(19) United States
(12) Patent Application Publication
(10) Pub. No.: US 2010/0296068 A1
(43) Pub. Date: Nov. 25, 2010

(54) EXPOSURE APPARATUS, EXPOSURE METHOD, AND DEVICE MANUFACTURING METHOD

(75) Inventor: Yuichi Shibazaki, Kumagaya-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/816,775

(22) Filed: Jun. 16, 2010

Related U.S. Application Data
(63) Continuation of application No. PCT/JP2008/072998, filed on Dec. 17, 2008.

(30) Foreign Application Priority Data
Dec. 17, 2007 (JP) 2007-325078
Dec. 28, 2007 (JP) 2007-340875

(51) Int. Cl. G03B 27/52

(52) U.S. Cl. 355/30

(57) ABSTRACT

An exposure apparatus exposes an object with exposure light. The exposure apparatus includes: a moving body which holds the object and is movable in a predetermined plane, and in which a scale member including a grating is disposed; a measurement system which measures positional information of the moving body in the predetermined plane using the scale member; a detection system which detects information regarding foreign matter on a surface of the scale member and the size of the foreign matter; and a cleaning apparatus which can clean the scale member. A cleaning operation is performed on the scale member according to a detection result of the detection system.

### CROSS-REFERENCE TO RELATED APPLICATION

This is a Continuation Application of International Application No. PCT/JP2008/072998, filed Dec. 17, 2008, which claims priority to Japanese Patent Application No. 2007-325078 filed on Dec. 17, 2007, and Japanese Patent Application No. 2007-340875 filed on Dec. 28, 2007, the content of which is incorporated herein by reference.

### BACKGROUND

1. Field of the Invention

The present invention relates to an exposure apparatus, an exposure method, and a device manufacturing method.

2. Description of Related Art

In a manufacturing procedure of micro devices such as semiconductor devices and electronic devices, there is used an exposure apparatus which exposes a substrate to exposure light. The exposure apparatus is provided with a moving body such as a substrate stage which holds a substrate and moves. The exposure apparatus measures positional information of the moving body. The exposure apparatus exposes the substrate with exposure light while moving the moving body using the measurement information. In US Patent Application Publication No. 2006/0227309, an example of a technique is disclosed in which the positional information of the moving body is measured using a scale member.

### SUMMARY

In a case where the positional information of the moving body is measured using the scale member, when a surface state of the scale member is degraded, for example, foreign matter or the like exists on the surface of the scale member, measurement error occurs. Therefore, the positional information of the moving body may not be accurately measured. In addition, it may be difficult to favorably carry out positional control on the moving body in which the position information is used. As a result, exposure error may be generated, or a defective device may be produced.

A purpose of some aspects of the invention is to provide an exposure apparatus and an exposure method in which positional control of a moving body can be favorably carried out and exposure error can be suppressed from occurring. In addition, another purpose of some aspects of the invention is to provide a device manufacturing method in which defective devices can be suppressed from being produced.

According to a first aspect of the invention, there is provided an exposure apparatus which exposes an object with exposure light which includes: a moving body which holds the object and is movable in a predetermined plane, and in which a scale member including a grating is disposed; a measurement system which measures positional information of the moving body in the predetermined plane using the scale member; a detection system which detects information regarding foreign matter on a surface of the scale member and the size of the foreign matter; and a cleaning apparatus which is capable of cleaning the scale member. Here, a cleaning operation is performed on the scale member according to a detection result of the detection system.

According to a second aspect of the invention, there is provided an exposure apparatus which exposes an object with exposure light, including: a moving body which holds the object and is movable in a predetermined plane, and in which a scale member including a grating is disposed; a measurement system which includes an encoder system having a head being capable of facing the scale member and measures positional information of the moving body in the predetermined plane; a detection system which detects foreign matter on a surface of the scale member; a cleaning apparatus which is capable of cleaning the scale member; and a control apparatus which controls the moving body on the basis of measurement information of the measurement system and controls the cleaning operation and change of a control mode of the moving body. Here, the control apparatus can perform the cleaning operation and the change of the control mode when the detection system detects foreign matter which is not acceptable in the exposure.

According to a third aspect of the invention, there is provided an exposure apparatus which exposes an object with exposure light via an optical member, including: a moving body which holds the object and is movable in a predetermined plane, and in which a scale member including a grating is disposed; a measurement system which includes an encoder system having a head being capable of facing the scale member and measures positional information of the moving body in the predetermined plane; an immersion member which fills an optical path of the exposure light between the optical member and the object with a liquid, and forms an immersion space; and a cleaning apparatus which expands the immersion space compared with that at the time of exposing the object and carries out cleaning on the scale member.

According to a fourth aspect of the invention, there is provided a device manufacturing method which includes: exposing a substrate using the exposure apparatus according to the first to third aspects, and developing the exposed substrate.

According to a fifth aspect of the invention, there is provided an exposure method of exposing an object with exposure light, including: measuring positional information of the moving object in a predetermined plane by an encoder system which uses a scale member of a moving body holding the object, moving the moving body, and exposing the object; detecting information regarding foreign matter on a surface of the scale member and the size of the foreign matter; and determining whether or not the scale member is cleaned on the basis of the detection result.

According to a sixth aspect of the invention, there is provided an exposure method of exposing an object with exposure light, including: measuring positional information of the moving object in a predetermined plane by an encoder system which uses a scale member of a moving body holding the object, moving the moving body, and exposing the object; detecting foreign matter on a surface of the scale member; and performing the cleaning or the change of the control mode when foreign matter which is not acceptable in the exposure is detected.

According to a seventh aspect of the invention, there is provided an exposure method of exposing an object with exposure light via an optical member, including: filling an optical path of the exposure light between the optical member and the object with a liquid; measuring positional information of the moving object in a predetermined plane by an encoder system which uses a scale member of a moving body holding the object, moving the moving body, and exposing the object via the liquid; expanding the immersion space compared with that at the time of the exposure, and cleaning the scale member.

According to an eighth aspect of the invention, there is provided a device manufacturing method which includes: exposing a substrate using the exposure method according to the fifth to seventh aspects; and developing the exposed substrate.

According to the ninth aspect of the invention, there is provided an exposure apparatus which exposes a substrate with exposure light, including: a moving body on which a scale member including a grating is disposed, and which holds the substrate and is movable in a predetermined plane; an encoder system which has a head being capable facing the scale member and measures positional information of the moving body in the predetermined plane by the head; a drive system which is capable of driving the moving body on the basis of measurement infoitiiation of the encoder system; a detection system which detects information regarding a surface state of the scale member; and a control apparatus which controls driving of the moving body by the drive system on the basis of detection information of the detection system in the middle of exposing the substrate.

According to a tenth aspect of the invention, there is provided an exposure apparatus which exposes a substrate with exposure light, including: a moving body on which a scale member including a grating is disposed, and which holds the substrate and is movable in a predetermined plane; an encoder system which has a head being capable of facing the scale member and measures positional information of the moving body in the predetermined plane by the head; a drive system which is capable of driving the moving body on the basis of measurement information of the encoder system; a detection system which detects foreign matter on the scale member; and a control apparatus which determines a specific area on the substrate with which at least a part of an illumination area of the exposure light is overlapped when foreign matter is disposed on a measurement area of the head. Here, the drive system does not use measurement information of the encoder system in the first state in which the specific area is scanned and exposed.

According to an eleventh aspect of the invention, there is provided an exposure apparatus which exposes a substrate with exposure light, including: a moving body which holds the substrate and is movable in a predetermined plane, and in which a scale member including a grating is disposed; an encoder system which has a head being capable of facing the scale member and measures positional information of the moving body in the predetermined plane; a drive system which is capable of driving the moving body on the basis of measurement information of the encoder system; a detection system which detects information regarding a surface state of the scale member; and a control apparatus which determines a specific area on the substrate in which the measurement information is substantially unusable in the driving of the moving body, on the basis of detection information of the detection system.

According to a twelfth aspect of the invention, there is provided an exposure apparatus which exposes a substrate with exposure light, including: a moving body which holds the substrate and is movable in a predetermined plane; an encoder system which is capable of measuring positional information of the moving body in the predetermined plane; a drive system which capable of driving the moving body on the basis of measurement information of the encoder system; and a control apparatus which changes a servo gain of the drive system in a specific area or stops servo control of the moving body in the middle of the scanning exposure of a shot area including the specific area in which measurement information of the encoder system is abnormal on the substrate.

According to a thirteenth aspect of the invention, there is provided an exposure apparatus which exposes a substrate with exposure light, including: a moving body which holds the substrate and is movable in a predetermined plane; a measurement system which has an encoder system and an interferometer system which being capable of measuring positional information of the moving body in the predetermined plane; a drive system which drives the moving body on the basis of measurement information of the measurement system; and a control apparatus which switches measurement information to be used to drive the moving body from one of the encoder system and the interferometer system to the other system, sets output coordinates of the other system to be used after the switching such that output coordinates of the encoder system and the interferometer system at the time of the switching substantially continue, and makes the manner of continuing the output coordinates different at the time of switching from one of the encoder system and the interferometer system to the other system and at the time of switching from the other system to the one system.

According to a fourteenth aspect of the invention, there is provided a device manufacturing method which includes: exposing a substrate using the exposure apparatus according to the ninth to thirteenth aspects, and developing the exposed substrate.

According to a fifteenth aspect of the invention, there is provided an exposure method of exposing a substrate with exposure light, including: detecting information regarding a surface state of a scale member disposed on a moving body which holds the substrate and is movable in a predetermined plane; measuring positional information of the moving body by an encoder system which has a head facing the scale member; scanning and exposing the substrate while driving the moving body on the basis of measurement information of the encoder system; and controlling the moving body to be driven on the basis of the detected information in the middle of the scanning exposure of the substrate.

According to a sixteenth aspect of the invention, there is provided an exposure method of exposing a substrate with exposure light, including: detecting information regarding foreign matter on a scale member disposed on a moving body which holds the substrate and is movable in a predetermined plane; measuring positional information of the moving body by an encoder system which has a head facing the scale member; scanning and exposing the substrate while driving the moving body on the basis of measurement information of the encoder system; determining a specific area on the substrate with which at least a part of an illumination area of the exposure light is overlapped when foreign matter is disposed on a measurement area of the head; and driving the moving body without using measurement information of the encoder system in a first state in which the specific area is scanned and exposed.

According to a seventeenth aspect of the invention, there is provided an exposure method of exposing a substrate with exposure light, including: detecting information regarding a surface state of a scale member disposed on a moving body which holds the substrate and is movable in a predetermined plane; measuring positional information of the moving body by an encoder system which has a head facing the scale member; scanning and exposing the substrate while driving the moving body on the basis of measurement information of the encoder system; and determining a specific area on the substrate in which the measurement information is substantially unusable in the driving of the moving body, on the basis of the detected information.

According to an eighteenth aspect of the invention, there is provided an exposure method of exposing a substrate with exposure light, including: measuring positional information of a moving body, which holds the substrate and is movable in a predetermined plane, by an encoder system; scanning and exposing the substrate while driving the moving body on the basis of measurement information of the encoder system; and changing a servo gain of a drive system driving the moving body in the specific area or stopping servo control of the moving body in the middle of the scanning exposure of a shot area including the specific area in which the measurement information of the encoder system is abnormal on the substrate.

According to a nineteenth aspect of the invention, there is provided an exposure method of exposing a substrate with exposure light, including: measuring positional information of a moving body, which holds the substrate and is movable in a predetermined plane, by a measurement system; scanning and exposing the substrate while driving the moving body on the basis of measurement information of the measurement system; and switching measurement information to be used for driving the moving body from one of an encoder system and an interferometer system of the measurement system to the other system, and setting output coordinates of the other system to be used after the switching such that the output coordinates of the encoder system and the interferometer system at the time of the switching substantially continue. Here, the manner of continuing the output coordinates is different at the time of switching from one of the encoder system and the interferometer system to the other system and at the time of switching from the other system to the one system.

According to a twentieth aspect of the invention, there is provided a device manufacturing method which includes: exposing a substrate using the exposure method according to the fifteenth to nineteenth aspects; and developing the exposed substrate.

### Advantage of the Invention

According to the invention, exposure error can be suppressed from occurring, and device error can be suppressed from occurring.

### BRIEF DESCRIPTION OF THE DRAWINGS

FIG. 1 is a diagram schematically illustrating a configuration of an example of an exposure apparatus according to a first embodiment.

FIG. 2 is a diagram illustrating an example of a control system of the exposure apparatus according to the first embodiment.

FIG. 3 is a cross-sectional view illustrating the vicinity of a final optical element, an immersion member, and a substrate stage.

FIG. 4 is a plan view illustrating the substrate stage and a measurement stage according to the first embodiment.

FIG. 5 is a plan view illustrating the vicinity of an alignment system, a detection system, and an encoder system according to the first embodiment.

FIG. 6 is a diagram illustrating an example of a head of the encoder system according to the first embodiment.

FIG. 7 is a side view illustrating an example of the detection system according to the first embodiment.

FIG. 8 is a flow chart illustrating an operation example of the exposure apparatus according to the first embodiment.

FIG. 9 is a diagram illustrating an operation example of the exposure apparatus according to the first embodiment.

FIG. 10 is a diagram illustrating an operation example of the exposure apparatus according to the first embodiment.

FIG. 11 is a diagram illustrating an operation example of the exposure apparatus according to the first embodiment.

FIG. 12 is a diagram illustrating an operation example of the exposure apparatus according to the first embodiment.

FIG. 13 is a diagram schematically illustrating an example of a contact area according to the first embodiment.

FIG. 14 is a diagram illustrating an operation example of the exposure apparatus according to the first embodiment.

FIG. 15A is a diagram illustrating an operation example of the exposure apparatus according to a second embodiment.

FIG. 15B is a diagram illustrating an operation example of the exposure apparatus according to the second embodiment.

FIG. 16 is a flow chart illustrating an operation example of the exposure apparatus according to a third embodiment.

FIG. 17A is a diagram illustrating an operation example of the exposure apparatus according to the third embodiment.

FIG. 17B is a diagram illustrating an operation example of the exposure apparatus according to the third embodiment.

FIG. 18 is a diagram illustrating an example of a specific area according to the third embodiment.

FIG. 19 is a diagram illustrating an operation example of the exposure apparatus according to the third embodiment.

FIG. 20 is a flow chart illustrating an example of a manufacturing process of a micro device.

### DESCRIPTION OF EMBODIMENTS

Hereinafter, embodiments of the invention will be described with reference to the drawings, but the invention is not limited thereto. In the following description, the XYZ orthogonal coordinate system is assumed to be set, and a positional relationship between the respective members will be described with reference to the XYZ orthogonal coordinate system. The X-axis direction is assumed to be set in a predetermined direction in a horizontal plane, the Y-axis direction is assumed to be set in a direction perpendicular to the X-axis direction in the horizontal plane, and the Z-axis direction is assumed to be set in a direction (that is, a vertical direction) perpendicular to the X-axis direction and the Y-axis direction. In addition, rotation directions around the X axis, the Y axis, and the Z axis are assumed as the θX, the θY, and the θZ directions, respectively.

### First Embodiment

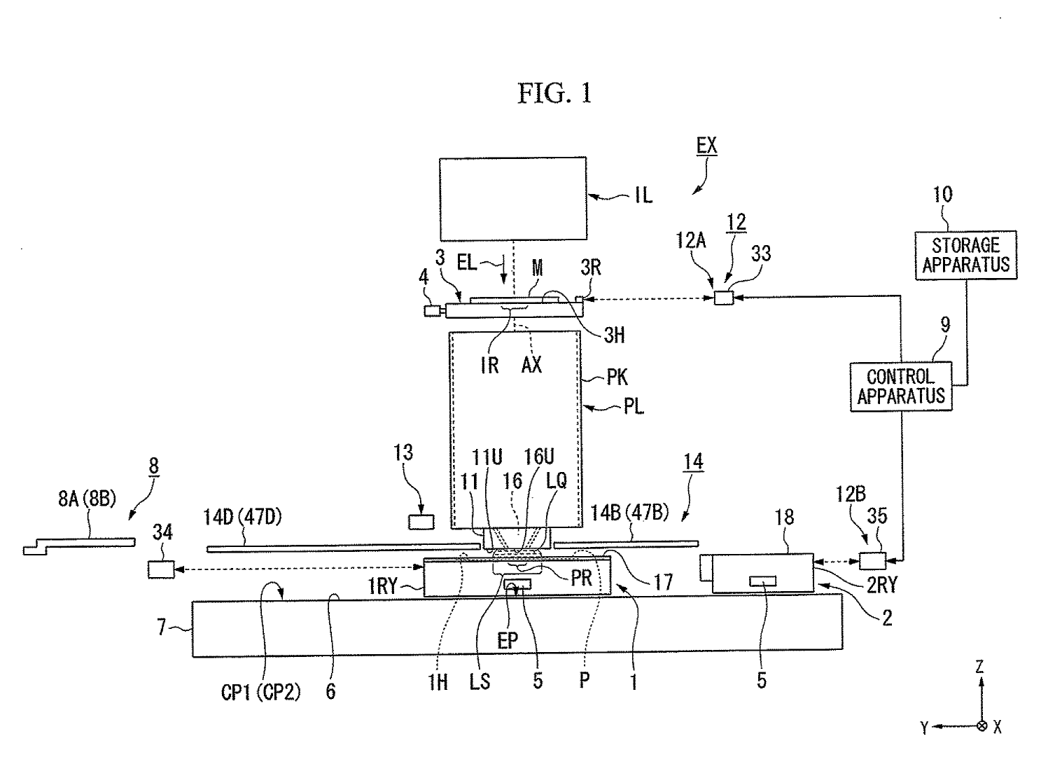

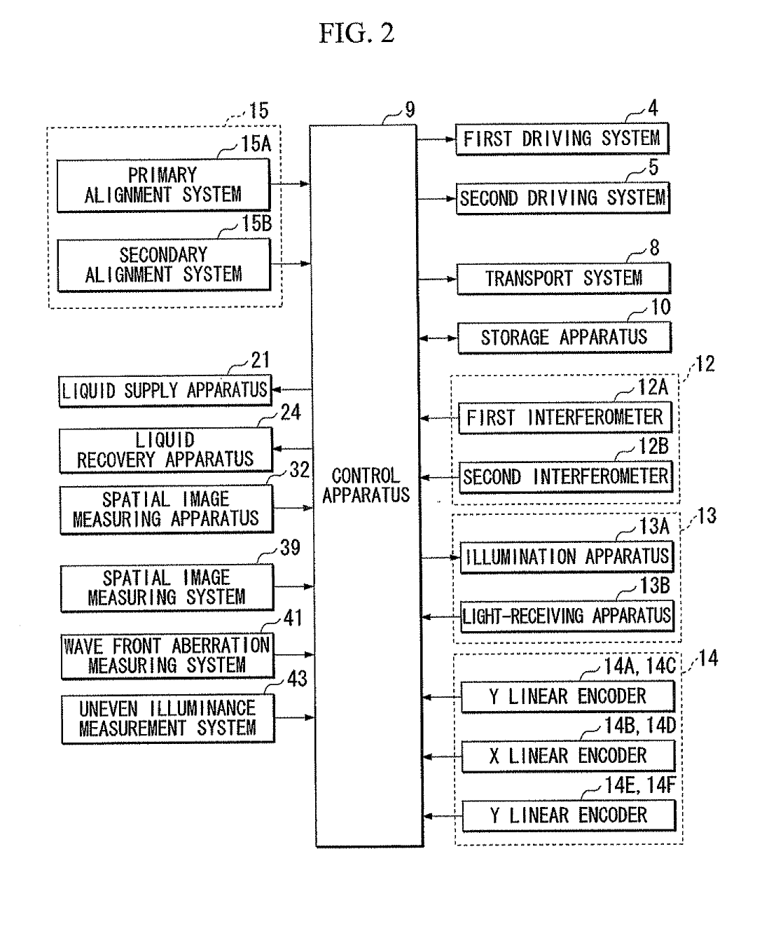

A first embodiment will be described. FIG. 1 is a diagram schematically illustrating a configuration of an example of an exposure apparatus EX according to the first embodiment. FIG. 2 is a diagram illustrating an example of a control system of the exposure apparatus EX according to the first embodiment. In this embodiment, the exposure apparatus EX will be exemplified as an exposure apparatus which is provided with a substrate stage 1 which holds a substrate P and is movable and a measurement stage 2 which does not hold the substrate P and performs predetermined measurement regarding exposure, as disclosed in the specifications of U.S. Pat. No. 6,897,963 and European Patent Application Publication No. 1,713,113.

In addition, in this embodiment, the exposure apparatus EX will be exemplified as an immersion exposure apparatus which exposes the substrate P by an exposure light EL via a liquid LQ, as disclosed in the specifications of US Patent Application Publication No. 2005/0280791 and US Patent Application Publication No. 2007/0127006.

In FIGS. 1 and 2, the exposure apparatus EX is provided with a mask stage 3 which holds a mask M and is movable, a substrate stage 1 which holds the substrate P and is movable, a measurement stage 2 mounted with a measurement member which does not hold the substrate P and performs predetermined measurement regarding exposure, a first drive system 4 which moves the mask stage 3, a second drive system 5 which moves the substrate stage 1 and the measurement stage 2, a base member (plate) 7 including a guide surface 6 which can move the substrate stage 1 and the measurement stage 2, an illumination system IL which illuminates the mask M by the exposure light EL, a projection optical system PL which projects a pattern image of the mask M illuminated by the exposure light EL on the substrate P, a transport system 8 which transports the substrate P, a control apparatus 9 which controls the entire operations of the exposure apparatus EX, and a storage apparatus 10 which is connected to the control apparatus 9 and stores a variety of information regarding the exposure.

In addition, the exposure apparatus EX is provided with an immersion member 11 which can form an immersion space LS such that at least a part of an optical path of the exposure light EL is filled with the liquid LQ. The immersion space LS is a space which is filled with the liquid LQ. In this embodiment, water (purified water) is used as the liquid LQ.

In addition, the exposure apparatus EX is provided with an interferometer system 12 which measures positional information of the mask stage 3, the substrate stage 1, and the measurement stage 2, a detection system (focus-leveling detection system) 13 which detects positional information on the surface of the substrate P held on the substrate stage 1, an encoder system 14 which measures positional information of the substrate stage 1, and an alignment system 15 which measures positional information of the substrate P.

The interferometer system 12 includes a first interferometer unit 12A which measures positional information of the mask stage 3, and a second interferometer unit 12B which measures positional information of the substrate stage 1 and the measurement stage 2. The measurement system 13 includes an illumination apparatus 13A which emits detection light, and a light-receiving apparatus 13B which is disposed in a predetermined positional relationship with respect to the illumination apparatus 13A and receives the detection light. The encoder system 14 includes Y linear encoders 14A, 14C, 14E, and 14F which measure positional information of the substrate stage 1 regarding the Y-axis direction, and X linear encoders 14B and 14D which measure positional information of the substrate stage 1 regarding the X-axis direction. The alignment stage 15 includes a primary alignment system 15A and a secondary alignment system 15B.

The substrate P is a substrate for manufacturing devices. The substrate P includes a member in which a photosensitive film is formed on a base material such as a semiconductor wafer, for example, a silicon wafer. The photosensitive film is a film of a photosensitive material (photo resist). In addition, on the substrate P, various films different from the photosensitive film may be foinied. For example, in the substrate P, a protective film (top coat film) may be formed on the photosensitive film. The mask M includes a reticle on which a device pattern projected to the substrate P is formed. The mask M includes a transparent mask on which a predetermined pattern is formed using a light blocking film such as chrome on a transparent plate such as glass. The transparent mask is not limited to a binary mask on which a pattern is formed by the light blocking film. For example, the transparent mask may include a half tone type mask or a spatial frequency modulation type mask. In this embodiment, as the mask M, the transparent mask is employed. Further, as the mask M, a reflective mask may be employed.

The illumination system IL includes an illuminance equalizing optical system including an optical integrator and a blind mechanism, and illuminates the exposure light EL with uniform illuminance distribution on a predetermined illumination area IR, as disclosed in the specification of US Patent Application Publication No. 2003/0025890. The illumination system IL illuminates the exposure light EL with uniform illuminance distribution on at least a part of the mask M which is disposed on the illumination area IR. For example, as the exposure light EL emitted from the illumination system IL, a far ultraviolet ray (DUV light) such as a bright line (g line, h line, and i line) emitted from a mercury lamp and the KrF excimer laser (wavelength 248 nm), a vacuum ultraviolet light (VUV light) such as the ArF excimer layer (wavelength 193 nm) and F₂ laser (wavelength 157 nm) are employed. In this embodiment, as the exposure light EL, the ArF excimer layer of the ultraviolet light (vacuum ultraviolet light) is employed.

The mask stage 3 has a mask holding apparatus 3H which holds the mask M. The mask holding apparatus 3H is attachable to or detachable from the mask M. In this embodiment, the mask holding apparatus 3H holds the mask M such that the lower surface (pattern forming surface) of the mask M becomes substantially flush with the XY plane. The first drive system 4 includes an actuator such as a linear motor. The mask stage 3 holds the mask M and is movable in the XY plane according to the operation of the first drive system 4. In this embodiment, the mask stage 3 is movable in three directions of the X axis, the Y axis, and the θZ directions in a state where the mask M is held by the mask holding apparatus 3H.

The projection optical system PL illuminates the exposure light EL on a predetermined illumination area (projection area PR). The projection optical system PL projects a pattern image of the mask M on at least a part of the substrate P disposed on the projection area PR at a projection magnification. The projection optical system PL has a final optical element 16 which can face the substrate P. The final optical element 16 is an optical element which is disposed closest to an image plane of the projection optical system PL among a plurality of optical elements of the projection optical system PL. The final optical element 16 has a light emitting surface (lower surface) 16U which emits the exposure light EL to the image plane of the projection optical system PL. The exposure light EL emitted from the lower surface 16U of the final optical element 16 is illuminated on the substrate P.

The plurality of optical elements of the projection optical system PL is held by a barrel PK. The barrel PK is mounted on a frame member (barrel plate) which is supported by three pillars via an anti-vibration mechanism. Further, as disclosed in a pamphlet of PCT International Publication No. 2006-038952, the barrel PK of the projection optical system PL may be hung on a support member which is disposed above the projection optical system PL.

For example, the projection optical system PL of this embodiment is a reduction system with a projection magnification such as ¼, ⅕, ⅛ or the like. Further, the projection optical system PL may be any one of a non-magnification system and a magnification system. In this embodiment, the optical axis AX of the projection optical system PL is substantially parallel to the Z axis. In addition, the projection optical system PL may be any one of a refraction system without a reflection optical element, a reflection system without a refraction optical element, and a reflective refraction system with a reflection optical element and a refraction optical element. In addition, the projection optical system PL may be formed as any one of an inverted image and an upright image.

The substrate stage 1 and the measurement stage 2 are movable on the guide surface 6 of the base member 7. In this embodiment, the guide surface 6 is substantially parallel to the XY plane. The substrate stage 1 holds the substrate P and is movable in the XY plane along the guide surface 6. The measurement stage 2 is disposed separately from the substrate stage 1 and is movable in the XY plane along the guide surface 6. The substrate stage 1 and the measurement stage 2 are movable to a position facing the lower surface 16U of the final optical element 16. The position facing the lower surface 16U of the final optical element 16 includes the illumination position EP of the exposure light EL which is emitted from the lower surface 16U of the final optical element 16. In the description below, the illumination position EP of the exposure light EL facing the lower surface 16U of the final optical element 16 is arbitrarily referred to as an exposure position EP.

The substrate stage 1 has a substrate holding apparatus 1H which holds the substrate P. The substrate holding apparatus 1H is attachable to or detachable from the substrate P. In this embodiment, the substrate holding apparatus 1H holds the substrate P such that the surface (exposure surface) of the substrate P is substantially parallel to the XY plane. The second drive system 5 includes an actuator such as a linear motor. The substrate stage 1 holds the substrate P and is movable in the XY plane according to the operation of the second drive system 5. In this embodiment, the substrate stage 1 is movable in six directions of the X axis, the Y axis, the Z axis, the θX, the θY, and the θZ axis directions in a state where the substrate P is held by the substrate holding apparatus 1H.

The substrate stage 1 has an upper surface 17 which is disposed around the substrate holding apparatus 1H. In this embodiment, the upper surface 17 of the substrate stage 1 is flat and substantially parallel to the XY plane. The substrate stage 1 has a concave portion. The substrate holding apparatus 1H is disposed on the inside of the concave portion. In this embodiment, the upper surface 17 of the substrate stage 1 and the surface of the substrate P held on the substrate holding apparatus 1H are disposed on substantially the same plane (becoming flush with each other). That is, the substrate stage 1 holds the substrate P by the substrate holding apparatus 1H such that the upper surface 17 of the substrate stage 1 and the surface of the substrate P are disposed on substantially the same plane (to become flush with each other).

The measurement stage 2 does not hold the substrate P and mounts measurement equipment and a measurement member (optical component) which can perform a predetermined measurement regarding exposure. The measurement stage 2 is movable in the XY plane according to the operation of the second drive system 5. In this embodiment, the measurement stage 2 is movable in six directions of the X axis, the Y axis, the Z axis, the θX, the θY, and the θZ directions in a state where at least a part of the measurement equipment and the measurement member are mounted in the measurement stage 2.

The measurement stage 2 has an upper surface 18 which is disposed around the measurement member. In this embodiment, the upper surface 18 of the measurement stage 2 is flat and substantially parallel to the XY plane. In this embodiment, a control apparatus 9 operates the second drive system 5, so that a positional relationship between the substrate stage 1 and the measurement stage 2 can be adjusted such that the upper surface 17 of the substrate stage 1 and the upper surface 18 of the measurement stage 2 are disposed on substantially the same plane (to become flush with each other).

The transport system 8 can transport the substrate P. In this embodiment, the transport system 8 is provided with a transport member 8A which can load the unexposed substrate P into the substrate holding apparatus 1H, and a transport member 8B which can unload the exposed substrate P from the substrate holding apparatus 1H. Further, the transport system 8 may load the substrate P into the substrate holding apparatus 1H and unload the substrate P from the substrate holding apparatus 1H using one transport member.

The control apparatus 9 moves the substrate stage 1 to a first substrate exchange position (loading position) CP1 which is different from the exposure position EP when the substrate P is loaded into the substrate holding apparatus 1H. In addition, the control apparatus 9 moves the substrate stage 1 to a second substrate exchange position (unloading position) CP2 which is different from the exposure position EP when the substrate P is unloaded from the substrate holding apparatus 1H. In this embodiment, the first substrate exchange position CP1 is different from the second substrate exchange position CP2. Further, the first substrate exchange position CP1 may be similar to the second substrate exchange position CP2

The substrate stage 1 is movable in a predetermined area of the guide surface 6 including the exposure position EP and the first and second substrate exchange positions CP1 and CP2. The transport system 8 can perform a loading operation of the substrate P into the substrate holding apparatus 1H of the substrate stage 1 which is moved to the first substrate exchange position CP1. In addition, the transport system 8 can perform an unloading operation of the substrate P from the substrate holding apparatus 1H of the substrate stage 1 which is moved to the second substrate exchange position CP2. Using the transport system 8, the control apparatus 9 can perform a substrate exchanging process which includes the unload operation for unloading the exposed substrate P from the substrate stage 1 (substrate holding apparatus 1H) which is moved to the first and second substrate exchange positions CP1 and CP2, and the loading operation for loading the unexposed substrate P to be exposed next into the substrate stage 1 (substrate holding apparatus 1H).

The immersion member 11 can form an immersion space LS with the liquid LQ such that at least a part of the optical path of the exposure light EL is filled with the liquid LQ. In this embodiment, the immersion member 11 is disposed in the vicinity of the final optical element 16. The immersion member 11 has a lower surface 11U which can face an object disposed on the exposure position EP. In this embodiment, the immersion member 11 forms the immersion space LS with the liquid LQ in an interval with the object such that the optical path of the exposure light EL between the final optical element 16 and the object disposed on the exposure position EP is filled with the liquid LQ. The immersion space LS is formed such that the optical path of the exposure light EL between the lower surface 16U of the final optical element 16 and the object disposed on the exposure position EP is filled with the liquid LQ. In this embodiment, the immersion space LS is formed by the liquid LQ which is held between the final optical element 16 and the immersion member 11 and the object facing the final optical element 16 and the immersion member 11.

The object facing the final optical element 16 and the immersion member 11 includes an object which is movable in a light emitting side (image plane side of the projection optical system PL) of the final optical element 16. In this embodiment, the object which is movable in the light emitting side of the final optical element 16 includes at least one of the substrate stage 1 and the measurement stage 2. In addition, the object includes the substrate P which is held on the substrate stage 1. In addition, the object includes various measurement members (optical components) which are mounted on the measurement stage 2.

For example, the final optical element 16 and the immersion member 11 hold the liquid LQ between the upper surface 17 of the substrate stage 1 disposed on the exposure position EP and the surface of the substrate P, so that the immersion space LS can be formed by the liquid LQ. In addition, the final optical element 16 and the immersion member 11 hold the liquid LQ in an interval with the upper surface 18 of the measurement stage 2 disposed on the exposure position EP, so that the immersion space LS can be formed with the liquid LQ.

On exposing the substrate P, the substrate P held on the substrate stage 1 is disposed on the exposure position EP so as to face the final optical element 16 and the immersion member 11. The immersion member 11 fills the optical path of the exposure light EL between the final optical element 16 and the substrate P with the liquid LQ at least when the substrate P is exposed, so that the immersion space LS can be formed. The liquid LQ is held between the final optical element 16 and the immersion member 11 and the substrate P such that the optical path of the exposure light EL emitted from the lower surface 16U of the final optical element 16 is filled with the liquid LQ at least when the substrate P is exposed, so that the immersion space LS is formed.

In this embodiment, the immersion space LS is fowled such that a part of the surface area of the substrate P including the projection area PR of the projection optical system PL is covered by the liquid LQ. A boundary (meniscus, edge) of the liquid LQ is formed between the lower surface 11U of the immersion member 11 and the surface of the substrate P. That is, the exposure apparatus EX of this embodiment employs a local immersion scheme.

In addition, during measuring by the measurement stage 2, the measurement member mounted on the measurement stage 2 is disposed on the exposure position EP so as to face the final optical element 16 and the immersion member 11. The immersion member 11 fills the optical path of the exposure light EL between the final optical element 16 and the substrate P using the liquid LQ at least during measuring by the measurement member, so that the immersion space LS can be formed. During measuring by the measurement member, the liquid LQ is held between the final optical element 16 and the immersion member 11 and the measurement member such that the optical path of the exposure light EL emitted from the lower surface 16U of the final optical element 16 is filled with the liquid LQ, so that the immersion space LS is formed.

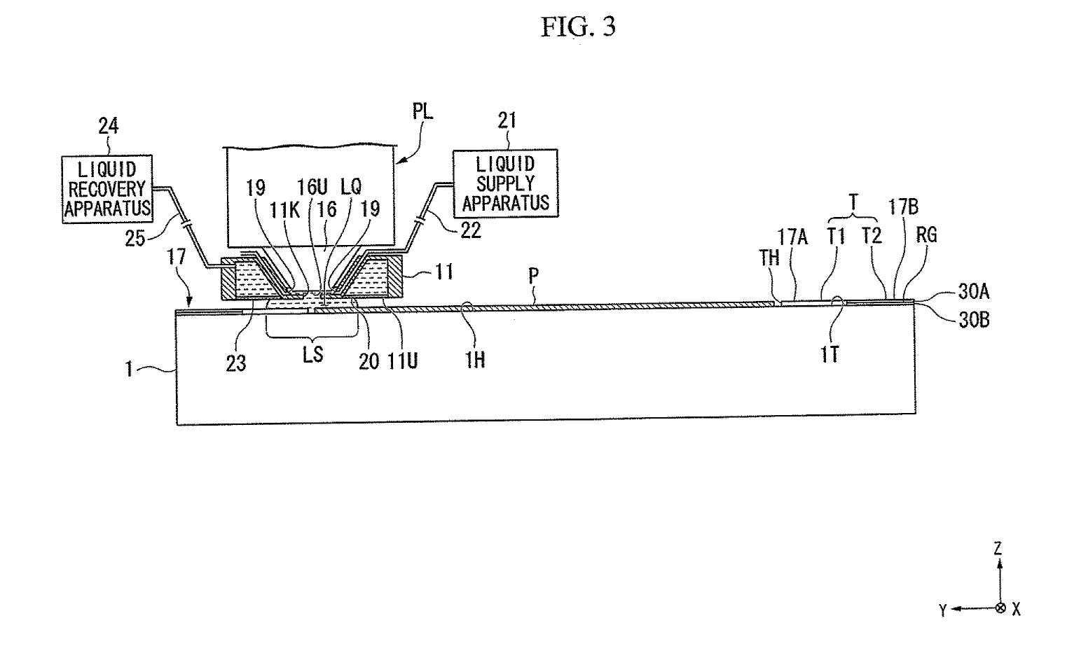

FIG. 3 is a cross-sectional view illustrating the vicinity of the substrate stage 1 which is disposed on the final optical element 16, the immersion member 11, and the exposure position EP. The immersion member 11 is an annular member. The immersion member 11 is disposed in the vicinity of the final optical element 16. The immersion member 11 has an opening 11K on a position facing the lower surface 16U of the final optical element 16. The immersion member 11 is provided with a supply port 19 for supplying the liquid LQ and a recovery port 20 for recovering the liquid LQ.

The supply port 19 can supply the liquid LQ to the optical path of the exposure light EL in order to form the immersion space LS. The supply port 19 is disposed on a predetermined position of the immersion member 11 facing the optical path in the vicinity of the optical path of the exposure light EL. In addition, the exposure apparatus EX is provided with a liquid supply apparatus 21. The liquid supply apparatus 21 can deliver the liquid LQ which is cleaned and adjusted in temperature. The support port 19 and the liquid supply apparatus 21 are connected to each other via the flow path 22. The flow path 22 includes a supply flow path which is formed on the inside of the immersion member 11 and a flow path which is formed in a supply tube for connecting the supply flow path and the liquid supply apparatus 21. The liquid LQ delivered from the liquid supply apparatus 21 is supplied to the support port 19 via the flow path 22.

The supply port 19 supplies the liquid LQ from the liquid supply apparatus 21 to the optical path of the exposure light EL. In addition, in this embodiment, the liquid supply apparatus 21 includes a liquid supply amount adjusting apparatus including a valve mechanism, a mass flow controller, and the like. The liquid supply apparatus 21 can adjust a liquid amount supplied to the supply port 19 per unit time using the liquid supply amount adjusting apparatus.

The recovery port 20 can recover at least a part of the liquid LQ on the object facing the lower surface 11U of the immersion member 11. In this embodiment, the recovery port 20 is disposed in the vicinity of the optical path of the exposure light EL.

The recovery port 20 is disposed on a predetermined position of the immersion member 11 facing the surface of the object. In the recovery port 20, a plate-like porous member 23 including a plurality of pores is disposed. Further, in the recovery port 20, a mesh filter which is a porous member in which a large number of small pores are formed in a mesh shape may be disposed. In this embodiment, at least a part of the lower surface 11U of the immersion member 11 is constituted by the lower surface of the porous member 23. In addition, the exposure apparatus EX is provided with a liquid recovery apparatus 24 which can recover the liquid LQ. The liquid recovery apparatus 24 includes a vacuum system to absorb and recover the liquid LQ. The recovery port 20 and the liquid recovery apparatus 24 are connected to each other via a flow path 25. The flow path 25 includes a recovery flow path which is formed on the inside of the immersion member 11, and a flow path which is formed in a recovery tube for connecting the recovery flow path and the liquid recovery apparatus 24. The liquid LQ recovered from recovery port 20 is recovered to the liquid recovery apparatus 24 via the flow path 25. In addition, in this embodiment, the liquid recovery apparatus 24 includes a liquid recovery amount adjusting apparatus including a valve mechanism, a mass flow controller, and the like. The liquid recovery apparatus 24 can adjust a liquid amount recovered by the recovery port 20 per unit time using the liquid recovery amount adjusting apparatus.

In this embodiment, the control apparatus 9 performs a liquid recovery operation using the recovery port 20 in parallel to a liquid supply operation using the supply port 19, so that the liquid space LS can be fowled by the liquid LQ between the final optical element 16 and the object facing the immersion member 11 and the final optical element 16 and the immersion member 11.

The substrate stage 1 is provided with the substrate holding apparatus 1H which is attachable to or detachable from the substrate P. In this embodiment, the substrate holding apparatus 1H includes a so-called pin chuck mechanism. The substrate holding apparatus 1H faces the rear surface of the substrate P and holds the rear surface of the substrate P. The upper surface 17 of the substrate stage 1 is disposed in the vicinity of the substrate holding apparatus 1H. The substrate holding apparatus 1H holds the substrate P such that the surface of the substrate P is substantially parallel to the XY plane. In this embodiment, the surface of the substrate P held on the substrate holding apparatus 1H is substantially parallel to the upper surface 17 of the substrate stage 1. In addition, in this embodiment, the surface of the substrate P held on the substrate holding apparatus 1H and the upper surface 17 of the substrate stage 1 are disposed on substantially the same plane (substantially becoming flush with each other).

In this embodiment, the substrate stage 1 has a plate member T which is disposed in the vicinity of the substrate P held on the substrate holding apparatus 1H. In this embodiment, the substrate stage 1 is attachable to or detachable from the plate member T. In this embodiment, the substrate stage 1 is provided with a plate member holding apparatus 1T which is attachable to or detachable from the plate member T. In this embodiment, the plate member holding apparatus 1T includes a so-called pin chuck mechanism. The plate member holding apparatus 1T is disposed in the vicinity of the substrate holding apparatus 1H. The plate member holding apparatus 1T faces the lower surface of the plate member T and holds the lower surface of the plate member T.

The plate member T has an opening TH in which the substrate P can be disposed. The plate member T held on the plate member holding apparatus 1T is disposed in the vicinity of the substrate P held on the substrate holding apparatus 1H. In this embodiment, the inner surface of the opening TH of the plate member T held on the plate member holding apparatus 1T is disposed to face the outer surface of the substrate P held on the substrate holding apparatus 1H via a predetermined gap. The plate member holding apparatus 1T holds the plate member T such that the upper surface of the plate member is substantially parallel to the XY plane. In this embodiment, the surface of the substrate P held on the substrate holding apparatus 1H and the upper surface of the plate member T held on the plate member holding apparatus 1T are substantially parallel to each other. In addition, in this embodiment, the surface of the substrate P held on the substrate holding apparatus 1H and the upper surface of the plate member T held on the plate member holding apparatus 1T are disposed on substantially the same plane (substantially becoming flush with each other).

That is, in this embodiment, the upper surface 17 of the substrate stage 1 includes at least a part of the upper surface of the plate member T held on the plate member holding apparatus 1T.

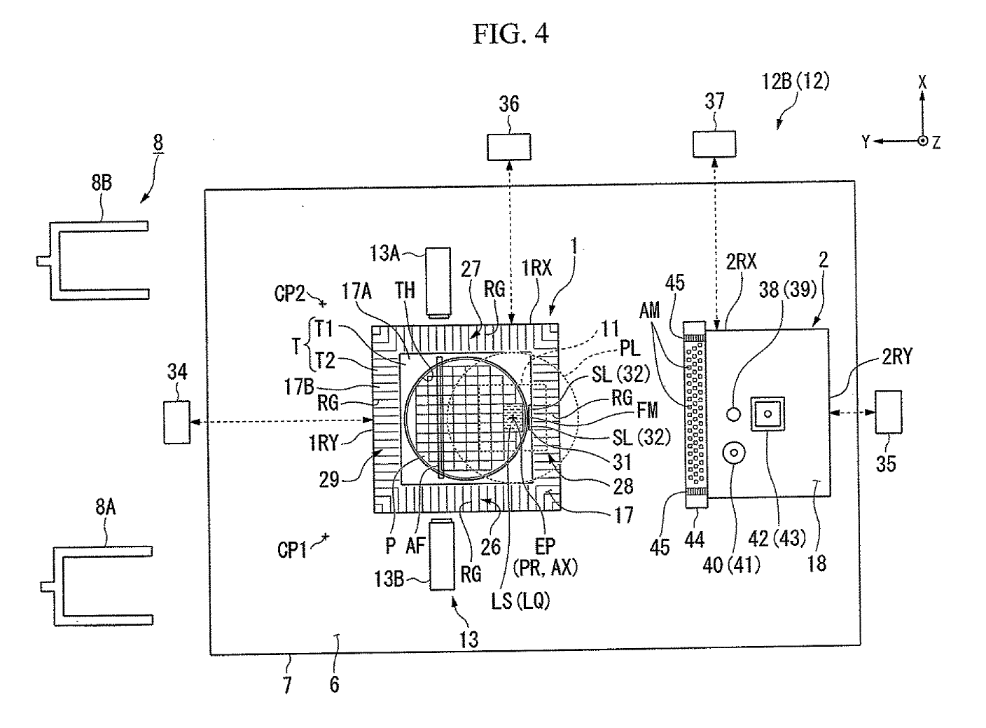

FIG. 4 is a plan view illustrating the substrate stage 1 and the measurement stage 2 as viewed from the above position. As shown in FIG. 4, in this embodiment, an appearance (contour, outline form) of the plate member T in the XY plane is a rectangular shape. The opening TH of the plate member T in which the substrate P can be disposed is in a circle shape.

In this embodiment, the plate member T is formed of a material with a low thermal expansion rate. The plate member T is formed of an optical glass material or a ceramic material (Zerodur (product name) made by Schott Co., Al₂O₃ or TiC, etc.). The upper surface of the plate member T has liquid repellency with respect to the liquid LQ. In this embodiment, the upper surface of the plate member T is subjected to a liquid repellency process. In this embodiment, a film made of a material including fluorine is formed on the upper surface of the plate member T, so that the upper surface has liquid repellency with respect to the liquid LQ. For example, a material for forming the film includes tetrafluoroethylene-perfluoroalkylvinylethercopolymer (PFA), polytetrafluoroethylene (PTFE), Teflon (Registered Trademark), or the like. Further, a material for forming the film may be an acrylic resin or a silicone resin.

In this embodiment, the plate member T includes a first plate T1 which has an opening TH and a second plate T2 which is disposed around the first plate T1. The appearance (contour, outline form) of the first plate T1 in the XY plane is a rectangular shape, and the appearance (contour, outline form) of the second plate T2 is a rectangular shape. In addition, the opening of the second plate T2 in which the first plate T1 is disposed is a rectangular shape. The opening of the second plate T2 has the same shape as that of the first plate T1.

In this embodiment, a scale member including a grating RG is disposed on the substrate stage 1. The scale member is disposed around the substrate holding apparatus 1H. In this embodiment, the scale member forms at least a part of the upper surface 17 of the substrate stage 1. In this embodiment, the second plate T2 serves as the scale member including the grating RG. In the above description, the second plate T2 is arbitrarily referred to as the scale member T2.

In this embodiment, the upper surface of the scale member T2 has liquid repellency against the liquid LQ. The upper surface of the scale member T2 substantially becomes flush with the surface of the substrate P which is held on the substrate holding apparatus 1H. The substrate stage 1 holds the substrate P such that the upper surface of the scale member T2 and the surface of the substrate P are disposed on substantially the same plane. The scale member T2 is disposed such that the upper surface thereof is disposed on substantially the same plane as the first plate T1 of the substrate stage 1 and the surface of the substrate P.

The scale member T2 includes Y scales 26 and 27 for measuring positional information of the substrate stage 1 regarding the Y axis direction and X scales 28 and 29 for measuring positional information of the substrate stage 1 regarding the X axis direction. The Y scale 26 is disposed on the −X side with respect to the opening TH, and the Y scale 27 is disposed on the +X side with respect to the opening TH. The X scale 28 is disposed on the −Y side with respect to the opening TH, and the X scale 29 is disposed on the +Y side with respect to the opening TH.

The Y scales 26 and 27 are set with the X axis direction as a longitudinal direction, and include a plurality of gratings (grating line) RG which are disposed at a predetermined pitch in the Y axis direction. That is, the Y scales 26 and 27 include one dimensional gratings of which the cycle direction is the Y axis direction.

The X scales 28 and 29 are set with the Y axis direction as a longitudinal direction, and include a plurality of gratings (grating line) RG which are disposed at a predetermined pitch in the X axis direction. That is, the X scales 28 and 29 include one dimensional gratings of which the cycle direction is the X axis direction.

In this embodiment, the grating RG is a refraction grating. That is, in this embodiment, the Y scales 26 and 27 have the refraction gratings RG of which the cycle direction is the Y axis direction, and the X scales 28 and 29 have the refraction gratings RG of which the cycle direction is the X axis direction.

In addition, in this embodiment, the Y scales 26 and 27 are a reflective scale, in which a reflective grating (reflective refraction grating) is formed such that the cycle direction thereof is the Y axis direction. The X scales 28 and 29 are a reflective scale, in which a reflective grating (reflective refraction grating) is formed such that the cycle direction thereof is the X axis direction.

Further, for the sake of simplicity in the drawing, in FIG. 4, the pitch of the refraction grating RG is shown significantly larger than the actual pitch. The subsequent drawings are also the same.

As shown in FIG. 3, the scale member T2 includes two sheets of plate-like members 30A and 30B which are attached to each other. The plate-like member 30A is disposed on the upper side (+Z side) of the plate-like member 30B. The refraction grating RG is provided on the upper surface (which is the surface on the +Z side) of the lower plate-like member 30B. The upper plate-like member 30A covers the upper surface of the lower plate-like member 30B. That is, the upper plate-like member 30A covers the refraction grating RG which is disposed on the upper surface of the lower plate-like member 30B. Therefore, degradation and damage to the refraction grating RG are suppressed.

The upper surface 17 of the plate member T includes a first liquid repelling area 17A which is disposed around the opening TH, and a second liquid repelling area 17B which is disposed around the first liquid repelling area 17A. The appearance (outline form) of the first liquid repelling area 17A is a rectangular shape. The appearance (contour, outline form) of the second liquid repelling area 17B is a rectangular shape. In this embodiment, the upper surface of the first plate T1 is the first liquid repelling area 17A, and the upper surface of the scale member (second plate) T2 is the second liquid repelling area 17B. For example, the first liquid repelling area 17A comes into contact with the liquid LQ of the immersion space (immersion area) LS which protrudes from the surface of the substrate P when the substrate P is subjected to the exposure operation.

In the exposure operation of the substrate P, the first plate T1 has a high possibility of being illuminated by the exposure light EL. For example, on exposing a shot area (which is a so-called edge shot area) in the peripheral portion of the substrate P, the upper surface (first liquid repelling area 17A) of the first plate T1 disposed around of the substrate P is also illuminated by the exposure light EL. On the other hand, the scale member T2 has a low possibility of being illuminated by the exposure light EL. In this embodiment, in consideration of an illumination quantity of the exposure light EL with respect to the first plate T1 and the scale member T2, the material of the film formed on the upper surface of the first plate T1 is different from the material of the film formed on the upper surface of the scale member T2. In this embodiment, the materials other than the film formed on the upper surface of the first plate T1 have higher tolerance to the exposure light EL than the film formed on the upper surface of the scale member T2. In general, there is a high possibility that the film with tolerance to the exposure light EL (vacuum ultraviolet light) will be hard to form on a glass material. That is, for example, when the first plate T1 is formed of a glass material, there is a high possibility that the film with tolerance to the exposure light EL will be hard to form on the first plate T1. Therefore, as the embodiment, forming the first plate T1 separately from the scale member T2 disposed around the first plate T1 is effective.

Further, the invention is not limited to the above-mentioned configuration, but it may be formed such that two kinds of films with different tolerances to the exposure light EL are formed on the upper surface of the same plate, and the first liquid repelling area 17A and the second liquid repelling area 17B are formed. In addition, the kind of film formed as the first liquid repelling area 17A may be the same as the kind of film formed as the second liquid repelling area 17B. For example, it may be sufficient that only one liquid repelling area is formed on the same plate. In addition, in this embodiment, at least a part of the upper surface of the plate member T may become flush with the surface of the substrate P. That is, the surface of the substrate P and the upper surface of the plate member T may be different in height. In addition, in this embodiment, the plate member T is configured to assemble the first plate T1 and the scale member T2, but the plate member T may be formed of a single plate. Alternatively, the plate member T may be formed of three plates or more.

As shown in FIG. 4, in this embodiment, a longitudinal notch may be formed at the edge of the −Y side of the first plate T1. The notch is formed near the center portion of the first plate T1 with respect to the X axis direction. A measurement plate 31 is disposed on the inside (inside the notch) of a longitudinal space which is formed of the notch of the first plate T1 and the scale member T2. A reference mark FM is disposed near the center portion of the measurement plate 31 with respect to the X axis direction. In addition, a slit-like measuring pattern (slit pattern) SL for measuring a spatial image is formed on the +X side and the −X side of the reference mark FM with respect to the X axis direction. The slit pattern SL is formed on the measurement plate 31. The slit pattern SL constitutes a part of a spatial image measuring apparatus 32. A pair of slit patterns SL for measuring a spatial image is symmetrically disposed with respect to the center of the reference mark FM. For example, the slit pattern SL is an L-shaped pattern of which the sides are aligned along the X axis direction and the Y axis direction. Alternatively, the slit pattern SL is two linear slit patterns which are respectively extended in the X axis direction and the Y axis direction.

The spatial image measuring apparatus 32 includes the slit pattern SL, an optical system which illuminates light via the slit pattern SL, and a light receiving element which receives light via the optical system. In this embodiment, at least a part of the optical system of the spatial image measuring apparatus 32 is disposed on the inside of the substrate stage 1.

Next, the interferometer system 12 will be described. The interferometer system 12 measures positional information of the mask stage 3, the substrate stage 1, and the measurement stage 2 in the XY plane. The interferometer system 12 is provided with a first interferometer unit 12A for measuring positional information of the mask stage 3 in the XY plane, and a second interferometer unit 12B for measuring positional information of the substrate stage 1 and the measurement stage 2 in the XY plane.

As shown in FIG. 1, the first interferometer unit 12A is provided with a laser interferometer 33. The first interferometer unit 12A illuminates measurement light on a measurement surface 3R of the mask stage 3 by the laser interferometer 33, and measures the positional information of the mask stage 3 (mask M) regarding the X axis, the Y axis, and the θZ directions using the measurement light via the measurement surface 3R.

As shown in FIGS. 1 and 4, the second interferometer unit 12B is provided with laser interferometers 34, 35, 36, and 37. The second interferometer unit 12B illuminates measurement surfaces 1RY and 1RX of the substrate stage 1 by the laser interferometers 34 and 36, and measures the positional information of the substrate stage 1 (substrate P) regarding the X axis, the Y axis, and the θZ directions using the measurement light via the measurement surfaces 1RY and 1RX. In addition, the second interferometer unit 12B illuminates measurement surfaces 2RY and 2RX of the measurement stage 2 by the laser interferometers 35 and 37, and measures the positional information of the measurement stage 2 regarding the X axis, the Y axis, and the θZ directions using the measurement light via the measurement surfaces 2RY and 2RX.

The laser interferometer 34 illuminates the measurement light on the measurement surface 1RY of the substrate stage 1. The measurement surface 1RY is disposed on the end surface of the +Y side of the substrate stage 1, and includes a reflection surface perpendicular to the Y axis. The laser interferometer 36 illuminates the measurement light on the measurement surface 1RX of the substrate stage 1. The measurement surface 1RX is disposed on the end surface of the +X side of the substrate stage 1, and includes a reflection surface perpendicular to the X axis. The second interferometer unit 12B illuminates the measurement light on the measurement surfaces 1RY and 1RX by the laser interferometers 34 and 36, and receives the measurement light which is reflected on the measurement surfaces 1RY and 1RX, so that the positional information of the substrate stage 1 in positions (displacement) of the measurement surfaces 1RY and 1RX with respect to the reference position, that is, the XY plane (X axis, Y axis, and the θZ directions) is measured. In addition, in this embodiment, the laser interferometers 34 and 36 include a multi-axis interferometer which has a plurality of optical axes. The measurement values of the laser interferometers 34 and 36 are output to the control apparatus 9. The control apparatus 9 can obtain the positional information of the substrate stage 1 regarding five directions of the X axis, the Y axis, the θX, the θY, and the θZ directions on the basis of the measurement results of the laser interferometers 34 and 36.

The laser interferometer 35 illuminates the measurement light on the measurement surface 2RY of the substrate stage 2. The measurement surface 2RY is disposed on the end surface of the −Y side of the substrate stage 2, and includes a reflection surface perpendicular to the Y axis. The laser interferometer 37 illuminates the measurement light on the measurement surface 2RX of the substrate stage 2. The measurement surface 2RX is disposed on the end surface of the +X side of the substrate stage 2, and includes a reflection surface perpendicular to the X axis. The second interferometer unit 12B illuminates the measurement light on the measurement surfaces 2RY and 2RX by the laser interferometers 35 and 37, and receives the measurement light which is reflected on the measurement surfaces 2RY and 2RX, so that the positional information of the substrate stage 2 in positions (displacement) of the measurement surfaces 2RY and 2RX with respect to the reference position, that is, the XY plane (X axis, Y axis, and the θZ directions) is measured. In addition, in this embodiment, the laser interferometers 35 and 37 include a multi-axis interferometer which has a plurality of optical axes. The measurement values of the laser interferometers 35 and 37 are output to the control apparatus 9. The control apparatus 9 can obtain the positional information of the substrate stage 2 regarding five directions of the X axis, the Y axis, the θX, the θY, and the θZ directions on the basis of the measurement results of the laser interferometers 35 and 37.

Next, the measurement stage 2 will be described with reference to FIGS. 1, 2, and 4. The measurement stage 2 is provided with a plurality of measurement equipment and measurement members (optical components) for performing various measurements on exposure. On a predetermined position of the upper surface 18 of the measurement stage 2, a first measurement member 38 is provided in which a porous pattern is formed so as to transmit the exposure light EL. For example, the first measurement member 38 constitutes a part of a spatial image measuring system 39 which measures spatial images by the projection optical system PL as disclosed in the specification of US Patent Application Laid-Open Publication No. 2002-0041377. On the first measurement member 38, the exposure light EL is illuminated from the projection optical system PL for measuring imaging characteristics of the projection optical system PL. The spatial image measuring system 39 is provided with the first measurement member 38, and a light receiving element for receiving the exposure light EL via the porous pattern of the first measurement member 38. The control apparatus 9 illuminates the exposure light EL on the first measurement member 38, and receives the exposure light EL via the porous pattern of the first measurement member 38 by the light receiving element, so that the measurement of the imaging characteristics of the projection optical system PL is performed.

In addition, on a predetermined position of the upper surface 18 of the measurement stage 2, a second measurement member 40 is provided in which a transmission pattern is formed so as to transmit the exposure light EL. For example, the second measurement member 40 constitutes a part of a wave front aberration measuring system 41 which measures wave front aberration of the projection optical system PL as disclosed in the specification of European Patent No. 1,079,223. On the second measurement member 40, the exposure light EL is illuminated from the projection optical system PL for measuring wave front aberration of the projection optical system PL. The wave front aberration measuring system 41 is provided with the second measurement member 40, and a light receiving element for receiving the exposure light EL via the porous pattern of the second measurement member 40. The control apparatus 9 illuminates the exposure light EL on the second measurement member 40, and receives the exposure light EL via the porous pattern of the second measurement member 40 by the light receiving element, so that the measurement of the wave front aberration of the projection optical system PL is performed.

In addition, on a predetermined position of the upper surface 18 of the measurement stage 2, a third measurement member 42 is provided in which a transmission pattern is formed so as to transmit the exposure light EL. For example, the third measurement member 42 constitutes a part of an uneven illuminance measurement system 43 which measures uneven illuminance of the exposure light EL as disclosed in the specification of U.S. Pat. No. 4,465,368. On the third measurement member 42, the exposure light EL is illuminated from the projection optical system PL for measuring the uneven illuminance of the exposure light EL which is illuminated on the image plane of the projection optical system PL. The uneven illuminance measuring system 43 is provided with the third measurement member 42, and a light receiving element for receiving the exposure light EL via the porous pattern of the third measurement member 42. The control apparatus 9 illuminates the exposure light EL on the third measurement member 42, and receives the exposure light EL via the porous pattern of the third measurement member 42 by the light receiving element, so that the measurement of the uneven illuminance of the exposure light EL is performed.

In this embodiment, the upper surface of the first measurement member 38, the upper surface of the second measurement member 40, the upper surface of the third measurement member 42, the upper surface 18 of the measurement stage 2 which is disposed around the upper surfaces of these measurement members 38, 40, and 42 are disposed on substantially the same plane (in the XY plane) (substantially becoming flush with one another).

In this embodiment, the spatial image measuring system 39, the wave front aberration measuring system 41, and the uneven illuminance measuring system 43 receive the exposure light EL via the projection optical system PL and the liquid LQ.

Further, for example, the third measurement member 42 may be the measurement system for measuring the variation in transmittance of the exposure light EL of the projection optical system PL as disclosed in the specification of U.S. Pat. No. 6,721,039, and may constitute a part of the measurement system for measuring information regarding the exposure energy of the exposure light EL, such as the illumination quantity measuring system (illuminance measuring system) as disclosed in the specification of US Patent Application Laid-Open Publication No. 2002-0061469.

Further, in this embodiment, for example, the final optical element 16 and an imaging apparatus (observing camera) capable of observing a state of the immersion member 11 may be disposed on the measurement stage 2.

In this embodiment, a reference member 44 is disposed on a side surface on the +Y side of the measurement stage 2. In this embodiment, the reference member 44 is a rectangular shape elongated in the X axis, which is also referred to as a fiducial bar (FD bar) or a confiducial bar (CD bar). The reference member 44 is kinematically supported to the measurement stage 2 by a full kinematic mount structure.

The reference member 44 serves as a standard (measurement reference). The reference member 44 is formed of an optical glass material with a low coefficient of thermal expansion or a ceramic material. In this embodiment, for example, the reference member 44 is formed of Zerodur (product name) made by Schott Co. The flatness of the upper surface (surface, the +Z side surface) of the reference member 44 is high, so that the reference member can serve as the reference plane. In the vicinity of the end of the +X side and the −X side of the reference member 44, reference gratings 45 of which the cycle direction is the Y axis direction are formed. The reference grating 45 includes a diffraction grating. The reference gratings 45 are disposed separately by a predetermined distance in the X axis direction. The reference gratings 45 are symmetrically disposed with respect to the center of the reference member 44 in the X axis direction. In addition, as shown in FIG. 4, a plurality of reference marks AM is formed on the upper surface of the reference member 44.

In addition, in this embodiment, the upper surface of the reference member 44 and the upper surface 18 of the measurement stage 2 have the liquid repellency against the liquid LQ. In this embodiment, for example, a film made of a material including fluorine is formed on the upper surface of the reference member 44 and the upper surface 18 of the measurement stage 2. In addition, the upper surfaces of the measurement members 38, 40, and 42 also have liquid repellency against the liquid LQ.

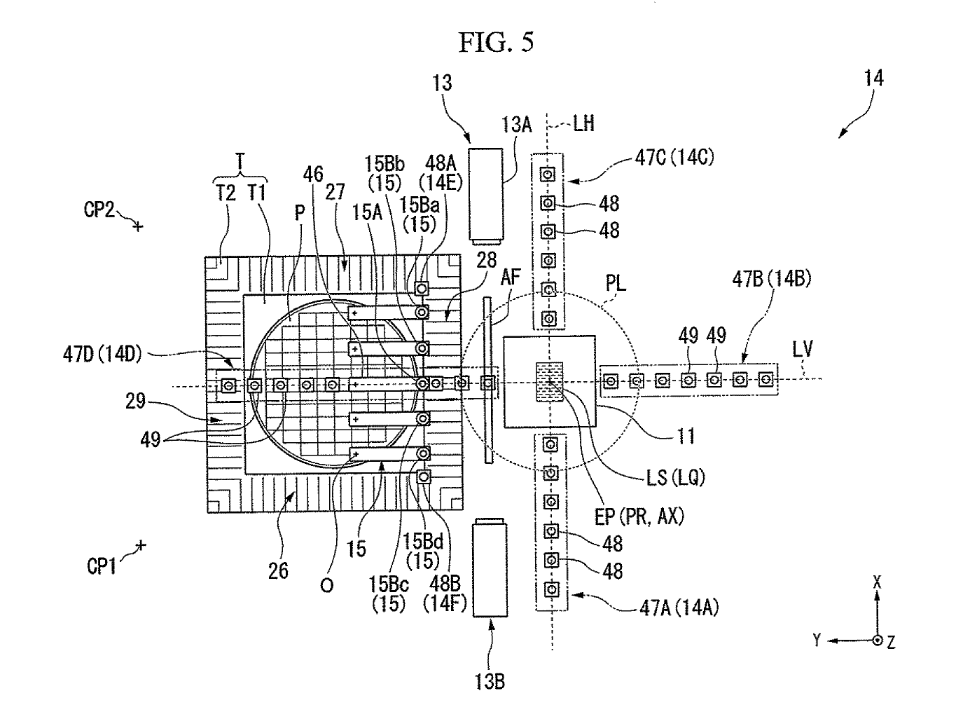

Next, the alignment system 15 will be described with reference to FIG. 5. FIG. 5 is a plan view illustrating the vicinity of the alignment system 15, the detection system 13, and the encoder system 14. Further, in FIG. 5, the measurement stage is omitted.

The alignment system 15 is provided with a primary alignment system 15A for detecting the positional information of the substrate P, and a secondary alignment system 15B. The primary alignment system 15A has a detection center (detection reference) on the straight line LV which is parallel to the Y axis and passes through the optical axis AX of the projection optical system PL. In this embodiment, the detection center of the primary alignment system 15A is disposed on the +Y side with respect to the optical axis AX of the projection optical system PL. The detection center of the primary alignment system 15A is separated from the optical axis AX of the projection optical system PL by a predetermined distance. The primary alignment system 15A is supported by a support member 46.

In this embodiment, the secondary alignment system 15B includes four secondary alignment systems 15Ba, 15Bb, 15Bc, and 15Bd. The secondary alignment systems 15Ba and 15Bb are disposed on the +X side with respect to the primary alignment system 15A, and the secondary alignment system 15Bc and 15Bd are disposed on the −X side with respect to the primary alignment system 15A. The detection centers (detection reference) of the secondary alignment system 15Ba and 15Bb and the detection centers (detection reference) of the secondary alignment systems 15Bc and 15Bd are substantially in a symmetric relation about the straight line LV. The secondary alignment systems 15Ba to 15Bd can rotate in the XY plane about the rotation center O. As the secondary alignment systems 15Ba to 15Bd rotate, the positions of these secondary alignment systems 15Ba to 15Bd are adjusted with respect to the X axis direction.

In this embodiment, for example, the primary alignment system 15A and four secondary alignment systems 15Ba to 15Bd employ a field image alignment (FIA) scheme in which the broadband detection light, which is not sensed by the photosensitive film on the substrate P, is illuminated on a target mark (alignment mark on the substrate P, etc.), the target mark image formed on the receiving surface by the reflection light from the target mark and an index (index mark on an index plate provided in each alignment system) image are imaged using an imaging element such as the CCD, and a position of the mark is measured by subjecting these imaged signals to an image process, as disclosed in the specification of U.S. Pat. No. 5,493,403. The imaged signals of the primary alignment system 15A and four secondary alignment systems 15Ba to 15Bd are output to the control apparatus 9.

Next, the encoder system 14 will be described with reference to FIG. 5. In this embodiment, the encoder system 14 can measure the positional information of the substrate stage 1 in the XY plane. The encoder system 14 measures the positional information of the substrate stage 1 in the XY plane using the scale member T2. The encoder system 14 is provided with Y linear encoders 14A and 14C for measuring the positional information of the substrate stage 1 regarding the Y axis direction, and X linear encoders 14B and 14D for measuring the positional information of the substrate stage 1 regarding the X axis direction.

The Y linear encoder 14A is provided with a head unit 47A which can face the scale member T2. The X linear encoder 14B is provided with a head unit 47B which can face the scale member T2. The Y linear encoder 14C is provided with a head unit 47C which can face the scale member T2. The X linear encoder 14D is provided with a head unit 47D which can face the scale member T2. Four head units 47A to 47D are disposed so as to surround the immersion member 11.

The head unit 47A is disposed on the −X side of the projection optical system PL. The head unit 47C is disposed on the +X side of the projection optical system PL. The head units 47A and 47C are elongated in the X axis direction. The head unit 47A and the head unit 47C are symmetrically disposed with respect to the optical axis AX of the projection optical system PL. In the XY plane, the distance between the optical axis AX of the projection optical system PL and the head unit 47A is substantially similar to the distance between the optical axis AX of the projection optical system PL and the head unit 47C.

The head unit 47B is disposed on the −Y side of the projection optical system PL. The head unit 47D is disposed on the +Y side of the projection optical system PL. The head units 47B and 47D are elongated in the Y axis direction. The head unit 47B and the head unit 47D are symmetrically disposed with respect to the optical axis AX of the projection optical system PL. In the XY plane, the distance between the optical axis AX of the projection optical system PL and the head unit 47B is substantially similar to the distance between the optical axis AX of the projection optical system PL and the head unit 47D.

The head unit 47A is provided with a plurality of Y heads 48 (6 heads in this embodiment) which are disposed along the X axis direction. The Y heads 48 of the head unit 47A are disposed separately by a predetermined gap on the straight line LH which passes through the optical axis AX of the projection optical system PL and is parallel to the X axis.

The head unit 47C is provided with a plurality of Y heads 48 (6 heads in this embodiment) which are disposed along the X axis direction. The Y heads 48 of the head unit 47C are disposed separately by a predetermined gap on the straight line LH which passes through the optical axis AX of the projection optical system PL and is parallel to the X axis.

The Y heads 48 of the head units 47A and 47C are can face the scale member T2.

The head unit 47A measures a position of the substrate stage 1 in the Y axis direction using the Y heads 48 and the Y scales 26 of the scale member T2. The head unit 47A has a plurality (6 pieces) of the Y heads 48, and constitutes a so-called multi-lens (6 lenses) Y linear encoder 14A.

The head unit 47C measures a position of the substrate stage 1 in the Y axis direction using the Y heads 48 and the Y scales 27 of the scale member T2. The head unit 47C has a plurality (6 pieces) of the Y heads 48, and constitutes a so-called multi-lens (6 lenses) Y linear encoder 14C.

In the head unit 47A, an interval between the adjacent Y heads 48 (measurement light of the Y heads 48) in the X axis direction is smaller than the width (length of the refraction grating RG) between the Y scales 26 and 27 in the X axis direction. Similarly, in the head unit 47C, an interval between the adjacent Y heads 48 (measurement light of the Y heads 48) in the X axis direction is smaller than the width (length of the refraction grating RG) between the Y scales 26 and 27 in the X axis direction.

The head unit 47B is provided with a plurality of X heads 49 (7 heads in this embodiment) which are disposed along the Y axis direction. The X heads 49 of the head unit 47B are disposed separately by a predetermined gap on the straight line LV which passes through the optical axis AX of the projection optical system PL and is parallel to the Y axis.

The head unit 47D is provided with a plurality of X heads 49 (11 heads in this embodiment) which are disposed along the Y axis direction. The X heads 49 of the head unit 47D are disposed separately by a predetermined gap on the straight line LV which passes through the optical axis AX of the projection optical system PL and is parallel to the Y axis.

The X heads 49 of the head units 47B and 47D are can face the scale member T2.

Further, in FIG. 5, among the plurality of the X heads 49 of the head unit 47D, a part of the X heads 49 overlapping with the primary alignment system 15A is omitted.

The head unit 47B measures a position of the substrate stage 1 in the X axis direction using the X heads 49 and the X scales 28 of the scale member T2. The head unit 47B has a plurality (7 pieces) of the X heads 49, and constitutes a so-called multi-lens (7 lenses) X linear encoder 14B.

The head unit 47D measures a position of the substrate stage 1 in the X axis direction using the X heads 49 and the X scales 29 of the scale member T2. The head unit 47D has a plurality (11 pieces) of the X heads 49, and constitutes a so-called multi-lens (11 lenses) X linear encoder 14D.

In the head unit 47B, an interval between the adjacent X heads 49 (measurement light of the X heads 49) in the Y axis direction is smaller than the width (length of the refraction grating RG) between the X scales 28 and 29 in the Y axis direction. Similarly, in the head unit 47D, an interval between the adjacent X heads 49 (measurement light of the X heads 49) in the Y axis direction is smaller than the width (length of the refraction grating RG) between the X scales 28 and 29 in the Y axis direction.

In addition, the encoder system 14 is provided with a Y linear encoder 14E including the Y head 48A which is disposed on the +X side of the secondary alignment system 15Ba, and a Y linear encoder 14F including the Y head 48B which is disposed on the −X side of the secondary alignment system 15Bd. The Y head 48A and the Y head 48B can face the scale member T2.

The Y heads 48A and 48B are disposed on the straight line which passes through the detection center of the primary alignment system 15A and is parallel to the X axis. The Y head 48A and the Y head 48B are symmetrically disposed with respect to the detection center of the primary alignment system 15A. The interval between the Y head 48A and the Y head 48B is substantially similar to the interval between a pair of the reference gratings 45 of the reference member 44.

As shown in FIG. 5, when the center of the substrate P held on the substrate stage 1 is disposed on the straight line LV, the Y head 48A and the Y scale 27 face each other, and the Y head 48B and the Y scale 26 face each other. The encoder system 14 can measure the positional information of the substrate stage 1 regarding the Y axis and the θZ directions using the Y heads 48A and 48B.

In addition, in this embodiment, the pair of the reference gratings 45 of the reference member 44 and the Y heads 48A and 48B respectively face each other, and the Y heads 48A and 48B measure the reference gratings 45 so as to measure the position of the reference member 44 in the Y axis direction.

The measurement values of the above-mentioned six linear encoders 14A to 14F are output to the control apparatus 9. The control apparatus 9 controls the position of the substrate stage 1 in the XY plane on the basis of the measurement values of the linear encoders 14A to 14D, and controls the position of the reference member 44 regarding the θZ direction on the basis of the measurement values of the linear encoders 14E and 14F.

In this embodiment, each of the linear encoders 14A to 14F is supported by a frame member which supports the projection optical system PL. Each of the linear encoders 14A to 14F hangs on the frame member via a support member. Each of the linear encoders 14A to 14F is disposed above the substrate stage 1 and the measurement stage 2.

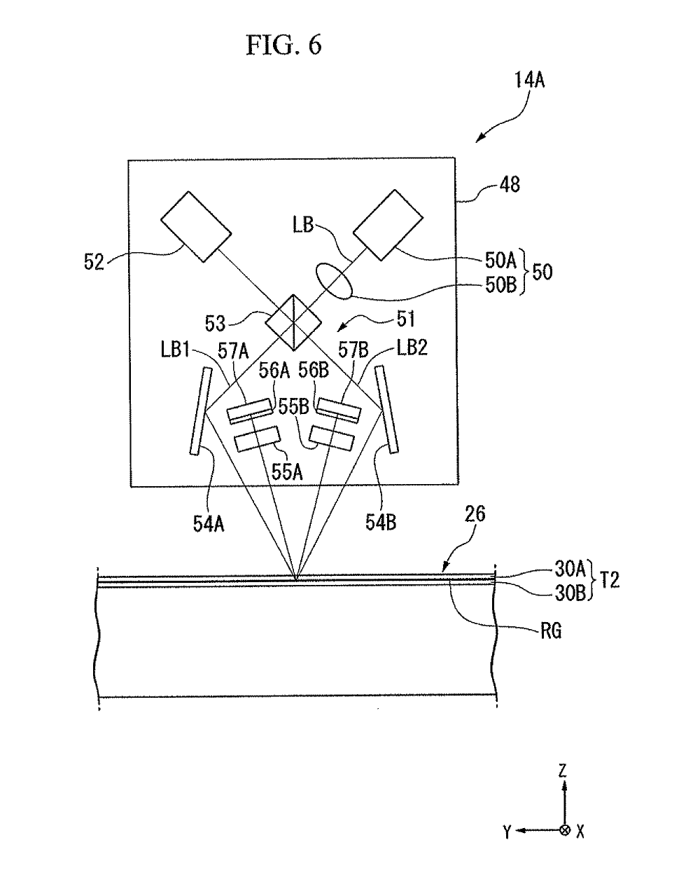

FIG. 6 is a diagram illustrating an example of the Y head 48 which is provided at the Y linear encoder 14A. In FIG. 6, the Y head 48 of the Y linear encoder 14A is illustrated in a state of facing the Y scale 26. Here, the configuration of the Y head 48 of the Y linear encoder 14A is substantially similar to the configurations of the Y head 48 of the Y linear encoder 14C, the X head 49 of the X linear encoders 14B and 14D, the Y heads 48A and 48B of the Y linear encoders 14E and 14F. Hereinafter, the Y head 48 of the Y linear encoder 14A will be described with reference to FIG. 6, and the heads of the other encoders 14B to 14F will be omitted in the description.

The Y linear encoder 14A measures the positional information of the substrate stage 1 by the Y head 48. The Y head 48 is provided with an illumination apparatus 50 emitting the measurement light, an optical system 51 which the measurement light passes through, and a light-receiving apparatus 52 for receiving the measurement light via the Y scale 26.

The illumination apparatus 50 includes a light source 50A for generating the measurement light (laser light) LB, and a lens system 50B disposed on a position on which the measurement light LB emitted from the light source 50A can be incident. For example, the light source 50A includes a semiconductor laser. The illumination apparatus 50 emits the measurement light LB in an oblique direction by 45° with respect to the Y axis and the Z axis.

The optical system 51 is provided with a polarization beam splitter 53, a pair of reflection mirrors 54A and 54B, lenses 55A and 55B, λ/4 plates 56A and 56B, and reflection mirrors 57A and 57B. In this embodiment, the polarization splitting surface of the polarization beam splitter 53 is substantially parallel to the XZ plane.

The light receiving apparatus 52 includes a polarizer (analyzer), an optical detector, and the like. The light receiving apparatus 52 outputs signals corresponding to the received light to the control apparatus 9.

In the Y linear encoder 14A, the measurement light LB emitted from the light source 50A is incident on the polarization beam splitter 53 via the lens system 50B so as to be polarized and split. The polarization beam splitter 53 splits the incident measurement light LB into the measurement light LB1 based on a P-polarized component and the measurement light LB2 based on an S-polarized component.

The measurement light LB1 passing through the polarization splitting surface of the polarization beam splitter 53 reaches the diffraction grating RG disposed on the Y scale 26 via the reflection mirror 54A. The measurement light LB2 passing through the polarization splitting surface of the polarization beam splitter 53 reaches the diffraction grating RG via the reflection mirror 54B.

By illuminating the measurement light LB1 and LB2, the diffraction grating RG generates refraction light. The refraction light with a predetermined degree (for example, 1st diffraction light) which is generated by the diffraction optical element RG is incident on the λ/4 plates 56A and 56B via the lenses 55A and 55B. The 214 plates 56A and 56B converts the incident light into circular polarized light. The circular polarized light converted by 214 plates 56A and 56B is incident on the reflection mirrors 57A and 58B, and reflected on the reflection mirrors 57A and 58B, and incident on the 214 plates 56A and 56B once more. The light incident on λ/4 plates 56A and 56B is illuminated to the diffraction grating RG disposed on the Y scale 26 via the λ/4 plates 56A and 56B. The light via the diffraction grating RG reaches the polarization beam splitter 53. In this embodiment, the light reflected on the reflection mirrors 57A and 57B reaches the polarization beam splitter 53 against the forwarding direction of the optical path.

The two beams of measurement light reaching the polarization beam splitter 53 rotate by 90° with respect to the original direction of the polarization direction. Therefore, the 1st diffraction light of the measurement light LB1 previously passing through the polarization beam splitter 53 is reflected on the polarization beam splitter 53 and incident on the light receiving apparatus 52. The 1st diffraction light of the measurement light LB2 previously reflected on the polarization beam splitter 53 passes through the polarization beam splitter 53, is coaxially synthesized with the 1st diffraction light of the measurement light LB1, and incident on the light receiving apparatus 52.

Then, two 1st beams of diffraction light incident on the light receiving apparatus 52 are arranged in their polarization direction by the analyzer on the inside of the receiving apparatus 52, and interfere with each other so as to become the interfering light. The interfering light is detected by the optical detector and converted into an electric signal according to the intensity of the interfering light.

In this embodiment, for example, in the Y linear encoder 14A, the lengths of the optical paths of two light beams interfering with each other are extremely short and substantially equal to each other, so that the effect of the air fluctuation can be practically ignored. When the Y scale 26 (substrate stage 1) moves in the measurement direction (in this case, corresponding to the Y axis direction), the phases of the two light beams are changed, so that the strength of the interfering light is changed. The strength change of the interfering light is detected by the light receiving apparatus 52. The Y linear encoder 14A outputs the positional information according to the strength change as the measurement value.

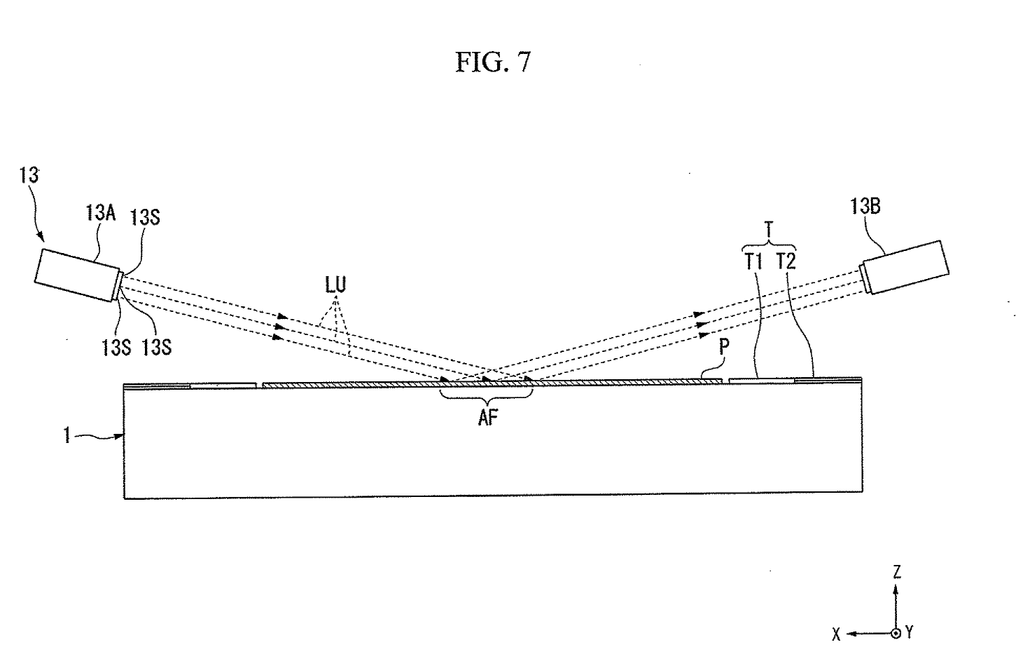

Next, the detection system 13 will be described with reference to FIGS. 1, 2, 5, and 7, FIG. 7 is a side view illustrating the detection system 13.

The detection system 13 detects the positional information of the substrate P held on the substrate stage 1, the positional information of the upper surface 17 (upper surface of the plate member T) of the substrate stage 1, and the positional information of the upper surface 18 of the measurement stage 2. In the description below, the surface of the substrate P held on the substrate stage 1, the upper surface 17 (upper surface of the plate member T including the first plate T1 and the scale member T2) of the substrate stage 1, and the upper surface 18 of the measurement stage 2, which are detected by the detection system 13 and substantially parallel in the XY plane, are arbitrarily referred to as detecting surfaces.

The detection system 13 detects the positional information of the detecting surface regarding the Z axis, the θX, and the θY directions. For example, the detection system 13 includes a so-called multipoint focus leveling detection system in an oblique incidence scheme, as disclosed in the specification of U.S. Pat. No. 5,448,332.

The detection system 13 illuminates the detection light LU on a plurality of detection points Kij in the detecting surface (in the XY plane), and detects the positional information of the detecting surface regarding the Z axis direction in each detection point Kij. The detection system 13 is provided with the illumination apparatus 13A which illuminates the detection light LU on each of the plurality of detection points Kij in the XY plane from an oblique direction with respect to the Z axis direction, and the light receiving apparatus 13B which can receive the detection light LU via the detection points Kij.

The illumination apparatus 13A illuminates the detection light LU on each of the plurality of detection points Kij on the detecting surface from the upper side of the detection surface. The illumination apparatus 13A emits the detection light LU which is not sensed by the photosensitive film of the substrate P. The light receiving apparatus 13B can receive the detection light LU which is emitted from the illumination apparatus 13A and reflected on the detecting surface. The illumination apparatus 13A is provided with a plurality of emission apparatuses 13S for emitting the detection light LU. The illumination apparatus 13A emits the detection light LU from each of the plurality of emission apparatuses 13S and illuminates the plurality of detection light (light flux) LU on the detecting surface.

In this embodiment, the plurality of the detection points Kij of the detection system 13 is disposed separately by a predetermined interval along the X axis direction in the detecting surface. The illumination apparatus 13A can illuminate the detection light LU on each of the plurality of the detection points Kij which are set along the X axis direction in the XY plane. In this embodiment, the detection points Kij are disposed on a single row along the X axis direction. As shown in FIG. 5, the detection points Kij on which the detection light LU is illuminated are disposed on the inside of the detection area AF elongating in the X axis direction. The detection area AF is disposed between the illumination apparatus 13A and the light receiving apparatus 13B. In this embodiment, the size (length) of the detection area AF regarding the X axis direction is substantially equal to the diameter of the substrate P.

Further, the plurality of the detection points Kij may be disposed in a matrix shape in the XY plane. For example, the plurality of the detection points Kij disposed along the X axis direction may be disposed in two lines (two rows) in the Y axis direction. Of course, three or more detection points Kij may be disposed in the Y axis direction. That is, the plurality of the detection points Kij may be disposed in i×j matrix shape (here, and j are arbitrary natural numbers) in the XY plane. Further, when the plurality of the detection points Kij disposed along the X axis direction are disposed in two lines (two rows) or more in the Y axis direction, it is preferable that the positions in the X axis direction be differently set between rows.

As shown in FIG. 5, in this embodiment, the illumination apparatus 13A is disposed on the +Y side of the +X end side of the head unit 47C of the encoder system 14. The light receiving apparatus 13B is disposed on the +Y side of the −X end side of the heat unit 47A.

In this embodiment, the detection area AF of the detection system 13 is disposed between the first and second substrate exchange positions CP1 and CP2 and the exposure position EP. The detection system 13 detects the positional information of the detection surface between the first and second substrate exchange positions CP1 and CP2 and the exposure position EP. In other words, the detection system 13 detects the positional information of the detecting surface which is disposed between the first and second substrate exchange positions CP1 and CP2 and the exposure position EP.

In this embodiment, the detection area AF is disposed between the immersion member 11 (the final optical element 16) and the alignment system 15 with respect to the Y axis direction. In this embodiment, in parallel to at least a part of the detecting operation using the detection system 13, the detecting operation using the alignment system 15 can be performed.

In this embodiment, the detection system 13 detects the positional information regarding the Z axis direction as height information Zij. The detection system 13 illuminates the detection light LU on the plurality of the detection points Kij in the XY plane, and detects the positional information regarding the Z axis direction of each detection point Kij as the height information Zij. The detection system 13 illuminates the detection light LU on each of the plurality of the detection points Kij on the detecting surface, and detects the height information Zij according to the positions in the Z axis direction (height direction) on the detecting surface of each of the plurality of the detection points Kij.

The light receiving results of the detection system 13 (light receiving apparatus 13B) are output to the control apparatus 9. The control apparatus 9 can detect the positional information regarding the Z axis direction on the detecting surface (height direction) and the oblique directions (θX and θY directions) on the basis of the output of the detection system 13. That is, the control apparatus 9 can acquire the positional information (surface positional information) regarding the Z axis direction (height direction) on the detecting surface and the oblique directions (θX and θY directions) on the basis of the height information Zij regarding each of the plurality of the detection points Kij.

In addition, the control apparatus 9 acquires the positional information in the height direction of the detecting surface of each detection point Kij with respect to a predetermined reference surface Zo (for example, the image plane of the projection optical system PL or the best imaging surface) using the height information Zij output from the light receiving apparatus 13B.

For example, the detecting surface of a predetermined detection point among the plurality of the detection points Kij is disposed on the reference surface Zo (or when the detecting surface is in a predetermined positional relationship with the reference surface Zo), the detection system 13 outputs the height information Zij of a predetermined stage (for example, a zero level state). In other words, when the detecting surface and the reference surface Zo are matched with each other (or when the detection surface and the reference surface Zo are in a predetermined positional relationship), a state of the detecting system 13 is adjusted (calibration) such that the height information Zij in a predetermined state is output from the light receiving apparatus 13B. In addition, the height information Zij on each measurement point Kij output from the detection system 13 is changed in proportion to the difference between the reference surface Zo and the position of the detection point Kij in the Z axis direction (height direction). Further, the calibration of the detection system 13 can be performed, for example, using the spatial image measuring system 39. An example of the calibration is disclosed in the specification of US Patent Application Laid-Open Publication No. 2002-0041377.

The control apparatus 9 can obtain the position of the reference surface Zo of each detection point Kij in the height direction (Z axis direction) on the basis of the height information Zij regarding each detection point Kij. In other words, the control apparatus 9 can obtain the positional relationship between the position in the height direction of each detection point Kij and the reference surface Zo.

In addition, the control apparatus 9 can obtain the shape (approximate plane, concave-convex information) of the detecting surface based on the reference surface Zo on the basis of the height information Zij regarding each detection point Kij.

In this embodiment, for example, when the positional information of the surface of the substrate P is being detected, the control apparatus 9 measures the positional information of the substrate stage 1 in the XY plane using at least one of the encoder stage 14 and the interferometer system 12 (second interferometer unit 12B). At the same time, while moving the substrate stage 1 in the XY plane, the control apparatus 9 controls the illumination apparatus 13A of the detection system 13 to illuminate the detection light LU on the substrate P which is held on the substrate holding apparatus 1H.

As described above, in this embodiment, the size (length) of the detection area AF regarding the X axis is substantially equal to the diameter of the substrate P. Therefore, simply by moving the substrate P once with respect to the detection area AF regarding the Y axis direction, the control apparatus 9 can illuminate the detection light LU on the substantially entire surface of the substrate P. The detection light LU illuminated on each of the plurality of the detection points Kij on the surface of the substrate P is reflected on the surface of the substrate P, and received by the light receiving apparatus 13B. The light receiving apparatus 13B outputs the detection signal according to the height information Zij corresponding to the position in the height direction of the surface of the substrate P in each of the plurality of the detection points Kij, which is received by the control apparatus 9. The control apparatus 9 can obtain the positional information of the surface of the substrate P over the entire surface of the substrate P on the basis of the detection signal output from the detection system 13 (light receiving apparatus 13B).

In FIG. 5, the substrate stage 1 can move the exposure position EP to which the exposure light EL emitted from the final optical element 16 is illuminated, the first substrate exchange position (loading position) CP1 in which the substrate P is loaded on the substrate stage 1, and the second substrate exchange position (unloading position) CP2 in which the substrate P is unloaded from the substrate stage 1. In this embodiment, the first substrate exchange position CP1 and the second substrate exchange position CP2 are symmetrically disposed with respect to the straight line LV.

In this embodiment, the detection system 13 is held on the substrate holding apparatus 1H, and detects the positional information of the surface of the substrate P (the unexposed substrate P) before being moved (disposed) to the exposure position EP between the first substrate exchange position (loading position) CP1 and the exposure position EP. That is, in this embodiment, the detection system 13 acquires the positional information of the surface of the substrate P in advance before the exposure light EL is illuminated on the substrate P (before the exposure process of the substrate P starts).

In addition, in this embodiment, the detection system 13 can detect foreign matter on the upper surface of the plate member T including the upper surface of the upper surface of the scale member T2. In addition, the detection system 13 can detect information regarding the size of the foreign matter on the upper surface of the scale member T2 (plate member T). The size of the foreign matter includes the size in the Z axis direction and the size in the XY plane. In addition, the detection system 13 can detect information regarding the amount of foreign matter on the upper surface of the scale member T2. In addition, the detection system 13 can detect information regarding the position of the foreign matter on the upper surface of the scale member T2. In addition, the detection system 13 can detect the area occupied by the foreign matter per unit area on the upper surface of the scale member T2. That is, in this embodiment, the detection information of the foreign matter obtained by the detection system 13 includes at least one of the size information, the amount information, and the positional information of the foreign matter, and the occupation area information of the foreign matter per unit area.

For example, the detection system 13 illuminates the detection light LU on the plurality of the detection points Kij of the upper surface of the scale member T2, detects the positional information of the upper surface of the scale member T2 regarding the Z axis direction in each detection point Kij as the height information Zij, and detects the foreign matter on the upper surface of the scale member T2 on the basis of the height information Zij. The detection system 13 determines whether or not there is the foreign matter on a position (detection point Kij) of which the height information Zij is different from other positions on the upper surface of the scale member T2.

In this embodiment, the detection system 13 detects the height information Zij in the plurality of the detection points Kij of the upper surface of the scale member T2, and it is determined whether at least one of the height information Zij is abnormal. On the basis of the determination result, it is determined whether or not there is foreign matter on the upper surface of the scale member T2.

The abnormality of the height information Zij includes a state where the height information Zij (difference between the reference surface Zo and the height information Zij in the Z axis direction) with respect to the reference surface Zo (reference height information Zr) exceeds a predetermined first acceptable value. When the height information Zij with respect to the reference surface Zo is equal to or less than the first acceptable value, it is determined that there is no foreign matter on the upper surface of the scale member T2.

When there is foreign matter on the upper surface of the scale member T2, the height information Zij in the detection point Kij corresponding to a portion on which the foreign matter exists has a different value compared with the case where the foreign matter does not exist. In addition, when the foreign matter exists on the upper surface of the scale member T2 and the size (which is the size regarding the height direction) of the foreign matter exceeds the predetermined first acceptable value, the height information Zij in the detection point Kij corresponding to the portion in which the foreign matter exists is abnormal.

In this embodiment, the detection system 13 detects the height information (reference height information) Zr of the upper surface of the scale member T2 in each of the plurality of the detection points Kij in an initial state of the upper surface of the scale member T2. The height information (reference height information) Zr on the upper surface of the scale member T2 in this initial state is stored in the storage apparatus 10.

Here, the initial state of the upper surface of the scale member T2 includes a state where the foreign matter does not exist on the upper surface of the scale member T2. For example, the initial state of the upper surface of the scale member T2 includes a state of the scale member T2 after cleaning. In addition, the initial state of the upper surface of the scale member T2 includes a state where the immersion space (immersion area) LS of the liquid LQ on the scale member T2 is not positioned yet.

The detection system 13 detects the foreign matter on the basis of the height information of the upper surface of the scale member T2 in the initial state which is stored in the storage apparatus 10. The control apparatus 9 detects the foreign matter on the basis of the detection result (height information Zij) of the detection system 13 and the height information (reference height information) Zr stored in the storage apparatus 10. That is, the control apparatus 9 compares the detection result (height information Zij) of the detection system 13 with the height information (reference height information) Zr stored in the storage apparatus 10. When the height information Zij (difference between the reference height information Zr and the height information Zij in the Z axis direction is equal to or more than the first acceptable value) detected by the detection system 13 with respect to the reference height information Zr stored in the storage apparatus 10 is equal to or more than the predetermined first acceptable value, the control apparatus 9 determines that the foreign matter exists on the position corresponding to the detection points Kij of the upper surface of the scale member T2.

In addition, the control apparatus 9 can obtain the size of the foreign matter in the Z axis direction (height direction) on the basis of the height information Zij detected by the detection system 13. The size of the foreign matter regarding the Z axis direction includes the height information Zij (difference between the reference surface Zo and the height information Zij in the Z axis direction) with respect to the reference surface Zo (reference height information Zr). That is, in this embodiment, the size of the foreign matter includes the height information Zij of the foreign matter.

In addition, in this embodiment, the control apparatus 9 measures the positional information of the substrate stage 1 using at least one of the encoder system 14 and the interferometer system 12. At the same time, while moving the substrate stage 1 in the XY plane with respect to the detection area AF of the detection system 13, the control apparatus 9 detects the height information Zij of the upper surface of the scale member T2 in each of the plurality of the detection points Kij on the upper surface of the scale member T2 and the foreign matter using the detection system 13. In addition, in this embodiment, the positional information (positional information of the detection light LU detected from each emission apparatus 13S of the illumination apparatus 13A) of each detection point Kij on the upper surface of the scale member T2 in the coordinate system defined by the encoder system 14 (or the interferometer system 12) is known. Therefore, the control apparatus 9 can obtain the positional information of each detection point Kij in the coordinate system defined by the encoder system 14 (or the interferometer system 12). Therefore, the control apparatus 9 can obtain the positional information of the detection point Kij of which the height information Zij is abnormal, that is, the information regarding the position of the foreign matter, in the coordinate system defined by the encoder system 14 (or the interferometer system 12) on the basis of the detection result of the detection system 13 and the measurement result of the encoder system 14 (or the interferometer system 12).

In addition, the control apparatus 9 can obtain the information regarding the amount of foreign matter on the basis of the detection result of the detection system 13 and the measurement result of at least one of the encoder system 14 and the interferometer system 12.

In addition, the control apparatus 9 can obtain the size of the foreign matter in the XY plane on the basis of the detection result of the detection system 13 and the measurement result of at least one of the encoder system 14 and the interferometer system 12.

In addition, the control apparatus 9 can obtain the area occupied by the foreign matter per unit area on the basis of the amount of foreign matter and the size of the foreign matter in the XY plane.

In this embodiment, as an example of the foreign matter which is likely to be attached to the upper surface of the plate member T including the upper surface of the scale member T2, particles may be exemplified which float in the arrangement space of the exposure apparatus EX. In addition, in this embodiment, the substrate P is exposed via the liquid LQ, so that the liquid LQ (droplet of the liquid LQ) may be exemplified as foreign matter which is likely to be attached to the upper surface of the plate member T. In addition, as foreign matter which is likely to be attached to the upper surface of the plate member T, a part of the material generated from the substrate P may be exemplified. For example, a part of the photosensitive film or a part of the protective film (top coat film) may be separated from the substrate P, so that the separated part is likely to be attached to the upper surface of the plate member T. In addition, the liquid LQ of the immersion space LS and the substrate P come into contact with each other, so that a part of the material of the substrate P is eluted to the liquid LQ of the immersion space LS. Then, the immersion space LS (immersion area) of the liquid LQ containing the eluted material is positioned on the plate member T, and the liquid LQ of the immersion space (immersion area) LS and the plate member T come into contact with each other, so that the foreign matter caused by the eluted material is likely to be attached to the upper surface of the plate member T.

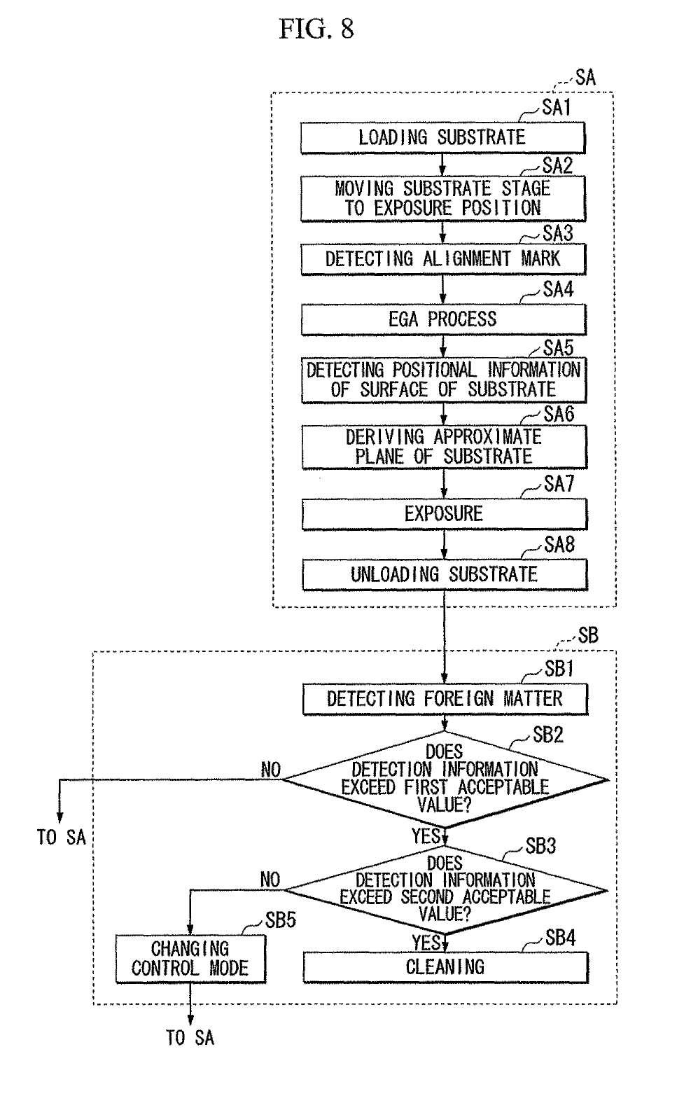

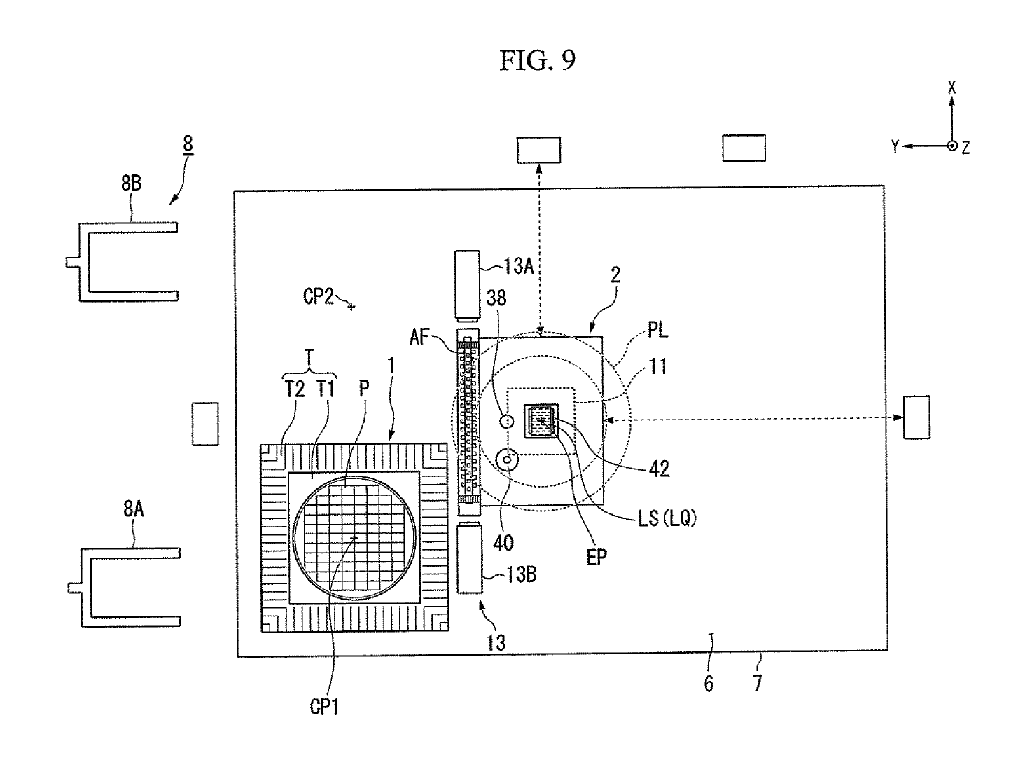

Next, an example of the operations of the exposure apparatus EX having the above-mentioned configuration will be described with reference to the flow chart of FIG. 8 and the schematic views of FIGS. 9 to 14. Further, for the sake of simplicity in the drawings, in FIGS. 9 to 14, the encoder system 14 and the alignment system 15 are omitted.

In this embodiment, an exposure sequence SA including the exposure operation of the substrate P and foreign matter processing sequence SB including the detection operation of the foreign matter on the upper surface of the scale member T2 are included.

In the exposure sequence SA, for example, the loading operation, the alignment operation, the exposure operation and the unloading operation of the substrate P, and the like are performed. In this embodiment, in the alignment operation and the exposure operation of the substrate P, the control apparatus 9 operates the first drive system 4 on the basis of the measurement result of the interferometer system 12 (first interferometer unit 12A), and controls a position of the mask M held on the mask holding apparatus 3H. In addition, in this embodiment, in the alignment operation and the exposure operation of the substrate P, the control apparatus 9 operates the second drive system 5 on the basis of the measurement result of the encoder system 14 and the detection result of the detection system 13, and controls a position of the substrate P held on the substrate holding apparatus 1H. The encoder system 14 measures the positional information of the substrate stage 1 in the XY plane using the scale member T2 at least in the alignment operation and the exposure operation of the substrate P.

In addition, in this embodiment, the laser interferometers 34 and 36 of the second interferometer unit 12B are accessorily used in a case where long-term change (for example, temporal deformation of the scale member) of the measurement values of the encoder system 14 is corrected (calibration).

In addition, in order to perform a substrate exchanging process including the loading operation and the unloading operation, when the substrate stage 1 moves in the vicinity of the first and second substrate exchange positions CP1 and CP2, the control apparatus 9 measures the positional information of the substrate stage 1 in the Y axis direction using the laser interferometer 34, and controls a position of the substrate stage 1. In addition, for example, the control apparatus 9 measures the positional information of the substrate stage 1 by the second interferometer unit 12B between the loading operation and the unloading operation and/or between the exposure operation and the unloading operation, and controls a position of the substrate stage 1 on the basis of the measurement result.

In addition, in this embodiment, in order to perform the unloading operation and the exposure operation of the substrate P, in a moving range of the substrate stage 1, the X scales 28 and 29 respectively face the head units 47B and 47D (X head 49), and the Y scales 26 and 27 respectively face the head units 47A and 47C (Y head 48). In addition, in order to perform the alignment operation and the exposure operation of the substrate P, in a moving range of the substrate stage 1, the Y scales 26 and 27 can face the Y heads 48A and 48B. Therefore, in a moving range (effective stroke range) of the substrate stage 1 for performing the alignment operation and the exposure operation of the substrate P, the control apparatus 9 can obtain the positional information of the substrate stage 1 in the XY plane (X axis, Y axis, and θZ directions) on the basis of at least three measurement values of the linear encoders 14A, 14B, 14C, and 14D. In addition, the control apparatus 9 can control a position of the substrate stage 1 in the XY plane with good accuracy by operating the second drive system 5 on the basis of the positional information. Since the effect of the air fluctuation on the measurement value of the linear encoders 14A to 14D is sufficiently reduced compared with the laser interferometer, the encoder system has favorable short-term stability regarding the measurement value with respect to the air fluctuation compared with the interferometer system.

First, the exposure sequence SA will be described. Further, as a premise in the exposure sequence SA, a base line measuring operation of the primary alignment system 15A and a base line measuring operation of the secondary alignment systems 15Ba to 15Bd are assumed to be already performed. The base line of the primary alignment system 15A is in a positional relationship (distance) with the projection position of the projection optical system PL and the detection reference (detection center) of the primary alignment system 15A. The base lines of the secondary alignment systems 15Ba to 15Bd are respectively relative positions of the detection reference (detection center) of the secondary alignment systems 15Ba to 15Bd with respect to the detection reference (detection center) of the primary alignment 15A. For example, the base line of the primary alignment system 15A is calculated such that the reference mark FM is measured in a state where the reference mark FM is disposed on the detection area (visual field) of the primary alignment system 15A. Further, as the method disclosed in the specification of US Patent Application Laid-Open Publication No. 2002-0041377, in a state where the reference mark FM is disposed on the projection area PR of the projection optical system PL, spatial images of a pair of measurement marks are measured by a spatial image measuring operation of a slit scan manner using a pair of slit patterns SL. Then, the base line of the primary alignment system 15A is calculated on the basis of the detection result and the measurement result. In addition, for example, specific alignment marks on the substrate P (process substrate) at a lot head are detected by the primary alignment system 15A and the secondary alignment systems 15Ba to 15Bd in advance, and the base lines of the secondary alignment systems 15Ba to 15Bd are calculated on the basis of the detection result and the measurement values of the encoders 14A to 14D at the time of detecting the specific marks. Further, the control apparatus 9 adjusts a position of the secondary alignment systems 15Ba to 15Bd in the X axis direction so as to be matched with the alignment shot area in advance.

For example, as shown in FIG. 9, the control apparatus 9 disposes the measurement stage 2 on a position facing the final optical element 16 and the immersion member 11, and moves the substrate stage 1 to the first substrate exchange position CP1 in a state where the immersion space LS is formed between the final optical element 16, the immersion member 11, and the measurement stage 2 with the liquid LQ. Further, when the exposed substrate P is held on the substrate stage 1, the control apparatus 9 moves the substrate stage 1 to the second substrate exchange position CP2, and unloads the exposed substrate P from the substrate stage 1 disposed on the second substrate exchange position CP2 using the transport stage 8. Therefore, the control apparatus 9 moves the substrate stage 1 to the first substrate exchange position CP1. The control apparatus 9 loads the unexposed substrate P to the substrate stage 1 disposed on the first substrate exchange position CP1 using the transport stage 8 (step SA1).

In addition, when the substrate stage 1 moves to the first substrate exchange position CP1, the control apparatus 9 may perform the measurement operation using the measurement stage 2 as needed. For example, the control apparatus 9 illuminates the exposure light EL on the first measurement member 38 in a state where the immersion space LS is formed between the final optical element 16, the immersion member 11, and the first measurement member 38 of the measurement stage 2 with the liquid LQ. As described above the first measurement member 38 constitutes a part of the spatial image measurement system 39, and the spatial image measurement system 39 can obtain the imaging characteristics of the projection optical system PL on the basis of the exposure light EL illuminated on the first measurement member 38. In addition, the control apparatus 9 performs at least one of the measurement operations using the wave front aberration measurement system 41 and the measurement operation using the uneven illuminance measuring system 43 as needed. The control apparatus 9 can adjust the optical characteristics of the projection optical system PL on the basis of the measurement operation using the measurement stage 2.

After the substrate P is loaded on the substrate stage 1, the control apparatus 9 operates the second drive system 5 and starts to move the substrate stage 1 toward the exposure position EP from the first substrate exchange position CP1 (step SA2).

In this embodiment, the detection area of the alignment system 15 is disposed between the first substrate exchange position CP1 and the exposure position EP. In this embodiment, the control apparatus 9 detects the alignment marks provided on the substrate P using the alignment system 15 before the substrate P is subjected to the exposure operation (step SA3).

On the substrate P, a plurality of shot areas as the exposure areas are provided in a matrix shape, for example. The alignment marks are provided on the substrate P so as to correspond to the respective shot areas. The control apparatus 9 detects the alignment marks provided on the substrate P using the alignment system 15 in the middle of moving the substrate stage 1 from the first substrate exchange position CP1 to the exposure position EP. The alignment system 15 detects the alignment marks on the unexposed substrate P held on the substrate stage 1 between the first substrate exchange position CP1 and the exposure position EP.

The control apparatus 9 moves the substrate P held on the substrate stage 1 with respect to the detection area of the alignment system 15, and detects the alignment marks provided on the substrate P. In this embodiment, the alignment system 15 (15A, and 15Ba to 15Bd) has a plurality of detection areas, and can detect the plurality of the alignment marks provided on the substrate P almost at the same time.

In this embodiment, the control apparatus 9 selects a part (for example, about 8 to 16 areas) of the shot areas on the substrate P as the alignment shot areas, and detects the alignment marks corresponding to the selected shot areas using the alignment system 15 (15A, and 15Ba to 15Bd). Then, as disclosed in the specification of U.S. Pat. No. 4,780,617, the control apparatus 9 performs a so-called EGA (Enhanced Global Alignment) process in which the positional information of the detected alignment marks is statistically calculated so as to calculate the positional information (arrangement coordinates) of each shot area on the substrate P (step SA4).

Therefore, the control apparatus 9 can obtain the positional information of each shot area of the substrate P in the XY plane. In addition, the control apparatus 9 may obtain the information regarding the scaling and rotation of the substrate P by the EGA process.

In addition, in this embodiment, the detection area AF of the detection system 13 is disposed between the first substrate exchange position CP1 and the exposure position EP. In this embodiment, the control apparatus 9 detects the positional information of the surface of the substrate P using the detection system 13 before the substrate P is subjected to the exposure operation (step SA5).

The control apparatus 9 detects the positional information of the surface of the substrate P using the detection system 13 in the middle of moving the substrate stage 1 from the first substrate exchange position CP1 to the exposure position EP. The detection system 13 detects the positional information of the surface of the unexposed substrate P held on the substrate stage 1 between the first substrate exchange position CP1 and the exposure position EP.

The control apparatus 9 moves the substrate P held on the substrate stage 1 with respect to the detection area AF of the detection system 13, and detects the positional information of the surface of the substrate P. In this embodiment, the control apparatus 9 obtains the positional information of the surface of the substrate P using the detection system 13 before the substrate P is subjected to the exposure operation.

The control apparatus 9 obtains the shape (approximate plane, concave-convex information) of the surface of the substrate P based on the reference surface Zo on the basis of the height information Zij of each detection point Kij which is detected using the detection system 13 (step SA6).

The control apparatus 9 forms the immersion space LS with the liquid LQ between the final optical element 16, the immersion member 11, and the surface of the substrate P in order to perform the exposure operation on the substrate P.

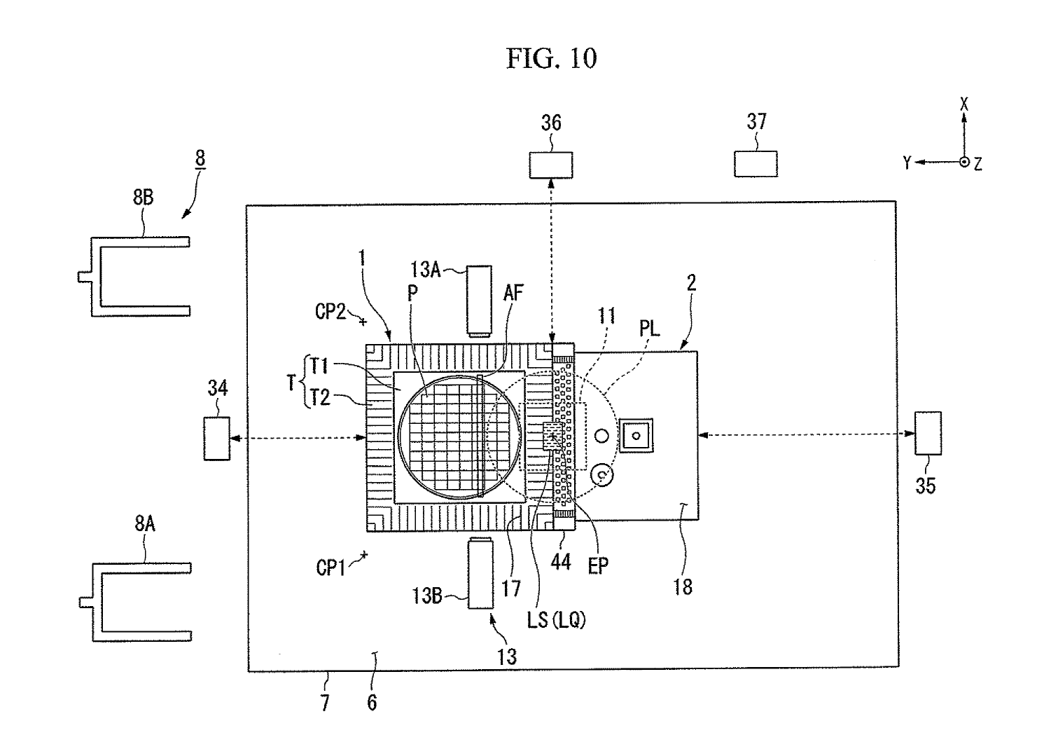

In this embodiment, for example, as disclosed in the specifications of the US Patent Application Laid-Open Publication No. 2006-0023186 and US Patent Application Laid-Open Publication No. 2007-0127006, in order to continue to form a space in which at least one of the substrate stage 1 and the measurement stage 2 can hold the liquid LQ between the final optical element 16 and the immersion member 11, the control apparatus 9 makes at least one of the upper surface 17 of the substrate stage 1 and the upper surface 18 of the measurement stage 2 face the lower surface 16U of the final optical element 16 and the lower surface 11U of the immersion member 11 in a state where the upper surface 17 of the substrate stage 1 is close to or comes into contact with the upper surface 18 (upper surface of the reference member 44) of the measurement stage 2 as shown in FIG. 10. Further, the control apparatus 9 synchronizes and moves the substrate stage 1 and the measurement stage 2 in the XY direction with respect to the final optical element 16 and the immersion member 11. Therefore, while suppressing the leakage of the liquid LQ, the control apparatus 9 can move the immersion space LS of the liquid LQ between the upper surface 17 of the substrate stage 1 and the upper surface 18 of the measurement stage 2. In this embodiment, when the immersion space LS of the liquid LQ is moved by the upper surface 17 of the substrate stage 1 and the upper surface 18 of the measurement stage 2, the control apparatus 9 operates the second drive system 5 such that the upper surface 17 of the substrate stage 1 and the upper surface 18 of the measurement stage 2 have the substantially same height (becoming flush with each other), and adjusts the positional relationship between the substrate stage 1 and the measurement stage 2.

In the above description, in order to move the immersion space LS of the liquid LQ by the upper surface 17 of the substrate stage 1 and the upper surface 18 of the measurement stage 2, at least one of the upper surface 17 of the substrate stage 1 and the upper surface 18 of the measurement stage 2 faces the lower surface 16U of the final optical element 16 and the lower surface 11U of the immersion member 11 in a state where the upper surface 17 of the substrate stage 1 is close to or comes into contact with the upper surface 18 of the measurement stage 2. Further, the substrate stage 1 and the measurement stage 2 are synchronized and moved in the XY direction with respect to the final optical element 16 and the immersion member 11. This operation is arbitrarily referred to as a scrum sweep operation.

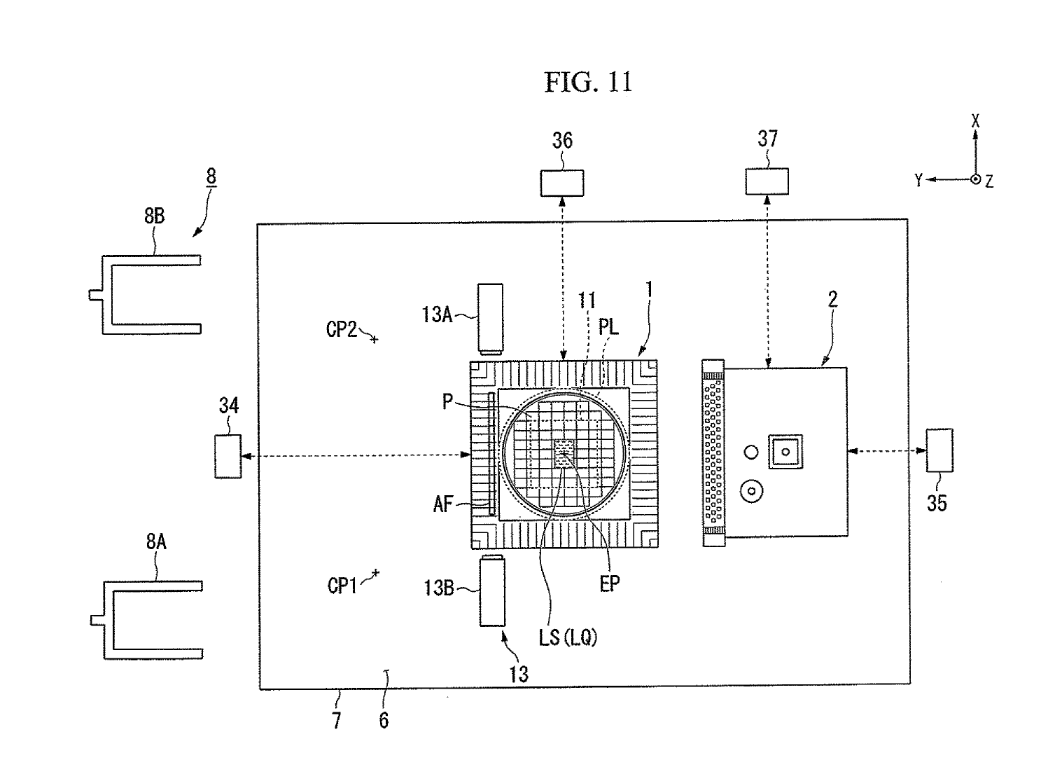

After the scrum sweep operation, as shown in FIG. 11, the final optical element 16 and the immersion member 11 face the surface of the substrate P, and the immersion space LS is formed with the liquid LQ between the final optical element 16, the immersion member 11, and the surface of the substrate P.

The control apparatus 9 adjusts the positional relationship between the projection area PR of the projection optical system PL and the shot area of the substrate P and the positional relationship between the image plane of the projection optical system PL and the surface of the substrate P on the basis of the positional information of the shot areas of the substrate P obtained in the step SA4 and the approximate plane of the substrate P obtained in the step SA6. Further, the control apparatus 9 sequentially exposes the plurality of the shot areas of the substrate P via the liquid LQ of the immersion space LS (step SA7).

In this embodiment, the positional information of the substrate stage 1 is measured by the encoder system 14 in the middle of at least the exposure operation of the substrate P. The control apparatus 9 measures the positional information of the first substrate stage 1 in the XY plane using the encoder system 14 and the scale member T2, and exposes the substrate P.

The control apparatus 9 controls a position of the substrate stage 1 in the XY plane on the basis of the measurement values of the encoder system 14, and at the same time sequentially exposes the plurality of the shot areas of the substrate P. In addition, the control apparatus 9 adjusts the positional relationship between the image plane of the projection optical system PL and the surface of the substrate P on the basis of the approximate plane of the substrate P which is previously deduced before the substrate P is subjected to the exposure operation, and exposes the substrate P at the same time.

The exposure apparatus EX of this embodiment is a scanning-type exposure apparatus (so-called scanning stepper) which synchronizes and moves the mask M and the substrate P in a predetermined scanning direction, and at the same time projects a pattern image of the mask M on the substrate P. In this embodiment, the scanning direction of the substrate P (synchronized moving direction) is assumed as the Y axis direction, and the scanning direction of the mask M (synchronized moving direction) is also assumed as the Y axis direction. The exposure apparatus EX moves the substrate P in the Y axis direction with respect to the projection area PR of the projection optical system PL, and moves the mask M in the Y axis direction with respect to the illumination area IR of the illumination system IL in synchronization with the movement of the substrate P in the Y axis direction. At the same time, the exposure apparatus EX illuminates the exposure light EL on the substrate P via the projection optical system PL and the liquid LQ, and exposes the substrate P.

Further, the control apparatus 9 can synchronize and move the substrate stage 1 and the measurement stage 2 in the XY direction in a state where the upper surface 17 of the substrate stage 1 and the upper surface 18 of the measurement stage 2 are close to or come into contact with each other in exposing the substrate P.

After completing the exposure of the substrate P, in order to move the immersion space LS of the liquid LQ from the upper surface 17 of the substrate stage 1 to the upper surface 18 of the measurement stage 2, the control apparatus 9 performs the scrum sweep operation in a state where the upper surface 17 of the substrate stage 1 and the upper surface 18 of the measurement stage 2 are close to or come into contact with each other. After the scrum sweep operation is completed, the immersion space LS of the liquid LQ is formed between the final optical element 16, the immersion member 11, and the upper surface 18 of the measurement stage 2.

In order to unload the exposed substrate P from the substrate stage 1, the control apparatus 9 operates the second drive system 5 and starts to move the substrate stage 1 from the exposure position EX toward the second substrate exchange position CP2. The control apparatus 9 moves the substrate stage 1 to the second substrate exchange position CP2 and unloads the exposed substrate P from the substrate stage 1 disposed on the second substrate exchange position CP2 using the transport system 8 (step SA8). Thereafter, the control apparatus 9 moves the substrate stage 1 to the first substrate exchange position CP1 and loads the unexposed substrate P on the substrate stage 1 using the transport system 8.

In this embodiment, after disposing the immersion space LS on the measurement stage 2, the control apparatus 9 measures a relative positional relationship (base line) of the detection center of the secondary alignment system 15 with respect to the detection center of the primary alignment system 15A using the reference marks AM of the reference member 44 constituting a part of the measurement stage 2. The control apparatus 9 measures a pair of reference gratings 45 on the reference member 44 using the Y heads 48A and 48B. The control apparatus 9 adjusts a position of the reference member 44 regarding the θZ direction on the basis of the measurement values of the Y heads 48A and 48B. In addition, the control apparatus 9 measures the reference marks AM on the reference member 44 using the primary alignment system 15A, and adjusts a position of the reference member 44 regarding the X axis and Y axis directions, for example, using the measurement values of the second interferometer unit 12B on the basis of the measurement values.

In this state, the control apparatus 9 simultaneously measures the reference marks AM on the reference member 44 which is in the visual field of the respective secondary alignment systems 15Ba to 15Bd using four secondary alignment systems 15Ba to 158d, and obtains the base lines of four secondary alignment systems 15Ba to 15Bd.

In addition, the control apparatus 9 controls the second drive system 5 when the substrate stage 1 is performing the substrate exchange process, and moves the measurement stage 2 to an optimal position (optimal scrum position) for performing the scrum sweep operation.

Hereinafter, the process as described above is repeatedly performed in the exposure sequence SA. That is, the control apparatus 9 operates the second drive system 5, and moves the substrate stage 1 from the first substrate exchange position CP1 to the exposure position EP. The alignment system 15 detects the alignment marks provided on the substrate P in the middle of the operation including the movement of the substrate stage 1 from the first substrate exchange position CP1 to the exposure position EP. In addition, the detection system 13 detects the positional information of the surface of the substrate P in the middle of the operation including the movement of the substrate stage 1 from the first substrate exchange position CP1 to the exposure position EP. Thereafter, the control apparatus 9 moves the substrate stage 1 holding the substrate P to the exposure position EP, and performs the exposure of the substrate P.

Next, a foreign matter processing sequence SB will be described. The foreign matter processing sequence SB includes the operation for detecting foreign matter on the upper surface of the scale member T2 using the detection system 13. In addition, in this embodiment, the foreign matter processing sequence SB includes the process for determining whether or not a cleaning operation is performed on the scale member T2 according to the detection result of the detection system 13. The cleaning operation includes the operation for removing the foreign matter on the upper surface of the scale member T2. In addition, in this embodiment, the foreign matter processing sequence SB includes the operation for determining whether or not the control mode change of the substrate stage 1 is performed according to the detection result of the detection system 13.

In this embodiment, a first acceptable value and a second acceptable value regarding the detection information of the foreign matter obtained by the detection system 13 are set in advance. The foreign matter detection information includes at least one of the size information, the amount information, and the positional information of the foreign matter, and the occupation area information of the foreign matter per unit area. In this embodiment, the second acceptable value is larger than the first acceptable value.

In this embodiment, when the detection information of the foreign matter is equal to or less than the first acceptable value, it is determined that there is no foreign matter which is not acceptable in exposure. The foreign matter which is not acceptable in exposure includes foreign matter which renders the measurement information obtained by the encoder system 14 using the scale member T2 unusable to control the substrate stage 1. The control of the substrate stage 1 includes at least one of the positional control and the movement control of the substrate stage 1. For example, in this embodiment, when the detection information of the foreign matter is equal to or less than the first acceptable value, it is determined that there is no foreign matter. Alternatively, when the detection information of the foreign matter is equal to or less than the first acceptable value, even though it is detected that the foreign matter exists, it is determined that the foreign matter is foreign matter which is acceptable in exposure (foreign matter of which the information measured by the encoder system 14 using the scale member T2 can be used for controlling the substrate stage 1).

In this embodiment, when the detection information of the foreign matter exceeds the first acceptable value and is equal to or less than the second acceptable value, the control mode change of the substrate stage 1 is performed. In addition, in this embodiment, when the detection information of the foreign matter exceeds the second acceptable value, the cleaning operation is performed.

In the description below, a case where the detection information of foreign matter is the size of the foreign matter will be described as an example. Therefore, for example, when it is determined that the size of the foreign matter detected by the detection system 13 is equal to or less than the first acceptable value, the control apparatus 9 determines that there is no foreign matter. When it is determined that the size of the foreign matter exceeds the first acceptable value and is equal to or less than the second acceptable value, the control apparatus 9 performs the control mode change of the substrate stage 1. In addition, when it is determined that the size of the foreign matter exceeds the second acceptable value, the control apparatus 9 performs the cleaning operation.

Further, in this embodiment, when the position of the foreign matter detected by the detection system 13 is in the outside of the acceptable area of the upper surface of the scale member T2, at least one of the control mode change and the cleaning operation is performed. When the position of the foreign matter is in the acceptable area of the upper surface of the scale member T2, the control mode change and the cleaning operation are not performed. Even though the foreign matter exists on the acceptable area of the upper surface of the scale member T2, the foreign matter does not adversely affect the measurement operation of the encoder system 14. For example, the acceptable area includes an area in which there is no diffraction grating RG among the scale member T2.

In this embodiment, the foreign matter processing sequence SB is performed in a predetermined period of time when at least the exposure operation of the substrate P is not carried out. In this embodiment, the foreign matter processing sequence SB is performed in a period of time when the loading operation, the alignment operation, the exposure operation and the unloading operation of the substrate P are not performed, that is, in a period of time when the exposure apparatus EX is in an idle state.

In order to perform the foreign matter processing sequence SB in a predetermined period of time when the substrate P is not subjected to the exposure operation, the foreign matter processing sequence SB is instructed to be performed at a predetermined timing. The control apparatus 9 starts to perform the detection operation of the foreign matter on the upper surface of the scale member T2 using the detection system 13 in a predetermined period of time when the exposure operation of the substrate P is not carried out (step SB1).

The control apparatus 9 measures the positional information of the substrate stage 1 using at least one of the encoder system 14 and the interferometer system 12. At the same time, while moving the substrate stage 1 in the XY plane with respect to the detection area AF of the detection system 13, the control apparatus 9 detects the foreign matter on the upper surface of the scale member T2 using the detection system 13. The control apparatus 9 detects the foreign matter on the basis of the detection result of the detection system 13 and the measurement result of the encoder system 14 (or the interferometer system 12). As described above in this embodiment, the control apparatus 9 can obtain at least one of the size information, the amount information, the positional information of the foreign matter, and the occupation area information of the foreign matter per unit area on the basis of the detection result of the detection system 13 and the measurement result of the encoder system 14 (or the interferometer system 12).

In this embodiment, since the detection system 13 is disposed on a position in which the detection operation of the foreign matter on the upper surface of the scale member T2 can be performed in the period of time when the exposure operation of the substrate P is not carried out, it can effectively detect the existence of the foreign matter on the upper surface of the scale member T2.

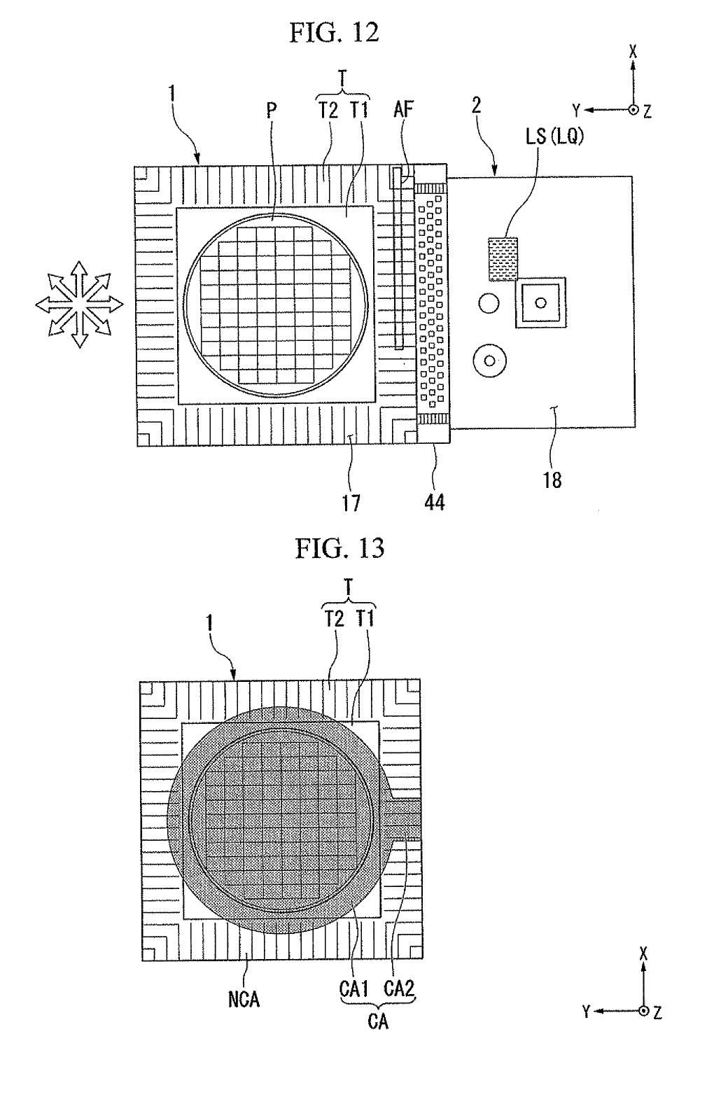

FIG. 12 is a diagram illustrating a state where the foreign matter on the upper surface of the plate member T including the upper surface of the scale member T2 is detected using the detection system 13. As shown in FIG. 12, in order to detect the foreign matter on the upper surface of the plate member T in a predetermined period of time when the exposure operation of the substrate P is not carried out, the control apparatus 9 moves the substrate stage 1 in the XY plane with respect to the detection area AF of the detection system 13. In this embodiment, at least one of the upper surface 17 of the substrate stage 1 and the upper surface 18 of the measurement stage 2 faces the lower surface 16U of the final optical element 16 and the lower surface 11U of the immersion member 11 in a state where the upper surface 17 of the substrate stage 1 and the upper surface 18 of the measurement stage 2 are close to or come into contact with each other. At the same time, the substrate stage 1 and the measurement stage 2 are synchronized and moved in the XY direction. Therefore, the substrate stage 1 can be moved with respect to the detection area AF of the detection system 13 in a state where the immersion space LS is formed with the liquid LQ between the final optical element 16, the immersion member 11, and the measurement stage 2. That is, the substrate stage 1 can be roughly moved in the XY plane with respect to the detection area AF in a state where the immersion space LS is formed, and the detection operation of the foreign matter can be performed on the substantially entire area of the upper surface (upper surface of the plate member T) 17 of the substrate stage 1.

In this embodiment, the substrate P is held on the substrate holding apparatus 1H in the middle of the detection operation of the foreign matter. Further, a dummy substrate may be held on the substrate holding apparatus 1H in the middle of the detection operation of the foreign matter. Unlike the substrate P for the exposure, the dummy substrate is a (clean) material with high cleanness so as to be unlikely to give off any foreign matter. The dummy substrate has the approximately same appearance as that of the substrate P. The substrate holding apparatus 1H can hold the dummy substrate. By holding the substrate P or the dummy substrate by the substrate holding apparatus 1H, the substrate holding apparatus 1H can be protected by the substrate P or the dummy substrate in the middle of the detection operation of the foreign matter. Further, the detection operation of the foreign matter may be performed in a state where a member such as the substrate P or the dummy substrate is not held by the substrate holding apparatus 1H.

In this embodiment, the control apparatus 9 detects foreign matter in a predetermined area on the upper surface of the scale member T2 which comes into contact with the liquid LQ of the immersion space LS in the middle of at least the scrum sweep operation and the exposure operation of the substrate P.

For example, the edge shot area of the substrate P is exposed, the liquid LQ of the immersion space LS protrudes to the outside from the surface of the substrate P, and thus comes into contact with the scale member T2. The exposure light EL is unlikely to be illuminated on the scale member T2. However, since the size of the immersion space (immersion area) LS in the XY plane is larger than the projection area PR which is the illumination area of the exposure light EL, the liquid LQ has a possibility of coming into contact with the scale member T2. In addition, in this embodiment, by performing the scrum sweep operation, the immersion space LS of the liquid LQ moves between the upper surface 17 of the substrate stage 1 and the upper surface 18 of the measurement stage 2, so that a part of the upper surface of the scale member T2 comes into contact with the liquid LQ of the immersion space LS. In the description below, a part of the upper surface of the plate member T coming into contact with the liquid LQ of the immersion space LS in the middle of the scrum sweep operation and the exposure operation of the substrate P is arbitrarily referred to as a contact area CA.

FIG. 13 is a diagram schematically illustrating the contact area CA. As shown in FIG. 13, in this embodiment, an annular area CA1 around the substrate P in the upper surface of the plate member T has a possibility of coming into contact with the liquid LQ of the immersion space LS by the exposure operation (immersion exposure operation) of the substrate P. In addition, in the scrum sweep operation, an area CA2 which is a part on the −Y side of the upper surface 17 of the substrate stage 1, to which the upper surface 18 of the measurement stage 2 is close to or comes into contact with, has a possibility of coming into contact with the liquid LQ of the immersion space LS. That is, in this embodiment, the contact area CA generated by the exposure sequence SA includes the area CA1 and the area CA2.

As described above, as the foreign matter with a possibility of being attached to the upper surface of the plate member T, the liquid LQ (droplet of the liquid LQ) may be exemplified. In the contact area CA coming into contact with the liquid LQ of the immersion space LS, there is a high possibility that, for example, the liquid LQ of the immersion space LS may remain or a part of the material of the substrate P eluted to the liquid LQ may be attached thereto.

Using the detection system 13, by carrying out the detection operation of the foreign matter with priority in the contact area CA with a high possibility that the foreign matter exists among the upper surface of the plate member T including the upper surface of the first plate T1 and the upper surface of the scale member T2, foreign matter can be detected with good efficiency and good accuracy.

In addition, the control apparatus 9 performs the detection operation of the foreign matter in the contact area CA on the upper surface of the plate member T using the detection system 13. Further, the control apparatus 9 performs the detection operation of the foreign matter even on a non-contact area NCA other than the contact area CA. Even in the non-contact area NCA with which the liquid LQ of the immersion space LS does not come into contact, for example, a part of the liquid LQ of the immersion space LS is splashed and attached, or particles floating in the arrangement space of the exposure apparatus EX are attached, so that foreign matter may be present. The control apparatus 9 can detect the existence of the foreign matter in the non-contact area NCA on the upper surface of the plate member T using the detection system 13.

In this embodiment, the control apparatus 9 moves the substrate stage 1 in the XY plane with respect to the detection area AF of the detection system 13. In addition, the control apparatus 9 performs the detection operation of the foreign matter on the substantially entire area of the upper surface of the plate member T including both the contact area CA and the non-contact area NCA.

The control apparatus 9 determines whether or not the size of the foreign matter obtained by the detection system 13 exceeds the first acceptable value on the basis of the detection result of the detection system 13 (step SB2). That is, the control apparatus 9 determines whether or not the foreign matter which is not acceptable in exposure exists.

In the step SB2, when it is determined that the size of the foreign matter is equal to or less than the first acceptable value, that is, when the foreign matter which is not acceptable in exposure is not detected, the control apparatus 9 performs a predetermined process such as performing (restarting) the exposure sequence SA.

On the other hand, in the step SB2, when it is determined that the size of the foreign matter exceeds the first acceptable value, the control apparatus 9 determines whether or not the size of the foreign matter is larger than the first acceptable value and exceeds the second acceptable value (step SB3).

In the step SB3, when it is determined that the size of the foreign matter exceeds the second acceptable value, the control apparatus 9 performs the cleaning operation on the scale member T2 (step SB4). In this embodiment, the control apparatus 9 performs the cleaning operation on the upper surface of the scale member T2 using the immersion member 11.

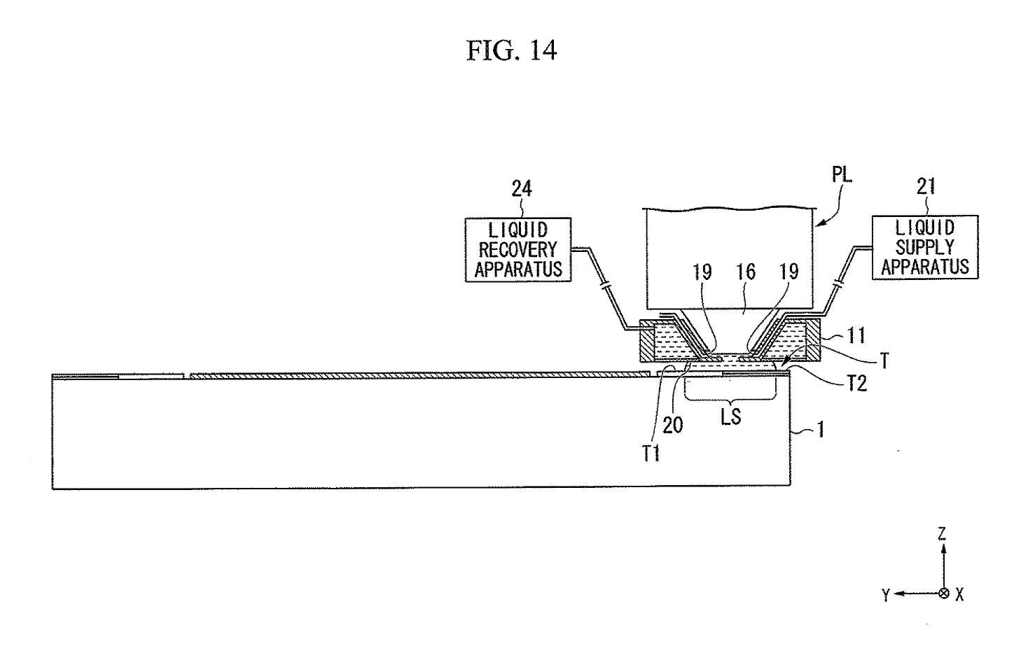

FIG. 14 is a diagram illustrating an operation example of the cleaning operation of the scale member T2. As shown in FIG. 14, the immersion member 11 can form the immersion space LS with the liquid LQ in an interval with the upper surface of the scale member T2. As described above, the control apparatus 9 can obtain a position of the foreign matter on the upper surface of the scale member T2 (plate member T) in the XY plane. In order that the liquid LQ of the immersion space LS comes into contact with the foreign matter on the upper surface of the scale member T2, the control apparatus 9 moves the substrate stage 1 with respect to the immersion member 11, and adjusts the positional relationship between the immersion member 11 (immersion space LS) and the scale member T2 (substrate stage 1).

In this embodiment, in order that the liquid LQ of the immersion space LS comes into contact with the foreign matter on the upper surface of the scale member T2, when the substrate stage 1 is moved with respect to the immersion member 11, the control apparatus 9 lowers a maximum value of a relative moving speed between the immersion member 11 and the substrate stage 1 at the time of the cleaning operation of the scale member T2 compared with the exposure operation of the substrate P. That is, the control apparatus 9 lowers a maximum value of the moving speed of the substrate stage 1 at the time of the cleaning operation of the scale member T2 compared with a maximum value of the moving speed of the substrate stage 1 at the time of the exposure operation of the substrate P. For example, when the foreign matter exists in the non-contact area NCA, the control apparatus 9 adjusts the positional relationship between the immersion member 11 and the substrate stage 1 in order to remove the foreign matter such that the liquid LQ of the immersion space LS comes into contact with the non-contact area NCA. As shown in FIG. 13, when the non-contact area NCA is disposed on the peripheral area of the upper surface 17 of the substrate stage 1 and the immersion space LS is formed on the non-contact area NCA, the liquid LQ has a possibility of overflowing from the substrate stage 1. By lowering a maximum value of the moving speed of the substrate stage 1 at the time of the cleaning operation of the scale member T2, the overflow of the liquid LQ can be suppressed. In addition, by lowering a maximum value of the moving speed of the substrate stage 1 with respect to the immersion space LS, the liquid. LQ can be suppressed from remaining on the upper surface of the scale member T2 at the time of the cleaning operation of the scale member T2. In addition, by lowering a maximum value of the moving speed of the substrate stage 1 with respect to the immersion space LS, the foreign matter can be favorably removed by the liquid LQ of the immersion space LS.

The control apparatus 9 performs the liquid recovery operation using the recovery port 20 in parallel to the liquid supply operation using the supply port 19 in a state where the immersion member 11 faces the area of the upper surface of the scale member T2 on which the foreign matter exists. Therefore, the immersion space LS is filled with the liquid LQ at the time of the cleaning operation of the scale member T2. The liquid LQ is generated by the liquid supply operation using the supply port 19 and the liquid recovery operation using the recovery port 20 so as to flow, so that the foreign matter existing on the upper surface of the scale member T2 can be separated from the upper surface of the scale member T2. The foreign matter separated from the upper surface of the scale member T2 is recovered by the recovery port 20 together with the liquid LQ. In addition, when the foreign matter is a droplet of the liquid LQ, the liquid LQ of the immersion space LS comes into contact with the droplet of the liquid LQ on the scale member T2, so that the droplet can be removed. Therefore, in this embodiment, the upper surface of the scale member T2 is cleaned using the immersion member 11. In this embodiment, the immersion member 11 serves as a cleaning apparatus which can remove the foreign matter.

In addition, in this embodiment, the control apparatus 9 fluctuates or vibrates the substrate stage 2 (scale member T2) with respect to the liquid LQ of the immersion space LS at the time of the cleaning operation of the scale member T2. For example, the control apparatus 9 can fluctuate or vibrate the substrate stage 2 in the XY plane using the second drive system 5. Therefore, the cleaning effect of the scale member T2 can be enhanced. Further, a vibration generating apparatus which can generate vibration (ultrasonic vibration) such as a piezoelectric element may be provided on at least one of the substrate stage 2 and the immersion member 11, so that at least one of the substrate stage 2 and the immersion member 11 may be vibrated using the vibration generating apparatus at the time of the cleaning operation of the scale member T2. Therefore, since the liquid LQ of the immersion space LS and the substrate stage 2 (scale member T2) can be relatively vibrated, the cleaning effect of the scale member T2 can be enhanced.

After the cleaning operation is completed, the control apparatus 9 performs a predetermined process such as performing (restarting) the exposure sequence SA.

In the step SB3, when the size of the foreign matter exceeds the first acceptable value and is equal to or less than the second acceptable value, the control apparatus 9 performs the control mode change of the substrate stage 1 (step SB5).

The control mode change of the substrate stage 1 includes the head unit change which is used for the positional control (movement control) of the substrate stage 1. In this embodiment, in an effective stroke range for moving the substrate stage 1 in order to perform the exposure operation of the substrate P, the X scales 28 and 29 respectively face the head units 47B and 47D (X head 49), and the Y scales 26 and 27 respectively face the head units 47A and 47C (Y head 48). The control apparatus 9 obtains the positional information of the substrate stage 1 in the XY plane (X axis, Y axis, and θZ directions) on the basis of at least three measurement values of the head units 47A, 47B, 47C, and 47D in the effective stroke range of the substrate stage 1. In addition, the control apparatus 9 performs the positional control (movement control) of the substrate stage 1 in the XY plane (X axis, Y axis, and the θZ directions) on the basis of the positional information. The control apparatus 9 changes the head to be used for the positional control (movement control) of the substrate stage 1 according to the detection information of the foreign matter.

As an example, when foreign matter exists on the upper surface of the X scale 28, the control apparatus 9 uses the measurement value of the head unit 47D which can face the X scale 29 without using the measurement value of the head unit 47B which can face the X scale 28. For example, in a state where the positional control of the substrate stage 1 is performed in the effective stroke range on the basis of the measurement values of the head units 47B, 47A, and 47C, when the foreign matter is disposed on the upper surface of the X scale 28 in the measurement area of the X head 49 of the head unit 47B, the control apparatus 9 changes the control mode to switch the measurement values to be used for the positional control of the substrate stage 1 from the measurement value output from the head unit 47B to the measurement value output from the head unit 47D immediately before the foreign matter is disposed on the measurement area. Therefore, the control apparatus 9 obtains the positional information of the substrate stage 1 in the XY plane (X axis, Y axis, and θZ directions) on the basis of the measurement values output from the head units 47D, 47A, and 47C. The control apparatus 9 can perform (continue) the positional control (movement control) of the substrate stage 1 in the XY plane (X axis, Y axis, and θZ directions) on the basis of the positional information.

In addition, for example, when the foreign matter exists on the upper surface of the X scale 28, the control apparatus 9 can change the control mode so as to use the measurement values output from the head units 47D, 47A, and 47C for the positional control of the substrate stage 1 in the effective stroke range, and so as not to use the measurement value output from the head unit 47B.

In addition, the control mode change of the substrate stage 1 includes the head unit change which is used for the positional control (movement control) of the substrate stage 1 among the plurality of heads disposed on one head unit. The control apparatus 9 changes the head to be used for the positional control of the substrate stage 1 among the plurality of heads disposed on one head unit.

As an example, in a state where the X scale 28 is measured by the plurality of the X heads 49 of the head unit 47B in order to measure the positional information of the substrate stage 1, when the foreign matter exists on the upper surface of the X scale 28, the control apparatus 9 changes the X head 49 for measuring the X scale 28. For example, among the plurality of the X heads 49, in a state where the positional control of the substrate stage 1 is performed in the effective stroke range on the basis of the measurement value of the first X head 49, when the foreign matter is disposed on the upper surface of the X scale 28 in the measurement area of the first X head 49, the control apparatus 9 changes the control mode so as to switch the measurement value to be used for the positional control of the substrate stage 1 from the measurement value output from the first X head 49 to the measurement value output from the second X head 49 other than the first X head 49 immediately before the foreign matter is disposed on the measurement area. Therefore, the control apparatus 9 obtains the positional information of the substrate stage 1 on the basis of the measurement value output from the second X head 49. The control apparatus 9 can perform (continue) the positional control (movement control) of the substrate stage 1 on the basis of the positional information.

In addition, the control mode change of the substrate stage 1 includes the measurement information change to be used for the positional control (movement control) of the substrate stage 1 from the encoder system 14 to the interferometer system 12. The control apparatus 9 changes the measurement value to be used for the positional control of the substrate stage 1 from the measurement value output from the encoder system 14 to the measurement value output from the interferometer system 12.

As an example, in a state where the scale member T2 is measured by the encoder system 14 in order to measure the positional information of the substrate stage 1, when the foreign matter exists on the upper surface of the X scale 28, the control apparatus 9 instantaneously switches the measurement value to be used for the positional control of the substrate stage 1 in the X axis direction from the measurement value output from the encoder system 14 (head unit 47B) to the measurement value output from the interferometer system 12 (laser interferometer 36). For example, in a state where the positional control of the substrate stage 1 in the X axis direction is performed in the effective stroke range on the basis of the measurement value of the head unit 48B, when the foreign matter is disposed on the upper surface of the X scale 28 in the measurement area of the head unit 47B (X head 49), the control apparatus 9 changes the control mode so as to switch the measurement value to be used for the positional control of the substrate stage 1 from the measurement value output from the head unit 47B to the measurement value output from the laser interferometer 36. In this embodiment, the output coordinates of the interferometer system 12 are corrected so as to be continuous to the output coordinates of the encoder system 14 immediately before the switching. Therefore, the control apparatus 9 obtains the positional information of the substrate stage 1 regarding the X axis on the basis of the measurement value output from the interferometer system 12 (laser interferometer 36). The control apparatus 9 can perform (continue) the positional control (movement control) of the substrate stage 1 on the basis of the positional information.

Then, the control apparatus 9 performs (restarts) the exposure sequence SA on the basis of the changed control mode.

Further, here, the detection information of the foreign matter has been described using the example of the size of the foreign matter, but the detection information of the foreign matter includes the amount information of the foreign matter, the occupation area information of the foreign matter per unit area, and the like. For example, when the amount of foreign matter to be detected by the detection system 13 exceeds a predetermined acceptable value, the control apparatus 9 can perform the cleaning operation. In addition, when the occupation area of the foreign matter per unit area exceeds a predetermined acceptable value, the control apparatus 9 can perform the cleaning operation.

Further, here, the foreign matter on the upper surface of the scale member T2 is detected, and the cleaning operation is performed using the immersion member 11. However, the cleaning operation can be performed on the first plate T1 according to the detection result of the detection system 13.

As described above, according to this embodiment, the foreign matter on the upper surface of the scale member T2 can be detected using the detection system 13. In addition, according to this embodiment, since the size of the foreign matter can be detected using the detection system 13, the treatment of the foreign matter can take measures according to the size thereof. For example, when it is determined that the size of the foreign matter is acceptable in exposure on the basis of the detection result of the detection system 13, even though the cleaning operation is omitted, the positional control (movement control) can be favorably performed on the substrate stage 1. In other words, without carrying out the unnecessary cleaning operation, the positional control of the substrate stage 1 can be favorably performed. Therefore, it is possible to suppress the throughput of the exposure apparatus EX in accordance with the cleaning operation. In addition, when the size of the foreign matter is an unacceptable size in exposure but is to a certain extent a small size (a size equal to or less than the first acceptable value), the control mode change of the substrate stage 1 is carried out in consideration of the foreign matter without performing the cleaning operation. Therefore, the positional control of the substrate stage 1 using the scale member T2 and the positional control (movement control) of the substrate stage 1 can be performed. In addition, when the size of the foreign matter is large, the cleaning operation is performed, so that the foreign matter is removed, and then the position measurement and positional control of the substrate stage 1 can be favorably performed. Therefore, according to this embodiment, the position measurement of the substrate stage 1 and the positional control of the substrate stage 1 can be performed in a state where the effect of the foreign matter is suppressed. Therefore, it is possible to suppress the degradation in the movement performance of the substrate stage 1. Therefore, exposure error can be suppressed from occurring, and device error can be suppressed from occurring.

In addition, according to this embodiment, since the positional information of the substrate stage 1 in the XY plane is measured by the encoder system 14 which has good short-term stability regarding the measurement value, the measurement can be performed with high accuracy while the effect of air fluctuation is being suppressed.

### Second Embodiment

Next, the second embodiment will be described. In the description below, the same or equivalent components as those in the above-mentioned first embodiment are designated by the same reference numerals, and the description thereof will be simplified or omitted.

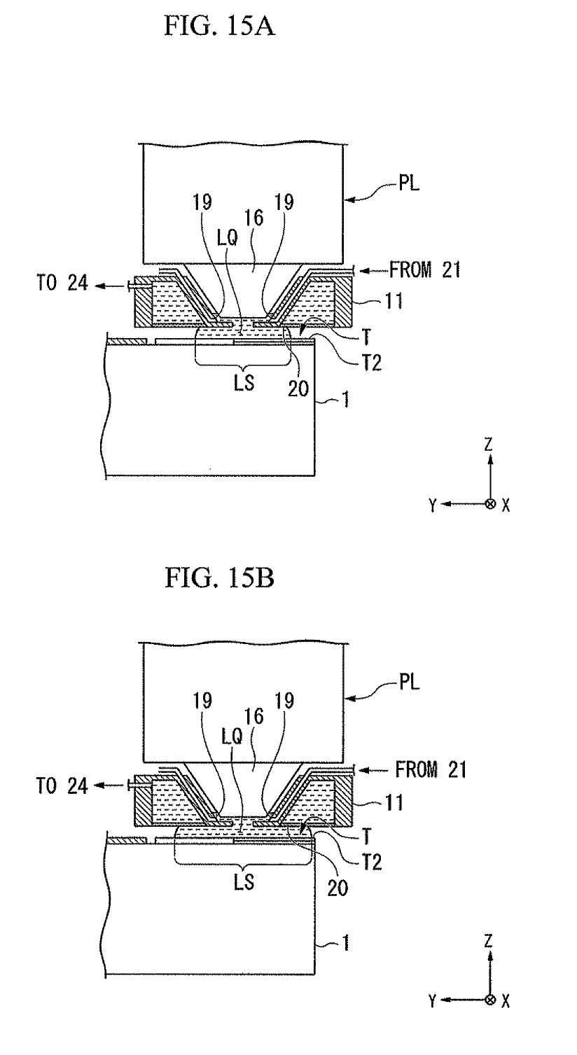

FIGS. 15A and 15B are diagrams illustrating an example of the operation of the immersion member 11 according to the second embodiment. This embodiment is characterized in that the immersion space LS to be formed at the time of the cleaning operation of the scale member T2 is enlarged more than the immersion space LS to be formed at the time of the exposure operation of the substrate P.

FIG. 15A is a diagram illustrating an example of the immersion space LS which is formed at the time of the exposure operation of the substrate P. FIG. 15B is a diagram illustrating an example of the immersion space LS which is formed at the time of the cleaning operation of the scale member T2. As shown in FIG. 15B, the immersion space LS of the immersion member 11 is enlarged compared with the immersion space LS formed at the time of the exposure operation of the substrate P, and the upper surface of the scale member T2 is subjected to the cleaning operation. The immersion space LS of the immersion member 11 is enlarged such that the liquid LQ of the immersion space LS comes into contact with the foreign matter on the upper surface of the scale member T2. The control apparatus 9 adjusts at least one of the liquid supply operation using the supply port 19 and the liquid recovery operation using the recovery port 20 such that the size of the immersion space LS in the XY plane becomes larger at the time of the cleaning operation of the scale member T2 compared with at the time of the exposure operation of the substrate P.

For example, the expansion of the immersion space LS includes the increase in liquid supply amount per unit time using the supply port 19. As described above, the liquid supply apparatus 21 can adjust the liquid supply amount per unit time to be supplied to the supply port 19 using the liquid supply amount adjusting apparatus. The control apparatus 9 controls the liquid supply amount adjusting apparatus to increase the liquid supply amount per unit time to be supplied to the supply port 19 at the time of the cleaning operation of the scale member T2 compared with the liquid supply amount per unit time to be supplied to the supply port 19 at the time of the exposure operation of the substrate P. Therefore, the control apparatus 9 can enlarge the immersion space LS.

In addition, the expansion of the immersion space LS includes the decrease in liquid recovery amount per unit time using the recovery port 20. As described above, the liquid recovery apparatus 24 can adjust the liquid recovery amount per unit time to be recovered by the recovery port 20 using the liquid recovery amount adjusting apparatus. The control apparatus 9 controls the liquid recovery amount adjusting apparatus to decrease the liquid recovery amount per unit time to be recovered by the recovery port 20 at the time of the cleaning operation of the scale member T2 compared with the liquid recovery amount per unit time to be recovered by the recovery port 20 at the time of the exposure operation of the substrate P. Therefore, the control apparatus 9 can enlarge the immersion space LS.

By expanding the immersion space LS, the foreign matter can be favorably removed from the substantially entire area of the upper surface 17 of the substrate stage 1 including the peripheral area of the upper surface 17 (upper surface of the scale member T2) of the substrate stage 1. For example, even when the foreign matter exists in the peripheral area of the upper surface 17 (upper surface of the scale member T2) of the substrate stage 1, the immersion space LS is enlarged and the liquid LQ and the foreign matter can come into contact with each other while the leakage of the liquid LQ is suppressed. Therefore, the foreign matter can be removed.

Further, in the above-mentioned first and second embodiments, description has been made using an example that the upper surface of the scale member T2 (plate member T) is subjected to the cleaning operation using the immersion space LS of the liquid LQ which is formed by the immersion member 11. However, at the time of the cleaning operation of the scale member T2, the immersion space LS may be filled with the liquid (cleaning liquid) which is different from the liquid LQ to be used in the immersion exposure. For example, the cleaning liquid is supplied by the supply port 19, and the immersion space is formed by the cleaning liquid between the immersion member 11 and the scale member T2, so that the scale member T2 can be cleaned.

As the cleaning liquid, for example, hydrogen water (hydrogen dissolved water) may be employed in which hydrogen gas is dissolved in water. In addition, as the cleaning liquid, ozone water (ozone dissolved water) in which ozone gas is dissolved in water, nitrogen water (nitrogen dissolved water) in which nitrogen gas is dissolved in water, argon water (argon dissolved water) in which argon gas is dissolved in water, carbon dioxide water (carbon dioxide dissolved water) in which carbon dioxide gas is dissolved in water, or the like may be employed for controlling water in which predetermined gas is dissolved. In addition, gas supersaturation water may be employed in which gas is dissolved in water at a solubility equal to or more that that under atmospheric pressure. In addition, as the cleaning liquid, hydrogen peroxide water in which hydrogen peroxide is added to water, chlorine-added water in which chlorine (hypochlorous acid) is added to water, ammonia water in which ammonia is added to water, choline water in which choline is added to water, sulfate-added water in which sulfuric acid is added to water, or the like may be employed. In addition, as the cleaning liquid, alcohol such as alethanol and methanol, ether, gamma butyrolactone, thinner, surfactant, fluorinated solvent such as HFE, or the like may be employed.

Further, in the above-mentioned first and second embodiments, unlike the exposure sequence SA, a dedicated sequence (foreign matter processing sequence) SB for the foreign matter process is provided. The control apparatus 9 can perform the detection operation of the foreign matter, for example, in the exposure sequence SA. For example, when a plurality of the substrates P are sequentially subjected to the exposure operation, the detection operation of the foreign matter can be performed using the detection system 13 for each interval period of every exchange of the substrate P in the substrate stage 1, that is, each time one sheet of the substrate P is subjected to the exposure operation. In addition, the timing of the detection operation of the foreign matter is not limited to each time one sheet of the substrate P is subjected to the exposure operation. The detection operation may be performed at each predetermined time interval, such as each time a predetermined number of the substrates P are subjected to the exposure operation, or each time a predetermined time lapses.

In addition, in each embodiment described above, the upper surface of the scale member T2 passes through the detection area AF of the detection system 13 when the substrate stage 1 is moved from the first substrate exchange position CP1 to the exposure position EP and when the substrate stage 1 moves from the exposure position EP to the second substrate exchange position CP2. Therefore, the detection operation of the foreign matter on the upper surface of the scale member T2 can be performed in the middle of moving the substrate stage 1.

In addition, in each embodiment described above, when the substrate P held on the substrate stage 1 is disposed on the projection area PR of the projection optical system PL which is the illumination area of the exposure light EL, the positional relationship between the projection optical system PL and the detection system 13 is determined such that at least a part of the scale member T2 is disposed on the detection area AF of the detection system 13. Therefore, the control apparatus 9 can perform the detection operation of the foreign matter on the upper surface of the scale member T2 using the detection system 13 in parallel to at least the exposure operation of the substrate P. In this case, in parallel to the exposure operation, the detection operation of the foreign matter may not be carried out on the entire surface of the scale member T2. That is, in parallel to the exposure operation, the detection operation of the foreign matter is carried out on a part of the scale member T2, and the detection operation of the foreign matter on the remaining portion of the scale member T2 may be carried out in a period of time other than the exposure operation in the exposure sequence, or in a period of time in the above-mentioned foreign matter processing sequence.

In addition, in each embodiment described above, when the substrate P held on the substrate stage 1 is disposed on the detection area of the alignment system 15, the positional relationship between the alignment system 15 and the detection system 13 is determined such that at least a part of the scale member T2 is disposed on the detection area AF of the detection system 13. Therefore, the control apparatus 9 can perform the detection operation of the foreign matter on the upper surface of the scale member T2 using the detection system 13 in parallel to the detection operation of the alignment marks of the substrate P.

The detection operation of the foreign matter on the upper surface of the scale member T2 (plate member T) can be performed in the exposure sequence SA including the exposure operation of the substrate P. In this case, the detection operation of the foreign matter may be carried out on the entire surface of the scale member T2 in one operation (period) of the exposure sequence SA, and the detection operation of the foreign matter may be carried out on the entire surface of the scale member T2 in the other periods (operation) of the exposure sequence SA. Furthermore, the detection operation of the foreign matter may be carried out on the entire surface of the scale member T2 in a part of the exposure sequence SA and the above-mentioned foreign matter processing sequence.

In addition, the detection operation of the foreign matter is performed in the middle of a predetermined operation before the exposure operation of the substrate P, in which the moving operation of the substrate stage 1 from the first substrate exchange position CP1 to the exposure position EP and the detecting operation of the alignment of the substrate P are included. When the foreign matter is detected in this detection operation, the control apparatus 9 cleans the upper surface of the scale member T2 using the immersion member 11, and then can start the exposure operation of the substrate P held on the substrate stage 1. In addition, the control apparatus 9 can change the control mode of the substrate stage 1 before the exposure operation of the substrate P.

In addition, for example, when the detection operation of the foreign matter is performed in the middle of the exposure operation of the substrate P and the foreign matter is detected by the detection operation, the control apparatus 9 completes the exposure on all of the shot areas on the substrate P. Before the substrate stage 1 holding the exposed substrate P is moved to the second substrate exchange position CP2, the control apparatus 9 can clean the upper surface of the scale member T2 using the immersion member 11.

In addition, for example, when the detection operation of the foreign matter is performed in the middle of the exposure operation of the substrate P and the foreign matter is detected by the detection operation, the control apparatus 9 completes the exposure operation on predetermined shot areas and suspends the exposure operation of the substrate P. The control apparatus 9 can perform the cleaning operation on the upper surface of the scale member T2 using the immersion member 11, and then restart the exposure operation on the remaining shot areas.

In addition, for example, when the detection operation of the foreign matter is performed in the middle of the exposure operation of the substrate P and the foreign matter is detected by the detection operation, the control apparatus 9 can change the control mode of the substrate stage 1 in the middle of the exposure operation of the substrate P.

In addition, for example, the detection operation of the foreign matter is performed in the middle of a predetermined operation after the exposure operation of the substrate P, which includes a moving operation of the substrate stage 1 from the exposure position EP to the second substrate exchange position CP2. When the foreign matter is detected by the detection operation, the control apparatus 9 can unload the substrate P after the upper surface of the scale member T2 is cleaned using the immersion member 11.

In addition, when the foreign matter is detected by the detection operation of the foreign matter after the exposure operation of the substrate P, the control apparatus 9 unloads the exposed substrate P, and then can perform the cleaning operation on the upper surface of the scale member T2 using the immersion member 11. When the cleaning operation of the upper surface of the scale member T2 is performed after the exposed substrate P is unloaded, a new substrate (unexposed) P may be held on the substrate holding apparatus 1H, or a dummy substrate may be held thereon, or no substrate may be held thereon.

In addition, the control apparatus 9 is connected to an input apparatus through which an operation signal can be input to the control apparatus 9. For example, when an operator inputs an operation signal by the input apparatus, the foreign matter processing sequence may be performed. Further, for example, the input apparatus includes a keyboard, a touch panel, an operation button, and the like.

In addition, for example, when the foreign matter processing sequence is performed many times at a predetermined interval, the detection operation of the foreign matter is performed on a first area on the upper surface of the scale member T2 in the nth foreign matter processing sequence SB. Then, in the (n+1)th foreign matter processing sequence, the detection operation of the foreign matter may be performed on a second area on the upper surface of the scale member T2.

In addition, in each embodiment described above, the foreign matter on the upper surface 18 of the measurement stage 2 can be detected using the detection system 13. In addition, the cleaning operation can be performed on the upper surface 18 of the measurement system 2 on the basis of the detection result of the detection system 13. The foreign matter on the upper surface of the measurement stage 2 is detected and the cleaning operation is performed on the basis of the detection result, so that the measurement operation using the measurement stage 2 can be performed with good accuracy.

In addition, in each embodiment described above, the foreign matter on the upper surface of the reference member 44 including the reference grating 45 can be detected using the detection system 13. In addition, the cleaning operation of the reference member 44 can be performed on the basis of the detection result of the detection system 13. The foreign matter on the upper surface of the reference member 44 is detected and the cleaning operation is performed on the basis of the detection result, so that the measurement operation using the reference member 44 and the adjustment operation of the alignment system 15 can be favorably performed.

Further, in each embodiment described above, it may be configured such that the control apparatus 9 measures the positional information of the substrate stage 1 in the XY plane using the encoder system 14, and at the same time moves the upper surface of the substrate stage 1 (plate member T) with respect to the detection area AF of the detection system 13 so as to perform the detection operation of the foreign matter on at least a part of the upper surface of the plate member T, and obtains the position of the foreign matter in the XY plane on the basis of the detection result of the focus detection system 13 and the measurement result of the encoder system 14. Alternatively, it may be configured such that the control apparatus 9 measures the position information of the substrate stage 1 in the XY plane using the interferometer system 12, and at the same time moves the upper surface of the substrate stage 1 (plate member T) with respect to the detection area AF of the detection system 13 so as to perform the detection operation of the foreign matter on at least a part of the upper surface of the plate member T, and obtains the position of the foreign matter in the XY plane on the basis of the detection result of the focus detection system 13 and the measurement result of the interferometer system 12.

Further, in each embodiment described above, the description has been made such that the positional information of the substrate stage 1 which is measured by the interferometer system 12 (second interferometer unit 12B) is not used for the alignment operation and the exposure operation of the substrate P, but mainly used for the calibration operation (that is, correction of the measurement value) of the encoder system 14. However, the measurement information (that is, at least one of five pieces of the positional information in the X axis, the Y axis, the θX, the θY, and the θZ directions) of the interferometer system 12 may be used for the alignment operation and the exposure operation of the substrate P. In this embodiment, the encoder system 14 measures the positional information of the substrate stage 1 in three directions of the X axis, the Y axis, and the θZ directions. Then, in the alignment operation and the exposure operation of the substrate P, among a variety of the measurement information of the interferometer system 12, only the positional information regarding a direction, for example, the θX direction and/or the θY direction, which is different from the measurement directions (X axis, Y axis, and θZ directions) of the positional information of the substrate stage 1 obtained by the encoder system 14 may be used. Alternatively, the positional information regarding the directions (that is, at least one of the X axis, the Y axis, and the θZ directions) similar to the measurement direction of the encoder system 14 may be used. In addition, the interferometer system 12 may measure the positional information of the Z direction of the substrate stage 1. In this case, the positional information in the Z axis direction may be used for the alignment operation and the exposure operation of the substrate P.

In addition, in order to clean the upper surface of the scale member T2 (plate member T), it may be configured such that an immersion member is formed which is different from the immersion member 11 for forming the immersion space to fill the optical path of the exposure light EL with the liquid LQ, and the immersion space is formed between the immersion member and the plate member T, so that the upper surface of the plate member T is cleaned.

In addition, the exposure apparatus EX is provided with an air supply apparatus which has an injection port to inject gas. The gas is injected on the upper surface of the plate member T by the injection port, and blows the foreign matter off, so that the upper surface of the plate member T can be cleaned. In addition, the exposure apparatus EX is provided with a vacuum apparatus which has a suction port to absorb the gas. The foreign matter on the upper surface of the plate member T is absorbed using the suction inlet, so that the upper surface of the plate member T can be cleaned.

Further, in each embodiment described above, the scale member T2 can be exchanged at a predetermined timing. For example, even in the cleaning operation using the immersion member 11 or the like, when the foreign matter is not totally removed, the scale member T2 can be exchanged with a new scale member T2.

In addition, in each embodiment described above, the exposure apparatus EX is provided with a notification apparatus. The notification apparatus may be operated on the basis of the detection result of the detection system 13. That is, when the detection system 13 detects the foreign matter on the upper surface of the scale member T2, the notification apparatus informs an operator that the foreign matter is detected. For example, the notification apparatus informs the operator using light, sound, image, and the like. Therefore, the operator suspends the operation of the exposure apparatus EX, withdraws the substrate stage 1 from the exposure apparatus EX, so that the maintenance of the scale member T2 can be performed. The operator can clean the scale member T2 as the maintenance. For example, the cleaning of the scale member T2 includes rinsing with an alkali solvent. For example, when a material generated from the substrate P is attached to the scale member T2 as the foreign matter, rinsing with the alkali solvent is effective. In addition, the operator can exchange the scale member T2 with a new scale member T.

### Third Embodiment

Next, a third embodiment will be described. In the description below, the same or equivalent components as those in the above-mentioned first embodiment are designated by the same reference numerals, and the description thereof will be simplified or omitted.

This embodiment is characterized in that the encoder system 14 can determine a specific area on the substrate P in which a measurement error occurs by defect of the scale member T2.

Also in this embodiment, the detection system 13 can detect the information regarding the state (surface stage) of the upper surface of the plate member T including the upper surface of the scale member T2. In this embodiment, the surface stage of the scale member T2 (plate member T) includes defect information of the upper surface of the scale member T2. The defect information includes information regarding the foreign matter on the scale member T2. That is, the detection system 13 can detect the foreign matter on the scale member T2 using the defect information regarding the upper surface of the scale member T2.

In this embodiment, the detection system 13 can detect the information regarding the size of the foreign matter on the upper surface of the scale member T2. The size of the foreign matter includes the size in the Z axis direction and the size in the XY plane. In addition, the detection system 13 can detect the information regarding the amount of foreign matter on the upper surface of the scale member T2. In addition, the detection system 13 can detect the information regarding the position of the foreign matter on the upper surface of the scale member T2. In addition, the detection system 13 can detect the information regarding the occupation area of the foreign matter per unit area on the upper surface of the scale member T2. That is, in this embodiment, the defect information regarding the upper surface of the scale member T2 includes the size information, the amount information, the positional information of the foreign matter, and the occupation area information of the foreign matter per unit area.

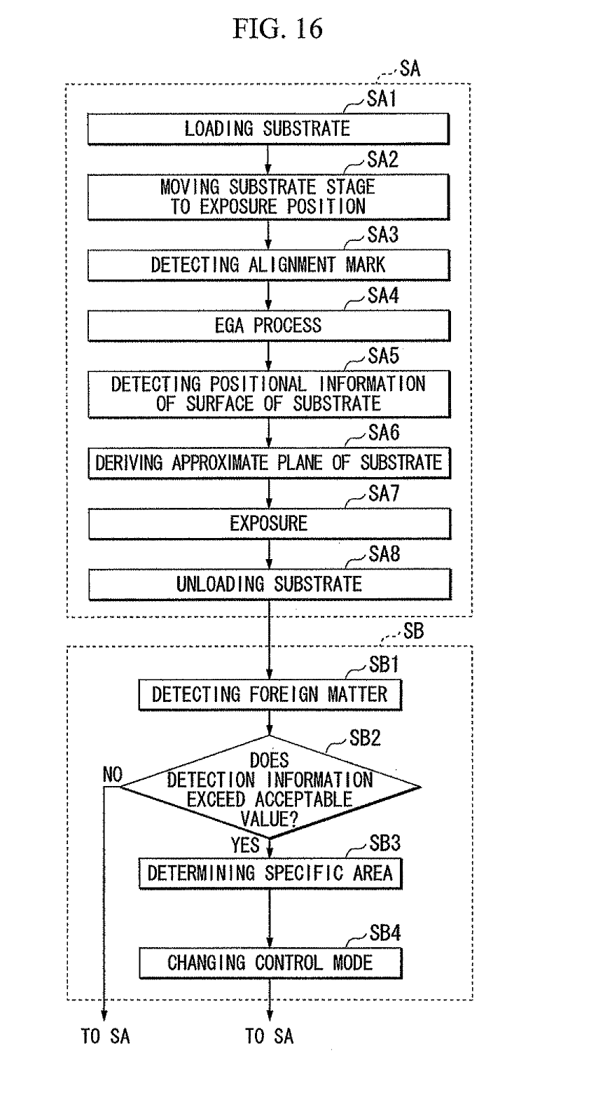

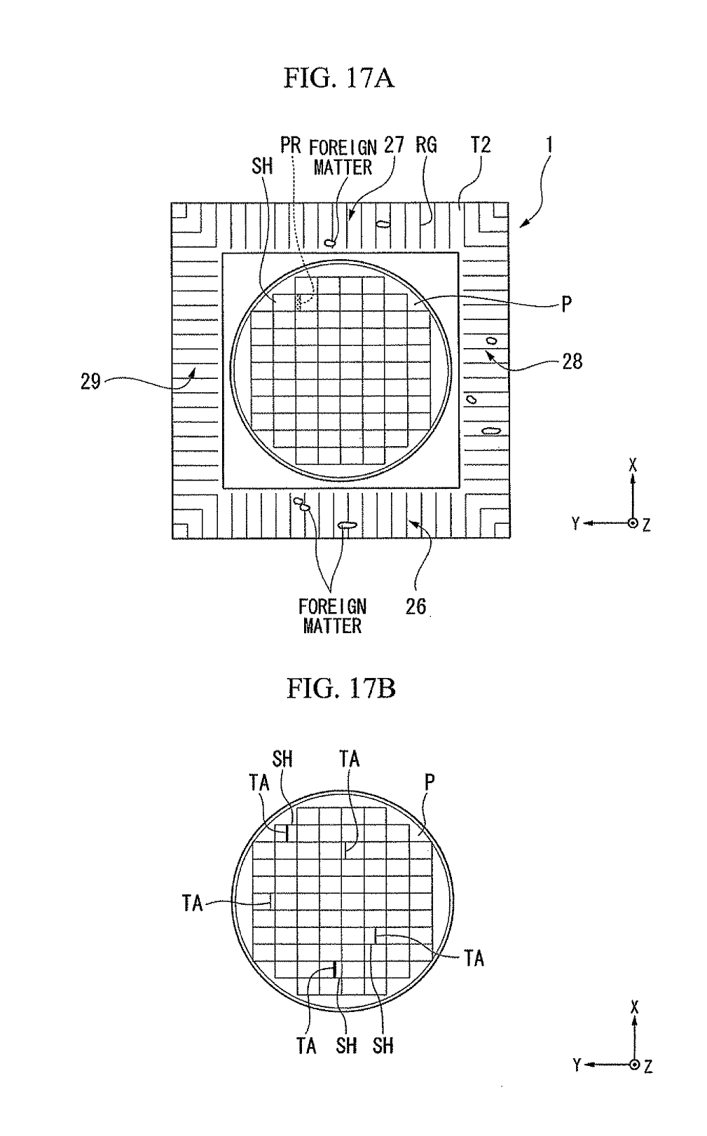

An example of the operations of the exposure apparatus EX in this embodiment will be described with reference to the schematic views of FIGS. 9 to 13, the flow chart of FIG. 16, and the schematic views of FIGS. 17A to 19. Further, for the sake of simplicity in the drawings, in FIGS. 9 to 13, and FIGS. 17A to 19, the encoder system 14 and the alignment system 15 are omitted.

In this embodiment, an exposure sequence SA including the exposure operation of the substrate P and foreign matter processing sequence SB including the detection operation of the state (surface state) of the upper surface of the scale member T2 are included.

In the exposure sequence SA, for example, the loading operation, the alignment operation, the exposure operation and the unloading operation of the substrate P, and the like are performed. In this embodiment, in the alignment operation and the exposure operation of the substrate P, the control apparatus 9 operates the first drive system 4 on the basis of the measurement result of the interferometer system 12 (first interferometer unit 12A), and controls a position of the mask M held on the mask holding apparatus 3H. In addition, in this embodiment, in the alignment operation and the exposure operation of the substrate P, the control apparatus 9 operates the second drive system 5 on the basis of the measurement result of the encoder system 14 and the detection result of the detection system 13, and controls a position of the substrate P held on the substrate holding apparatus 1H. The encoder system 14 measures the positional information of the substrate stage 1 in the XY plane using the scale member T2 at least in the alignment operation and the exposure operation of the substrate P.

In addition, in this embodiment, the laser interferometers 34 and 36 of the second interferometer unit 12B are accessorily used in a case where long-term change (for example, temporal deformation of the scale member) of the measurement values of the encoder system 14 is corrected (calibration).

In addition, in order to perform a substrate exchanging process including the loading operation and the unloading operation, when the substrate stage 1 moves in the vicinity of the first and second substrate exchange positions CP1 and CP2, the control apparatus 9 measures the positional information of the substrate stage 1 in the Y axis direction using the laser interferometer 34, and controls a position of the substrate stage 1. In addition, for example, the control apparatus 9 measures the positional information of the substrate stage 1 by the second interferometer unit 12B between the loading operation and the unloading operation and/or between the exposure operation and the unloading operation, and controls a position of the substrate stage 1 on the basis of the measurement result.

In addition, in this embodiment, in order to perform the unloading operation and the exposure operation of the substrate P, in a moving range of the substrate stage 1, the X scales 28 and 29 respectively face the head units 47B and 47D (X head 49), and the Y scales 26 and 27 respectively face the head units 47A and 47C (Y head 48). In addition, in order to perform the alignment operation and the exposure operation of the substrate P, in a moving range of the substrate stage 1, the Y scales 26 and 27 can face the Y heads 48A and 48B. Therefore, in a moving range (effective stroke range) of the substrate stage 1 for performing the alignment operation and the exposure operation of the substrate P, the control apparatus 9 can obtain the positional information of the substrate stage 1 in the XY plane (X axis, Y axis, and θZ directions) on the basis of at least three measurement values of the linear encoders 14A, 14B, 14C, and 14D. In addition, the control apparatus 9 can control a position of the substrate stage 1 in the XY plane with good accuracy by operating the second drive system 5 on the basis of the positional information. Since the effect of the air fluctuation on the measurement value of the linear encoders 14A to 14D is sufficiently reduced compared with the laser interferometer, the encoder system has favorable short-term stability regarding the measurement value with respect to the air fluctuation compared with the interferometer system.

First, the exposure sequence SA will be described. Further, as a premise in the exposure sequence SA, a base line measuring operation of the primary alignment system 15A and a base line measuring operation of the secondary alignment systems 15Ba to 15Bd are assumed to be already performed. The base line of the primary alignment system 15A is in a positional relationship (distance) with the projection position of the projection optical system PL and the detection reference (detection center) of the primary alignment system 15A. The base lines of the secondary alignment systems 15Ba to 15Bd are respectively relative positions of the detection reference (detection center) of the secondary alignment systems 15Ba to 15Bd with respect to the detection reference (detection center) of the primary alignment system 15A. For example, the base line of the primary alignment system 15A is calculated such that the reference mark FM is measured in a state where the reference mark FM is disposed on the detection area (visual field) of the primary alignment system 15A. Further, as the method disclosed in the specification of US Patent Application Laid-Open Publication No. 2002-0041377, in a state where the reference mark FM is disposed on the projection area PR of the projection optical system PL, spatial images of a pair of measurement marks are measured by a spatial image measuring operation of a slit scan manlier using a pair of slit patterns SL. Then, the base line of the primary alignment system 15A is calculated on the basis of the detection result and the measurement result. In addition, for example, specific alignment marks on the substrate P (process substrate) at a lot head are detected by the primary alignment system 15A and the secondary alignment systems 15Ba to 15Bd in advance, and the base lines of the secondary alignment systems 15Ba to 15Bd are calculated on the basis of the detection result and the measurement values of the encoders 14A to 14D at the time of detecting the specific marks. Further, the control apparatus 9 adjusts a position of the secondary alignment systems 15Ba to 15Bd in the X axis direction so as to be matched with the alignment shot area in advance.

For example, as shown in FIG. 9, the control apparatus 9 disposes the measurement stage 2 on a position facing the final optical element 16 and the immersion member 11, and moves the substrate stage 1 to the first substrate exchange position CP1 in a state where the immersion space LS is formed between the final optical element 16, the immersion member 11, and the measurement stage 2 with the liquid LQ. Further, when the exposed substrate P is held on the substrate stage 1, the control apparatus 9 moves the substrate stage 1 to the second substrate exchange position CP2, and unloads the exposed substrate P from the substrate stage 1 disposed on the second substrate exchange position CP2 using the transport stage 8. Therefore, the control apparatus 9 moves the substrate stage 1 to the first substrate exchange position CP1. The control apparatus 9 loads the unexposed substrate P to the substrate stage 1 disposed on the first substrate exchange position CP1 using the transport stage 8 (step SA1).

In addition, when the substrate stage 1 moves to the first substrate exchange position CP1, the control apparatus 9 may perform the measurement operation using the measurement stage 2 as needed. For example, the control apparatus 9 illuminates the exposure light EL on the first measurement member 38 in a state where the immersion space LS is formed between the final optical element 16, the immersion member 11, and the first measurement member of the measurement stage 2 with the liquid LQ. As described above, the first measurement member 38 constitutes a part of the spatial image measurement system 39, and the spatial image measurement system 39 can obtain the imaging characteristics of the projection optical system PL on the basis of the exposure light EL illuminated on the first measurement member 38. In addition, the control apparatus 9 performs at least one of the measurement operations using the wave front aberration measurement system 41 and the measurement operation using the uneven illuminance measuring system 43 as needed. The control apparatus 9 can adjust the optical characteristics of the projection optical system PL on the basis of the measurement operation using the measurement stage 2.

After the substrate P is loaded on the substrate stage 1, the control apparatus 9 operates the second drive system 5 and starts to move the substrate stage 1 toward the exposure position EP from the first substrate exchange position CP1 (step SA2).

In this embodiment, the detection area of the alignment system 15 is disposed between the first substrate exchange position CP1 and the exposure position EP. In this embodiment, the control apparatus 9 detects the alignment marks provided on the substrate P using the alignment system 15 before the substrate P is subjected to the exposure operation (step SA3).

On the substrate P, a plurality of shot areas SH as the exposure areas is provided in a matrix shape, for example. The alignment marks are provided on the substrate P so as to correspond to the respective shot areas SH. The control apparatus 9 detects the alignment marks provided on the substrate P using the alignment system 15 in the middle of moving the substrate stage 1 from the first substrate exchange position CP1 to the exposure position EP. The alignment system 15 detects the alignment marks on the unexposed substrate P held on the substrate stage 1 between the first substrate exchange position CP1 and the exposure position EP.

The control apparatus 9 moves the substrate P held on the substrate stage 1 with respect to the detection area of the alignment system 15, and detects the alignment marks provided on the substrate P. In this embodiment, the alignment system 15 (15A, 15Ba to 15Bd) has a plurality of detection areas, and can detect the plurality of the alignment marks provided on the substrate P almost at the same time.

In this embodiment, the control apparatus 9 selects a part (for example, about 8 to 16 areas) of the shot areas SH on the substrate P as the alignment shot areas, and detects the alignment marks corresponding to the selected shot areas using the alignment system 15 (15A, 15Ba to 15Bd). Then, as disclosed in the specification of U.S. Pat. No. 4,780,617, the control apparatus 9 performs a so-called EGA (Enhanced Global Alignment) process in which the positional information of the detected alignment marks is statistically calculated so as to calculate the positional information (arrangement coordinates) of each shot area on the substrate P (step SA4).

Therefore, the control apparatus 9 can obtain the positional information of each shot area SH of the substrate P in the XY plane. In addition, the control apparatus 9 may obtain the information regarding the scaling and rotation of the substrate P by the EGA process.

In addition, in this embodiment, the detection area AF of the detection system 13 is disposed between the first substrate exchange position CP1 and the exposure position EP. In this embodiment, the control apparatus 9 detects the positional information of the surface of the substrate P using the detection system 13 before the substrate P is subjected to the exposure operation (step SA5).

The control apparatus 9 detects the positional information of the surface of the substrate P using the detection system 13 in the middle of moving the substrate stage 1 from the first substrate exchange position CP1 to the exposure position EP. The detection system 13 detects the positional information of the surface of the unexposed substrate P held on the substrate stage 1 between the first substrate exchange position CP1 and the exposure position EP.

The control apparatus 9 moves the substrate P held on the substrate stage 1 with respect to the detection area AF of the detection system 13, and detects the positional information of the surface of the substrate P. In this embodiment, the control apparatus 9 obtains the positional information of the surface of the substrate P using the detection system 13 before the substrate P is subjected to the exposure operation.

The control apparatus 9 obtains the shape (approximate plane, concave-convex information) of the surface of the substrate P based on the reference surface Zo on the basis of the height information Zij of each detection point Kij which is detected using the detection system 13 (step SA6).

The control apparatus 9 forms the immersion space LS with the liquid LQ between the final optical element 16, the immersion member 11, and the surface of the substrate P in order to perform the exposure operation on the substrate P.

In this embodiment, for example, as disclosed in the specifications of the US Patent Application Laid-Open Publication No. 2006-0023186 and US Patent Application Laid-Open Publication No. 2007-0127006, in order to continue to form a space in which at least one of the substrate stage 1 and the measurement stage 2 can hold the liquid LQ between the final optical element 16 and the immersion member 11, the control apparatus 9 makes at least one of the upper surface 17 of the substrate stage 1 and the upper surface 18 of the measurement stage 2 face the lower surface 16U of the final optical element 16 and the lower surface 11U of the immersion member 11 in a state where the upper surface 17 of the substrate stage 1 is close to or comes into contact with the upper surface 18 (upper surface of the reference member 44) of the measurement stage 2 as shown in FIG. 10. Further, the control apparatus 9 synchronizes and moves the substrate stage 1 and the measurement stage 2 in the XY direction with respect to the final optical element 16 and the immersion member 11. Therefore, while suppressing the leakage of the liquid LQ, the control apparatus 9 can move the immersion space LS of the liquid LQ between the upper surface 17 of the substrate stage 1 and the upper surface 18 of the measurement stage 2. In this embodiment, when the immersion space LS of the liquid LQ is moved by the upper surface 17 of the substrate stage 1 and the upper surface 18 of the measurement stage 2, the control apparatus 9 operates the second drive system 5 such that the upper surface 17 of the substrate stage 1 and the upper surface 18 of the measurement stage 2 have the substantially same height (becoming flush with each other), and adjusts the positional relationship between the substrate stage 1 and the measurement stage 2.

In the above description, in order to move the immersion space LS of the liquid LQ by the upper surface 17 of the substrate stage 1 and the upper surface 18 of the measurement stage 2, at least one of the upper surface 17 of the substrate stage 1 and the upper surface 18 of the measurement stage 2 faces the lower surface 16U of the final optical element 16 and the lower surface 11U of the immersion member 11 in a state where the upper surface 17 of the substrate stage 1 is close to or comes into contact with the upper surface 18 of the measurement stage 2. Further, the substrate stage 1 and the measurement stage 2 are synchronized and moved in the XY direction with respect to the final optical element 16 and the immersion member 11. This operation is arbitrarily referred to as a scrum sweep operation.

After the scrum sweep operation, as shown in FIG. 11, the final optical element 16 and the immersion member 11 face the surface of the substrate P, and the immersion space LS is formed with the liquid LQ between the final optical element 16, the immersion member 11, and the surface of the substrate P.

The control apparatus 9 adjusts the positional relationship between the projection area PR of the projection optical system PL and the shot area SH of the substrate P and the positional relationship between the image plane of the projection optical system PL and the surface of the substrate P on the basis of the positional information of the shot areas SH of the substrate P obtained in the step SA4 and the approximate plane of the substrate P obtained in the step SA6. Further, the control apparatus 9 sequentially exposes the plurality of the shot areas SH of the substrate P via the liquid LQ of the immersion space LS (step SA7).

In this embodiment, the positional information of the substrate stage 1 is measured by the encoder system 14 in the middle of at least the exposure operation of the substrate P. The control apparatus 9 measures the positional information of the substrate stage 1 in the XY plane using the encoder system 14 and the scale member T2, and exposes the substrate P.

The control apparatus 9 controls a position of the substrate stage 1 in the XY plane on the basis of the measurement values of the encoder system 14, and at the same time sequentially exposes the plurality of the shot areas SH of the substrate P. In addition, the control apparatus 9 adjusts the positional relationship between the image plane of the projection optical system PL and the surface of the substrate P on the basis of the approximate plane of the substrate P which is previously deduced before the substrate P is subjected to the exposure operation, and exposes the substrate P at the same time.

The exposure apparatus EX of this embodiment is a scanning-type exposure apparatus (so-called scanning stepper) which synchronizes and moves the mask M and the substrate P in a predetermined scanning direction, and at the same time projects a pattern image of the mask M on the substrate P. In this embodiment, the scanning direction of the substrate P (synchronized moving direction) is assumed as the Y axis direction, and the scanning direction of the mask M (synchronized moving direction) is also assumed as the Y axis direction. The exposure apparatus EX moves the shot areas SH of the substrate P in the Y axis direction with respect to the projection area PR of the projection optical system PL, and moves the mask M in the Y axis direction with respect to the illumination area IR of the illumination system IL in synchronization with the movement of the substrate P in the Y axis direction. At the same time, the exposure apparatus EX illuminates the exposure light EL on the substrate P via the projection optical system PL and the liquid LQ, and exposes the substrate P.

Further, the control apparatus 9 can synchronize and move the substrate stage 1 and the measurement stage 2 in the XY direction in a state where the upper surface 17 of the substrate stage 1 and the upper surface 18 of the measurement stage 2 are close to or come into contact with each other in exposing the substrate P.

After completing the exposure of the substrate P, in order to move the immersion space LS of the liquid LQ from the upper surface 17 of the substrate stage 1 to the upper surface 18 of the measurement stage 2, the control apparatus 9 performs the scrum sweep operation in a state where the upper surface 17 of the substrate stage 1 and the upper surface 18 of the measurement stage 2 are close to or come into contact with each other. After the scrum sweep operation is completed, the immersion space LS of the liquid LQ is formed between the final optical element 16, the immersion member 11, and the upper surface 18 of the measurement stage 2.

In order to unload the exposed substrate P from the substrate stage 1, the control apparatus 9 operates the second drive system 5 and starts to move the substrate stage 1 from the exposure position EX toward the second substrate exchange position CP2. The control apparatus 9 moves the substrate stage 1 to the second substrate exchange position CP2 and unloads the exposed substrate P from the substrate stage 1 disposed on the second substrate exchange position CP2 using the transport system 8 (step SA8). Thereafter, the control apparatus 9 moves the substrate stage 1 to the first substrate exchange position CP1 and loads the unexposed substrate P on the substrate stage 1 using the transport system 8.

In this embodiment, after disposing the immersion space LS on the measurement stage 2, the control apparatus 9 measures a relative positional relationship (base line) of the detection center of the secondary alignment system 15 with respect to the detection center of the primary alignment system 15A using the reference marks AM of the reference member 44 constituting a part of the measurement stage 2. The control apparatus 9 measures a pair of reference gratings 45 on the reference member 44 using the Y heads 48A and 48B. The control apparatus 9 adjusts a position of the reference member 44 regarding the θZ direction on the basis of the measurement values of the Y heads 48A and 48B. In addition, the control apparatus 9 measures the reference marks AM on the reference member 44 using the primary alignment system 15A, and adjusts a position of the reference member 44 regarding the X axis and Y axis directions, for example, using the measurement values of the second interferometer unit 12B on the basis of the measurement values.

In this state, the control apparatus 9 simultaneously measures the reference marks AM on the reference member 44 which is in the visual field of the respective secondary alignment systems 15Ba to 15Bd using four secondary alignment systems 15Ba to 15Bd, and obtains the base lines of four secondary alignment systems 15Ba to 15Bd.

In addition, the control apparatus 9 controls the second drive system 5 when the substrate stage 1 is performing the substrate exchange process, and moves the measurement stage 2 to an optimal position (optimal scrum position) for performing the scrum sweep operation.

Hereinafter, the process as described above is repeatedly performed in the exposure sequence SA. That is, the control apparatus 9 operates the second drive system 5, and moves the substrate stage 1 from the first substrate exchange position CP1 to the exposure position EP. The alignment system 15 detects the alignment marks provided on the substrate P in the middle of the operation including the movement of the substrate stage 1 from the first substrate exchange position CP1 to the exposure position EP. In addition, the detection system 13 detects the positional information of the surface of the substrate P in the middle of the operation including the movement of the substrate stage 1 from the first substrate exchange position CP1 to the exposure position EP. Thereafter, the control apparatus 9 moves the substrate stage 1 holding the substrate P to the exposure position EP, and performs the exposure of the substrate P.

Next, the detection sequence SB will be described. The detection sequence SB includes an operation for detecting the information regarding the state (surface state) of the upper surface of the scale member T2 using the detection system 13. The information regarding the surface state of the scale member T2 includes the defect information of the upper surface of the scale member T2. The defect information includes the detection information of the foreign matter on the scale member T2. In the description below, a case where the defect information is the detection information of the foreign matter will be described as an example.

The detection information of the foreign matter includes at least one of the size information, the amount information, and the positional information of the foreign matter, and the occupation area information of the foreign matter per unit area. That is, in this embodiment, the detection sequence SB includes an operation for detecting the foreign matter on the scale member T2. In addition, in this embodiment, the detection sequence SB includes an operation in which the encoder system 14 determines the specific area TA on the substrate P in which measurement error occurs due to the defect of the scale member T2 in the middle of the scanning exposure of the substrate P. In addition, in this embodiment, the detection sequence SB includes an operation for changing the control mode of the substrate stage 1 according to the detection result of the detection system 13.

In this embodiment, an acceptable value regarding the detection information of the foreign matter obtained by the detection system 13 is set in advance. In this embodiment, when the detection information of the foreign matter is equal to or less than the acceptable value, it is determined that there is no foreign matter which is not acceptable in exposure. The foreign matter which is not acceptable in exposure includes foreign matter of which the measurement information obtained by the encoder system 14 is substantially unusable in the driving of the substrate stage 1 which uses the second drive system 5 when the substrate P is subjected to the exposure operation. In other words, the foreign matter which is not acceptable in exposure includes foreign matter due to which the encoder system 14 cannot perform the position measurement of the substrate stage 1.

For example, in this embodiment, when the detection information of the foreign matter is equal to or less than the acceptable value, it is determined that there is no foreign matter. Alternatively, when the detection information of the foreign matter is equal to or less the acceptable value, even though it is detected that the foreign matter exists, it is determined that the foreign matter is foreign matter which is acceptable in exposure, in other words, foreign matter which allows substantial use of the measurement information of the encoder system 14 in the driving of the substrate stage 1 (foreign matter which does not prevent the position measurement of the encoder system 14 using the scale member T2 being performed).

On the other hand, when the detection information of the foreign matter exceeds the acceptable value, it is determined that the foreign matter is foreign matter which is not acceptable in exposure. In other words, it is determined that the foreign matter is foreign matter which renders the measurement information of the encoder system 14 substantially unusable in the driving of the substrate stage 1 (foreign matter which prevents the position measurement of the encoder system 14 using the scale member T2 from being performed).

In this embodiment, when the detection information of the foreign matter exceeds the acceptable value, the specific area TA on the substrate P is determined, and the control mode change of the substrate stage 1 is performed.

In the description below, a case where the detection information of foreign matter is the size of the foreign matter will be described as an example. Therefore, for example, when it is determined that the size of the foreign matter detected by the detection system 13 is equal to or less than the acceptable value, the control apparatus 9 determines that there is no foreign matter. When it is determined that the size of the foreign matter exceeds the acceptable value, the control apparatus 9 determines the specific area TA on the substrate P, and the control mode change of the substrate stage 1 is performed.

Further, in this embodiment, when the position of the foreign matter detected by the detection system 13 is in the outside of the acceptable area of the upper surface of the scale member T2, at least one of the determination of the specific area TA and the control mode change is performed. When the position of the foreign matter is in the acceptable area of the upper surface of the scale member T2, the determination of the specific area TA and the control mode change are not performed. Even though the foreign matter exists on the acceptable area of the upper surface of the scale member T2, the foreign matter does not adversely affect the measurement operation of the encoder system 14. For example, the acceptable area includes an area in which there is no diffraction grating RG among the scale member T2.

In this embodiment, the detection sequence SB is performed in a predetermined period of time when at least the exposure operation of the substrate P is not carried out. In this embodiment, the detection sequence SB is performed in a period of time when the loading operation, the alignment operation, the exposure operation and the unloading operation of the substrate P are not performed, that is, in a period of time when the exposure apparatus EX is in an idle state.

In order to perform the detection sequence SB in a predetermined period of time when the substrate P is not subjected to the exposure operation, the detection sequence SB is instructed to be performed at a predetermined timing. The control apparatus 9 starts to perform the detection operation of the foreign matter on the upper surface of the scale member T2 using the detection system 13 in a predetermined period of time when the exposure operation of the substrate P is not carried out (step SB1).

The control apparatus 9 measures the positional information of the substrate stage 1 using at least one of the encoder system 14 and the interferometer system 12. At the same time, while moving the substrate stage 1 in the XY plane with respect to the detection area AF of the detection system 13, the control apparatus 9 detects the foreign matter on the upper surface of the scale member T2 using the detection system 13. The control apparatus 9 detects the foreign matter on the basis of the detection result of the detection system 13 and the measurement result of the encoder system 14 (or the interferometer system 12). As described above in this embodiment, the control apparatus 9 can obtain at least one of the size information, the amount information, the positional information of the foreign matter, and the occupation area information of the foreign matter per unit area on the basis of the detection result of the detection system 13 and the measurement result of the encoder system 14 (or the interferometer system 12).

In this embodiment, since the detection system 13 is disposed on a position in which the detection operation of the foreign matter on the upper surface of the scale member T2 can be performed in the period of time when the exposure operation of the substrate P is not carried out, it can effectively detect the existence of the foreign matter on the upper surface of the scale member T2.

FIG. 12 is a diagram illustrating a state where the foreign matter on the upper surface of the plate member T including the upper surface of the scale member T2 is detected using the detection system 13. As shown in FIG. 12, in order to detect the foreign matter on the upper surface of the plate member T in a predetermined period of time when the exposure operation of the substrate P is not carried out, the control apparatus 9 moves the substrate stage 1 in the XY plane with respect to the detection area AF of the detection system 13. In this embodiment, at least one of the upper surface 17 of the substrate stage 1 and the upper surface 18 of the measurement stage 2 faces the lower surface 16U of the final optical element 16 and the lower surface 11U of the immersion member 11 in a state where the upper surface 17 of the substrate stage 1 and the upper surface 18 of the measurement stage 2 are close to or come into contact with each other. At the same time, the substrate stage 1 and the measurement stage 2 are synchronized and moved in the XY direction. Therefore, the substrate stage 1 can be moved with respect to the detection area AF of the detection system 13 in a state where the immersion space LS is formed with the liquid LQ between the final optical element 16, the immersion member 11, and the measurement stage 2. That is, the substrate stage 1 can be roughly moved in the XY plane with respect to the detection area AF in a state where the immersion space LS is formed, and the detection operation of the foreign matter can be performed on the substantially entire area of the upper surface (upper surface of the plate member T) 17 of the substrate stage 1.

In this embodiment, the substrate P is held on the substrate holding apparatus 1H in the middle of the detection operation of the foreign matter. Further, a dummy substrate may be held on the substrate holding apparatus 1H in the middle of the detection operation of the foreign matter. Unlike the substrate P for the exposure, the dummy substrate is a (clean) material with high cleanness so as to be unlikely to give off any foreign matter. The dummy substrate has the approximately same appearance as that of the substrate P. The substrate holding apparatus 1H can hold the dummy substrate. By holding the substrate P or the dummy substrate by the substrate holding apparatus 1H, the substrate holding apparatus 1H can be protected by the substrate P or the dummy substrate in the middle of the detection operation of the foreign matter. Further, the detection operation of the foreign matter may be performed in a state where a member such as the substrate P or the dummy substrate is not held by the substrate holding apparatus 1H.

In this embodiment, the control apparatus 9 detects the foreign matter in a predetermined area on the upper surface of the scale member T2 which comes into contact with the liquid LQ of the immersion space LS in the middle of at least the scrum sweep operation and the exposure operation of the substrate P.

For example, the edge shot area of the substrate P is exposed, the liquid LQ of the immersion space LS exits to the outside from the surface of the substrate P, and thus comes into contact with the scale member T2. The exposure light EL is unlikely to be illuminated on the scale member T2. However, since the size of the immersion space (immersion area) LS in the XY plane is larger than the projection area PR which is the illumination area of the exposure light EL, the liquid LQ has a possibility of coming into contact with the scale member T2. In addition, in this embodiment, by performing the scrum sweep operation, the immersion space LS of the liquid LQ moves between the upper surface 17 of the substrate stage 1 and the upper surface 18 of the measurement stage 2, so that a part of the upper surface of the scale member T2 comes into contact with the liquid LQ of the immersion space LS. In the description below, a part of the upper surface of the plate member T coming into contact with the liquid LQ of the immersion space LS in the middle of the scrum sweep operation and the exposure operation of the substrate P is arbitrarily referred to as a contact area CA.

FIG. 13 is a diagram schematically illustrating the contact area CA. As shown in FIG. 13, in this embodiment, an annular area CA1 around the substrate P in the upper surface of the plate member T has a possibility of coming into contact with the liquid LQ of the immersion space LS by the exposure operation (immersion exposure operation) of the substrate P. In addition, in the scrum sweep operation, an area CA2 which is a part on the −Y side of the upper surface 17 of the substrate stage 1, to which the upper surface 18 of the measurement stage 2 is close to or comes into contact with, has a possibility of coming into contact with the liquid LQ of the immersion space LS. That is, in this embodiment, the contact area CA generated by the exposure sequence SA includes the area CA1 and the area CA2.

As described above, as the foreign matter with a possibility of being attached to the upper surface of the plate member T, the liquid LQ (droplet of the liquid LQ) may be exemplified. In the contact area CA coming into contact with the liquid LQ of the immersion space LS, there is a high possibility that, for example, the liquid LQ of the immersion space LS may remain or a part of the material of the substrate P eluted to the liquid LQ may be attached thereto.

Using the detection system 13, by carrying out the detection operation of the foreign matter with priority in the contact area CA with a high possibility that the foreign matter exists among the upper surface of the plate member T including the upper surface of the first plate T1 and the upper surface of the scale member T2, foreign matter can be detected with good efficiency and good accuracy.

In addition, the control apparatus 9 performs the detection operation of the foreign matter in the contact area CA on the upper surface of the plate member T using the detection system 13. Further, the control apparatus 9 performs the detection operation of the foreign matter even on a non-contact area NCA other than the contact area CA. Even in the non-contact area NCA with which the liquid LQ of the immersion space LS does not come into contact, for example, a part of the liquid LQ of the immersion space LS may be splashed and attached, or particles floating in the arrangement space of the exposure apparatus EX may be attached, so that the foreign matter may be present. The control apparatus 9 can detect the existence of the foreign matter in the non-contact area NCA on the upper surface of the plate member T using the detection system 13.

In this embodiment, the control apparatus 9 moves the substrate stage 1 in the XY plane with respect to the detection area AF of the detection system 13. In addition, the control apparatus 9 performs the detection operation of the foreign matter on the substantially entire area of the upper surface of the plate member T including both the contact area CA and the non-contact area NCA.

The control apparatus 9 determines whether or not the size of the foreign matter obtained by the detection system 13 exceeds the acceptable value on the basis of the detection result of the detection system 13 (step SB2). That is, the control apparatus 9 determines whether or not the foreign matter which is not acceptable in exposure exists.

In the step SB2, when it is determined that the size of the foreign matter is equal to or less than the acceptable value, that is, when the foreign matter which is not acceptable in exposure is not detected, the control apparatus 9 performs a predetermined process such as performing (restarting) the exposure sequence SA.

On the other hand, in the step SB2, when it is determined that the size of the foreign matter exceeds the acceptable value, the control apparatus 9 determines the specific area TA of the substrate P (step SB3).

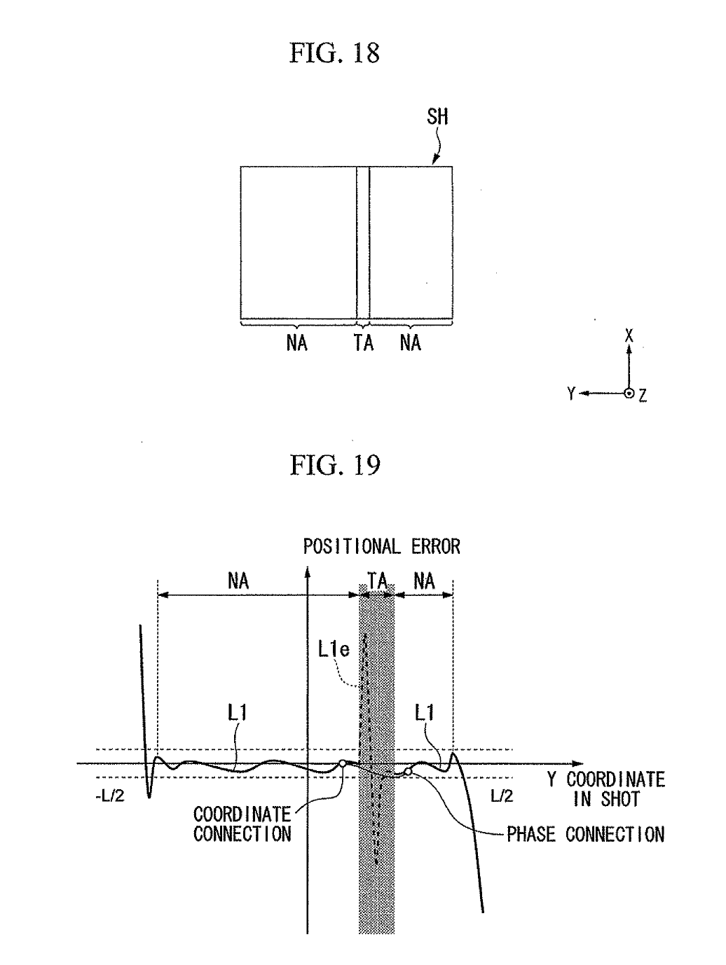

FIG. 17A is a schematic view illustrating an example of the scale member T2 in which the foreign matter exists on its upper surface. FIG. 17B is a schematic view illustrating an example of the specific area TA of the substrate P. In addition, FIG. 18 is a schematic view illustrating an example of the shot area SH including the specific area TA.

The specific area TA is an area on the substrate P, which is overlapped with at least a part of the illumination area (projection area) PR of the exposure light EL when the defect (foreign matter) on the scale member T2 is disposed on the measurement area of the Y head 48 (or the X head 49). For example, when there is foreign matter which exceeds the acceptable value on the scale member T2, the encoder system 14 generates measurement error in the specific area TA in the middle of the scanning exposure of the substrate P because the foreign matter exists on the scale member T2. That is, when the specific area TA is disposed on at least a part of the projection area PR, error occurs in the measurement value of the encoder system 14 because the foreign matter exists on the scale member T2.

When there is the foreign matter which exceeds the acceptable value on the scale member T2, in the specific area TA, the measurement information of the encoder system 14 is substantially unusable in the driving of the substrate stage 1 which uses the second drive system 5 when the substrate P is scanned and exposed. In other words, in the specific area TA, the position measurement of the substrate stage 1 obtained by the encoder system 14 cannot be performed.

In the specific area TA, the measurement information of the encoder system 14 becomes abnormal, which is caused by the foreign matter (defect) of the scale member T2. That is, the measurement value of the encoder system 14 when the specific area TA is disposed on at least a part of the projection area PR becomes abnormal because the foreign matter exists on the scale member T2. For example, the abnormality of the measurement information of the encoder system 14 includes rapid change in measurement value, or an excessive amount of deviation in the measurement value of the encoder system 14 and the interferometer system 12.

The positional relationship between the measurement area of the X head 48 (or the Y head 49) and the illumination area PR of the exposure light EL in the coordinate system (XY coordinate system) is defined by the encoder system 14 (or the interferometer system 12), which is known from a setting value, for example. In addition, as described above, the information regarding the position of the foreign matter is obtained in the coordinate system (XY coordinate system) defined by the encoder system 14 (or the interferometer system 12) on the basis of the detection result of the detection system 13 and the measurement result of the encoder system 14 (or the interferometer system 12). Therefore, when the defect (foreign matter) on the scale member T2 is disposed on the measurement area of the Y head 48 (or the X head 49), the control apparatus 9 can determine the specific area TA on the substrate P with which at least a part of the illumination area (projection area) PR of the exposure light EL is overlapped.

After the specific area TA is determined, the control apparatus 9 performs the control mode change of the substrate stage 1 in accordance with the specific area TA (step SB4). Then, the control apparatus 9 performs (restarts) the exposure sequence SA on the basis of the changed control mode.

Hereinafter, an example of the control mode and an example of the operation based on the control mode will be described. In this embodiment, the control mode change of the substrate stage 1 includes change in which the control mode is changed for driving the substrate stage 1 by the second drive system 5 in the middle of the scanning exposure of the shot area SH including the specific area TA on the substrate P. That is, the control apparatus 9 makes a difference between the control mode regarding the driving of the substrate stage 1 by the second drive system 5 in the middle of the scanning exposure of the shot area SH not including the specific area TA and the control mode regarding the driving the substrate stage 1 by the second drive system 5 in the middle of the scanning exposure of the shot area SH including the specific area TA. The control apparatus 9 performs the driving of the substrate stage 1 by the second drive system 5 in the middle of the scanning exposure of the shot area SH including the specific area TA in a different control mode from the control mode used the scanning exposure of the shot area SH not including the specific area TA.

The control mode used in the middle of the scanning exposure of the shot area SH including the specific area TA includes a first mode used for the scanning exposure of an area NA other than the specific area TA of the shot area SH, and a second mode used for the scanning exposure of the specific area TA. That is, when the shot area SH of the substrate P is scanned and exposed by relatively moving the substrate stage 1 with respect to the exposure light EL, the control apparatus 9 controls the second drive system 5 in the first mode when the area NA is exposed. In addition, when the specific area TA is exposed, the control apparatus 9 controls the second drive system 5 in the second mode. That is, the control apparatus 9 makes driving of the substrate stage 1 by the second drive system 5 in a state where the area NA is scanned and exposed different from that in a state where the specific area TA is scanned and exposed.

In this embodiment, the measurement information of the encoder system 14 is used in the first mode. In this embodiment, in the first mode, the control apparatus 9 controls the second drive system 5 on the basis of the measurement result of the encoder system 14. The second drive system 5 can adjust a servo gain (gain coefficient) with respect to the measurement information of the encoder system 14. The control apparatus 9 sets the servo gain in the first mode to a substantially constant value and performs the scanning exposure on the area NA.

In addition, in this embodiment, when the shot area SH not including the specific area TA is scanned and exposed, the control apparatus 9 sets the servo gain to a substantially constant value. The control apparatus 9 controls (feed back control) the second drive system 5 on the basis of the measurement result of the encoder system 14 and performs the scanning exposure on the shot area SH.

On the other hand, in this embodiment, in the second mode, the measurement information of the encoder system 14 is not used, but the measurement information of the interferometer system 12 is used. In the second mode, the control apparatus 9 controls (feed back control) the second drive system 5 on the basis of the measurement result of the interferometer system 12.

As described above, the control apparatus 9 controls the second drive system 5 so as to drive the substrate stage 1 on the basis of the measurement information of the encoder system 14 in a state where the area NA is being scanned and exposed. The control apparatus 9 controls the second drive system 5 on the basis of the measurement information of the interferometer system 12 in a state where the specific area TA is being scanned and exposed. Then, the control apparatus 9 changes the control mode so as to drive the substrate stage 1.

That is, the measurement information of the encoder system 14 is used for driving the substrate stage 1 in the scanning exposure operation of the substrate P. However, for example, when the measurement information of the encoder system 14 is abnormal due to the defect (existence of the foreign matter) of the scale member T2, when measurement error occurs in the encoder system 14, and when the encoder system 14 cannot measure the position of the substrate stage 1, the measurement information of the interferometer system 12 is used for driving the substrate stage 1.

In this embodiment, the control apparatus 9 can switch the measurement information used for driving the substrate stage 1 from one of the encoder system 14 and the interferometer system 12 to the other system in the middle of scanning and exposing the shot area SH of the substrate P. In this embodiment, when a state is changed from the state where the area NA, is scanned and exposed to the state where the specific area TA is scanned and exposed, the control apparatus 9 switches the measurement information used for driving the substrate stage 1 from the encoder system 14 to the interferometer system 12. In addition, when a state is changed from the state where the specific area TA is scanned and exposed to the state where the area NA is scanned and exposed, the control apparatus 9 switches the measurement information used for driving the substrate stage 1 from the interferometer system 12 to the encoder system 14. In other words, when the control mode is changed from the first mode to the second mode, the control apparatus 9 switches the measurement information used for driving the substrate stage 1 from the encoder system 14 to the interferometer system 12. In addition, when the control mode is changed from the second mode to the first mode, the control apparatus 9 switches the measurement information used for driving the substrate stage 1 from the interferometer system 12 to the encoder system 14.

The control apparatus 9 sets, at the time of switching or before switching, the output coordinates of the encoder system 14 or the interferometer system 12 which are used after switching, such that the output coordinates of the encoder system 14 and the interferometer system 12 substantially continue at the time of switching between the first mode and the second mode.

In this embodiment, the manner of continuing between the output coordinates of the encoder system 14 and the interferometer system 12 is made to differ at the time of the switching from the first mode to the second mode and at the time of the switching from the second mode to the first mode. In other words, a connection processing manner between the output coordinates of the encoder system 14 and the output coordinates of the interferometer system 12 is made to differ at the time of the switching from the first mode to the second mode and at the time of the switching from the second mode to the first mode.

In this embodiment, in the switching from the first mode to the second mode, a coordinate connecting process is used in which the output coordinates of the interferometer system 12 are set to be matched with the output coordinates of the encoder system 14.

On the other hand, in the switching from the second mode to the first mode, a phase connecting process is used in which the output coordinates of the encoder system 14 are set using the output coordinates of the interferometer system 12 and the phase information of the encoder system 14.

FIG. 19 is a schematic view illustrating the connection process in the switching from a servo control of the substrate stage 1 performed by the encoder system 14 to a servo control of the substrate stage 1 performed by the interferometer system 14, and in the switching from a servo control of the substrate stage 1 performed by the interferometer system 12 to a servo control of the substrate stage 1 performed by the encoder system 14. In FIG. 19, the horizontal axis shows positions (coordinates) regarding the Y axis direction in one shot area SH, and the vertical axis shows the measurement error (positional error) of the encoder system 14 and the interferometer system 12. In addition, the line L1 shows the measurement values of the encoder system 14, and the line L2 shows the measurement values of the interferometer system 12. Further, the line L1e shows the abnormal values of the encoder system 14 caused by the foreign matter when the connection process is not carried out.

When the shot area SH is scanned and exposed, a sampling clock (control clock) for the positional control of the substrate stage 1 is generated at a predetermined generation timing CS, and a sampling clock (measurement clock) for the measurement of the encoder system 14 (and the interferometer system 12) is generated at a predetermined generation timing MS.

First, the connection process (coordinates connecting process) in the switching from the servo control of the substrate stage 1 performed by the encoder system 14 to the servo control of the substrate stage 1 performed by the interferometer system 14 will be described. The control apparatus 9 performs a preprocessing for the connection process at each control clock (CS). At the measurement clock (MS), the control apparatus 9 monitors both the output signal of the encoder system 14 and the output signal of the interferometer system 12.

At the control clock (CS) in the area NA, the control apparatus 9 obtains the positional coordinates (X, Y, θZ) of the substrate stage 1 on the basis of the measurement result of the encoder system 14, and obtains the positional coordinates (X′, Y′, θZ′) of the substrate stage 1 on the basis of the measurement result of the interferometer system 12. In addition, the control apparatus 9 derives a differential value between two positional coordinates (X, Y, θZ) and (X′, Y′, θZ′). In addition, the control apparatus 9 derives a differential moving average MA_{K} {(X, Y, θZ)−(X′, Y′, θZ′)} from the predetermined number of clocks in the area NA, which is stored as a coordinate offset O.

When the area NA is exposed, the control apparatus 9 performs the servo control of the substrate stage 1 using the position coordinate (X, Y, θZ) which is obtained on the basis of the measurement result of the encoder system 14.

The control apparatus 9 performs the connection process (coordinate connecting process) from the encoder system 14 to the interferometer system 12. For example, at a second control clock, the output signal of the encoder system 14 is assumed to be abnormal, and the switching from the encoder system 14 to the interferometer system 12 is assumed to be carried out at timing of a first clock immediately before the second control clock. In this case, at the second control clock, the control apparatus 9 adds the coordinate offset O, which is stored at the first control clock immediately before the second control clock, to the positional coordinates (X′, Y′, θZ′) of the substrate stage 1, which is obtained on the basis of the measurement result of the interferometer system 12, so that the positional coordinates (X′, Y′, θZ′) are matched with the positional coordinates (X, Y, θZ) of the substrate stage 1 which is obtained on the basis of the measurement result of the encoder system 14 at the control clock (first control clock) immediately before the second control clock. Therefore, the output coordinates of the interferometer system 12 are set to be matched with the output coordinates of the encoder system 14. As described above, the output coordinates of the interferometer system 12 are set at the second control clock and, after the second control clock, the specific area TA is scanned and exposed on the basis of the measurement information of the interferometer system 12. Specifically, in the specific area TA, the control apparatus 9 performs the servo control on the substrate stage 1 with reference to the positional coordinates [(X′, Y′, θZ′)+O] which are corrected by the coordinate offset O.

When the foreign matter is disposed on the scale member T2 in the measurement area of the encoder system 14 (each of the heads 48 and 49) in a state where the positional control of the substrate stage 1 is performed in the effective stroke range on the basis of the measurement value of the encoder system 14, the control apparatus 9 switches the measurement value to be used for the positional control of the substrate stage 1 from the measurement value output from the encoder system 14 to the measurement value output from the interferometer system 12. In this embodiment, the output coordinates of the interferometer system 12 are corrected so as to continue to the output coordinates of the encoder system 14 immediately before the switching. Therefore, when the specific area TA is exposed, the control apparatus 9 obtains the positional information of the substrate stage 1 on the basis of the measurement value output from the interferometer system 12. The control apparatus 9 can perform (continue) the positional control (movement control) of the substrate stage 1 on the basis of the positional information.

Next, the connection process (phase connecting process) of switching from the servo control of the substrate stage 1 performed by the interferometer system 12 to the servo control of the substrate stage 1 performed by the encoder system 12 will be described. For example, at a fourth control clock, the specific area TA is assumed to move to a position not overlapping with the projection area PR. The control apparatus 9 is assumed to switch the servo control from the interferometer system 12 to the encoder system 14 at a fifth control clock after the fourth control clock. The control apparatus 9 sets the output coordinates of the encoder system 14 using the positional information [(X′, Y′, θZ′)+O] output from the interferometer system 12 of which the offset is corrected and the positional information of the encoder system 14.

For example, the positional information of the substrate stage 1 in the XY plane (X axis, Y axis, and θZ directions) is obtained using at least three heads. Assuming that positions (X, Y) of three heads are (p₁, q₁), (p₂, q₂), and (p₃, q₃) in the XY coordinate system, when the substrate stage 1 is positioned on the coordinates (X, Y, θZ), the measurement values of three heads can be theoretically expressed the following equations (1A) to (1C).

C₁=−(p₁−X)sin θZ+(q₁−Y)cos θZ (1A)

C₂=−(P₂−X)sin θZ+(q₂−Y)cos θZ (1B)

C₃=(p₃−X)cos θZ+(q₃−Y)sin θZ (1C)

The positional coordinates supplied from the interferometer system 12 are substituted for the simultaneous equations (1A) to (1C). Solving the equations, the measurement values to be output from three heads are calculated. Therefore, the output coordinates of the encoder system 14 can be obtained on the basis of the output coordinates of the interferometer system 12. The control apparatus 9 performs an initial setting on the encoder system 14 using the obtained output coordinates of the encoder system 14.

After the fifth control clock, the control apparatus 9 performs the servo control by the encoder system 14. Therefore, the output coordinates of the encoder system 14 are set before the fifth control clock. After the fifth control clock, the scanning exposure is performed on the area NA, on the basis of the measurement information of the encoder system 14.

As described above, according to this embodiment, the foreign matter on the upper surface of the scale member T2 can be detected using the detection system 13. In addition, according to this embodiment, the driving of the substrate stage 1 performed by the second drive system 5 is controlled on the basis of the detection information of the detection system 13 in the middle of scanning and exposing the substrate P. Therefore, for example, in consideration of the foreign matter on the scale member T2, the control mode of the substrate stage 1 is changed, so that the position measurement of the substrate stage 1 using the scale member T2 and the positional control (movement control) of the substrate stage 1 can be favorably performed. Therefore, according to this embodiment, the position measurement of the substrate stage 1 and the positional control of the substrate stage 1 can be performed in a state where the effect of the foreign matter is suppressed. Therefore, it is possible to suppress the degradation in movement performance of the substrate stage 1. Therefore, exposure error can be suppressed from occurring, and device error can be suppressed from occurring.

In addition, according to this embodiment, since the positional information of the substrate stage 1 in the XY plane is measured by the encoder system 14 which has a good short-term stability regarding the measurement value, the measurement can be performed with high accuracy while the effect of air fluctuation is being suppressed.

### Fourth Embodiment

Next, the fourth embodiment will be described. In the description below, the same or equivalent components as those in the above-mentioned first embodiment are designated by the same reference numerals, and the description thereof will be simplified or omitted.

In the third embodiment described above, the control of the second drive system 5 is performed in the first mode on the basis of the measurement result of the encoder system 14, and the control of the second drive system 5 is performed in the second mode on the basis of the measurement result of the interferometer system 12. However, the fourth embodiment is characterized in that the servo gain (gain coefficient) with respect to the measurement information of the encoder system 14 is changed in the second mode.

The second drive system 5 can adjust (change) the servo gain (gain coefficient) with respect to the measurement information of the encoder system 14. The control apparatus 9 sets the servo gain in the first mode to a substantially constant value, and performs the scanning exposure on the area NA.

On the other hand, the control apparatus 9 controls the servo gain in the second mode to be smaller than the servo gain in the first mode. That is, the control apparatus 9 controls the servo gain in the specific area TA to be smaller than that in the area NA of the shot area SH. In this embodiment, the servo gain in the second mode is set to zero. That is, in the second mode, the measurement information of the encoder system 14 is substantially unused. Therefore, in the specific area TA, the servo gain becomes zero.

In this embodiment, in the second mode, the servo control of the substrate stage 1 performed by the second drive system 5 is not carried out. The control apparatus 9 can stop the servo control of the substrate stage 1. The control apparatus 9 does not carry out the servo control of the substrate stage 1 performed by the second drive system 5 in the specific area TA in the middle of the scanning exposure of the shot area SH including the specific area TA.

In this embodiment, the control apparatus 9 changes the servo gain in the specific area TA in the middle of the scanning exposure of the shot area SH including the specific area TA. The control apparatus 9 makes the servo gain small when the specific area TA passes through the projection area PR. The control apparatus 9 sets the servo gain with respect to the measurement information of the encoder system 14 to zero in a state where the specific area TA is not subjected to the scanning exposure, and drives the substrate stage 1 without using the measurement information of the encoder system 14. The substrate stage 1 is driven in the specific area TA in the middle of the scanning exposure of the shot area SH including the specific area TA without using the measurement information of the encoder system 14.

In this embodiment, in the middle of the scanning exposure of the shot area SH of the substrate P, the control apparatus 9 sets the servo gain to a predetermined value in the middle of the scanning exposure of the area NA and drives the substrate stage 1 using the measurement information of the encoder system 14. When a state is changed from the state where the scanning exposure of the area NA is carried out to the state where the scanning exposure of the specific area TA is carried out, the control apparatus 9 sets the servo gain to zero. In the middle of the scanning exposure of the specific area TA, the substrate stage 1 moves without carrying out the servo control in the state where the servo gain is zero. The servo gain returns to a predetermined value when a state is changed from the state where the scanning exposure is carried out on the area NA to the state where the scanning exposure is carried out on the specific area TA. Thereafter, in the middle of the scanning exposure of the area NA, the substrate stage 1 is driven using the measurement information of the encoder system 14.

Also in this embodiment, the position measurement of the substrate stage 1 and the positional control of the substrate stage 1 can be performed in a state where the effect of the foreign matter is suppressed. Therefore, it is possible to suppress the degradation in movement performance of the substrate stage 1. Therefore, exposure error can be suppressed from occurring, and device error can be suppressed from occurring.

Further, in this embodiment, the servo gain is set to zero. However, the servo control may be carried out on the substrate stage 1 in a state where the servo gain is set to be smaller in the specific area TA compared with that in the area NA so as to suppress the influence of the foreign matter.

Further, in the above-mentioned third and fourth embodiments, unlike the exposure sequence SA, a dedicated sequence (detection sequence) SB for the foreign matter detection is provided. The control apparatus 9 can perform the detection operation of the foreign matter, for example, in the exposure sequence SA. For example, when a plurality of the substrates P are sequentially subjected to the exposure operation, the detection operation of the foreign matter can be performed, in parallel to at least a part of the exposure operation, using the detection system 13 for each interval period of every exchange of the substrate Pin the substrate stage 1, that is, each time one sheet of the substrate P is subjected to the exposure operation. In this case, in parallel to the exposure operation, the detection operation of the foreign matter may not be carried out on the entire surface of the scale member T2. That is, in parallel to the exposure operation, the detection operation of the foreign matter is carried out on a part of the scale member T2, and the detection operation of the foreign matter on the remaining portion of the scale member T2 may be carried out in a period of time other than the exposure operation in the exposure sequence, or in a period of time in the above-mentioned foreign matter processing sequence. In addition, the timing of the detection operation of the foreign matter is not limited to each time one sheet of the substrate P is subjected to the exposure operation. The detection operation may be performed at each predetermined time interval, such as each time a predetermined number of the substrates P are subjected to the exposure operation, or each time a predetermined time lapses.

In addition, in the above-mentioned third and fourth embodiments, the upper surface of the scale member T2 passes through the detection area AF of the detection system 13 during the substrate stage 1 moves from the first substrate exchange position CP1 to the exposure position EP and during the substrate stage 1 moves from the exposure position EP to the second substrate exchange position CP2. Therefore, the detection operation of the foreign matter on the upper surface of the scale member T2 can be performed in the middle of moving the substrate stage 1.

In addition, in the above-mentioned third and fourth embodiments, when the substrate P held on the substrate stage 1 is disposed on the projection area PR of the projection optical system PL which is the illumination area of the exposure light EL, the positional relationship between the projection optical system PL and the detection system 13 is determined such that at least a part of the scale member T2 is disposed on the detection area AF of the detection system 13. Therefore, the control apparatus 9 can perform the detection operation of the foreign matter on the upper surface of the scale member T2 using the detection system 13 in parallel to the exposure operation of the substrate P.

In addition, in the above-mentioned third and fourth embodiments, when the substrate P held on the substrate stage 1 is disposed on the detection area of the alignment system 15, the positional relationship between the alignment system 15 and the detection system 13 is determined such that at least a part of the scale member T2 is disposed on the detection area AF of the detection system 13. Therefore, the control apparatus 9 can perform the detection operation of the foreign matter on the upper surface of the scale member T2 using the detection system 13 in parallel to the detection operation of the alignment marks of the substrate P.

The detection operation of the foreign matter on the upper surface of the scale member T2 (plate member T) can be performed in the exposure sequence SA including the exposure operation of the substrate P. In this ease, the detection operation of the foreign matter may be carried out on the entire surface of the scale member T2 in one operation (period) of the exposure sequence SA, and the detection operation of the foreign matter may be carried out on the entire surface of the scale member T2 in the other periods (operation) of the exposure sequence SA. Furthermore, the detection operation of the foreign matter may be carried out on the entire surface of the scale member T2 in a part of the exposure sequence SA and the above-mentioned foreign matter processing sequence.

In addition, the detection operation of the foreign matter is performed in the middle of a predetermined operation before the exposure operation of the substrate P, in which the moving operation of the substrate stage 1 from the first substrate exchange position CP1 to the exposure position EP and the detecting operation of the alignment of the substrate P are included. When the foreign matter is detected in this detection operation, the control apparatus 9 can change the control mode of the substrate stage 1 before the exposure operation of the substrate P.

In addition, for example, when the detection operation of the foreign matter is performed in the middle of the exposure operation of the substrate P and the foreign matter is detected by the detection operation, the control apparatus 9 can change the control mode of the substrate stage 1 in the middle of the exposure operation of the substrate P.

In addition, the control apparatus 9 is connected to an input apparatus through which an operation signal can be input to the control apparatus 9. For example, when an operator inputs an operation signal by the input apparatus, the detection sequence may be performed. Further, for example, the input apparatus includes a keyboard, a touch panel, an operation button, and the like.

In addition, for example, when the detection sequence is performed many times at a predetermined interval, the detection operation of the foreign matter is performed on a first area on the upper surface of the scale member T2 in the nth detection sequence SB. Then, in the (n+1)th detection sequence, the detection operation of the foreign matter may be performed on a second area on the upper surface of the scale member T2.

In addition, in the above-mentioned third and fourth embodiments, the foreign matter on the upper surface 18 of the measurement stage 2 can be detected using the detection system 13. In addition, the driving of the measurement stage 2 can be controlled on the basis of the detection result of the detection system 13. In addition, in this embodiment, the foreign matter on the upper surface of the reference member 44 including the reference grating 45 can be detected using the detection system 13.

Further, in the above-mentioned third and fourth embodiments, it may be configured such that the control apparatus 9 measures the positional information of the substrate stage 1 in the XY plane using the encoder system 14, and at the same time moves the upper surface of the substrate stage 1 (plate member T) with respect to the detection area AF of the detection system 13 so as to perform the detection operation of the foreign matter on at least a part of the upper surface of the plate member T, and obtains the position of the foreign matter in the XY plane on the basis of the detection result of the focus detection system 13 and the measurement result of the encoder system 14. Alternatively, it may be configured such that the control apparatus 9 measures the positional information of the substrate stage 1 in the XY plane using the interferometer system 12, and at the same time moves the upper surface of the substrate stage 1 (plate member T) with respect to the detection area AF of the detection system 13 so as to perform the detection operation of the foreign matter on at least a part of the upper surface of the plate member T, and obtains the position of the foreign matter in the XY plane on the basis of the detection result of the focus detection system 13 and the measurement result of the interferometer system 12.

Further, in the above-mentioned third and fourth embodiments, the description has been made such that the positional information of the substrate stage 1 which is measured by the interferometer system 12 (second interferometer unit 12B) is not used for the alignment operation and the exposure operation of the substrate P, but mainly used for the calibration operation (that is, correction of the measurement value) of the encoder system 14. However, the measurement information (that is, at least one of five pieces of the positional information in the X axis, the Y axis, the θX, the θY, and the θZ direction) of the interferometer system 12 may be used for the alignment operation and the exposure operation of the substrate P. In this embodiment, the encoder system 14 measures the positional information of the substrate stage 1 in three directions of the X axis, the Y axis, and the θZ directions. Then, in the alignment operation and the exposure operation of the substrate P, among a variety of the measurement information of the interferometer system 12, only the positional information regarding a direction, for example, the θX direction and/or the θY direction, which is different from the measurement directions (X axis, Y axis, and θZ directions) of the positional information of the substrate stage 1 obtained by the encoder system 14 may be used. Alternatively, the positional information regarding the directions (that is, at least one of the X axis, Y axis, and θZ directions) similar to the measurement direction of the encoder system 14 may be used. In addition, the interferometer system 12 may measure the positional information of the Z direction of the substrate stage 1. In this case, the positional information in the Z axis direction may be used for the alignment operation and the exposure operation of the substrate P.

Further, in the above-mentioned first to fourth embodiments, the foreign matter is detected over the entire upper surface of the scale member by the detection system, but the invention is not limited thereto. The foreign matter may be detected only on a part of the upper surface of the scale member. In this case, a part of the scale member on which the foreign matter detection is carried out includes at least a range on which the encoder beam is illuminated in the exposure sequence.

Further, in each embodiment described above, the scale member T2 is formed by two sheets of the plate-like members 30A and 30B, but the invention is not limited thereto. The scale member T2 may be configured of one sheet of the plate-like member and the diffraction grating may be formed directly on the upper surface of the plate-like member. In addition, the diffraction grating is formed on the upper surface of the scale member, and a protective member (for example, thin film) is provided on the upper surface of the scale member so as to transmit the measurement light of the heads 48, 48A, 48B, and 49, so that the diffraction grating may be suppressed from damage. In addition, instead of configuring the substrate stage 1 such that the scale member T2 is attachable thereto or detachable therefrom, the substrate stage and the scale member may be integrally formed. That is, the diffraction grating may be directly formed on at least a part of the substrate stage 1.

Further, in this embodiment, the scale member T2 is disposed on the substrate stage 1, and the encoder system 14 measures the scale member T2 and measures the positional information of the substrate stage 1, but the invention is not limited thereto. Similar to the substrate stage 1, the scale member including the diffraction grating can also be disposed on the measurement stage 2. The encoder system 14 can measure the positional information of the measurement stage 2 in the XY plane using the scale member. The control apparatus 9 can operate the second drive system 5 on the basis of the measurement result of the encoder system 14 and the detection result of the detection system 13, and carry out the positional control of the measurement stage 2. In addition, the detection system 13 can detect the foreign matter on the upper surface of the scale member which is disposed on the measurement stage. In addition, in the above-mentioned first and second embodiments, the scale member of the measurement stage can be cleaned using the cleaning apparatus such as the immersion member 11. Furthermore, an operator can maintain the scale member of the measurement stage by withdrawing the measurement stage from the exposure apparatus EX. On the other hand, in the above-mentioned third and fourth embodiments, the driving of the substrate stage 1 using the second drive system 5 can be controlled on the basis of the detection information of the detection system 13.

In addition, the scale member including the diffraction grating can also be disposed on the mask stage 3. By disposing the encoder stage which can measure the scale member disposed on the mask stage 3, the mask encoder system can measure the positional information of the mask stage 3 in the XY plane using the scale member disposed on the mask stage 3. In addition, a detection system can be provided which can measure the positional information of the pattern forming surface of the mask M. Then, using the detection system, the foreign matter disposed on the mask stage 3 can be detected.

Further, in each embodiment described above, the description has been made as an example in that the scale member is disposed on the substrate stage (measurement stage and mask stage) which is a moving body, the encoder system is disposed on a position (upper portion of the substrate stage) to face the scale member. However, the configuration of the each embodiment described above can be applied to an exposure apparatus in which the head of the encoder system is disposed on the substrate stage, and the scale member (grid plate) is disposed on a position (upper portion of the substrate stage) to face the head as disclosed in the specification of the US Patent Application Laid-Open Publication NO. 2006-0227309. That is, there is provided the detection system which can detect the positional information of the surface of the substrate held on the substrate stage, and the foreign matter on the upper surface of the encoder system disposed on the substrate stage can be detected by the detection system. In addition, in the above-mentioned first and second embodiments, the upper surface of the encoder head can be cleaned using the cleaning apparatus according to the detection result of the detection system. For example, as the cleaning apparatus, there may be used an immersion member which performs the cleaning using liquid, an air supply apparatus which has an injection port to inject the liquid, a vacuum apparatus which has a suction port to absorb the air, and the like. On the other hand, in the above-mentioned third and fourth embodiments, the driving of the substrate stage can be controlled according to the detection result of the detection system.

Further, in each embodiment described above, the detection system (focus leveling detection system) 13 which can detect the positional information of the surface of the substrate P is used to detect the foreign matter. However, a detection system different from the detection system 13 may be provided at the exposure apparatus EX as long as the foreign matter and the size thereof can be detected, so that the foreign matter may be detected by the detection system. In addition, as the detection system 13, an imaging scheme may be employed.

Further, in each embodiment described above, the description has been made as an example in that the defect of the scale member is the foreign matter existing on the scale member. However, even when the defect is a scar, the configuration of each embodiment described above can be employed, so that exposure error can be suppressed from occurring, and device error can be suppressed from occurring.

Further, in each embodiment described above, a projection optical system PL is configured such that the optical path of the light emitting side (image plane side) of the final optical element is filled with the liquid. However, there may be employed a projection optical system in which the optical path of a light incident side (object plane side) is also filled with the liquid, as disclosed in the specification of US Patent Application Laid-Open Publication No. 2005-0248856.

Further, in each embodiment described above, the liquid LQ is water, but a liquid other than the water may be used. As the liquid LQ, it is favorable that the liquid be capable of transmitting the exposure light EL and has a reflective index as high as possible, and is stable with respect to the photosensitive film which is formed on the projection optical system or the surface of the substrate. For example, as the liquid LQ, there may be employed hydro fluoro ether (HFE), perfluoro polyether (PFPE), fomblin oil, cedarwood oil, or the like. In addition, as the liquid LQ, there may be employed a liquid with a reflective index of about 1.6 to 1.8. Further, the optical element (final optical element, etc.) of the projection optical system PL which comes into contact with the liquid LQ may be formed of a material of which the reflective index (for example, 1.6 or more) is higher than that of quartz and fluorite. In addition, as the liquid LQ, a variety of fluids, for example, supercritical fluid may be employed.

In addition, for example, when the exposure light EL is F₂ laser light, the F₂ laser light does not pass through the water. Therefore, as the liquid LQ, it is favorable that a liquid be capable of transmitting to the F₂ laser light. For example, fluorinated fluid such as perfluoro polyether (PFPE) or fluorinated oil can be employed. In this case, a portion coming into contact with the liquid LQ is subjected to a lyophilic treatment by forming a thin film with a fluorine-containing material with a low polarity, for example.

Further, in each embodiment described above, the projection area PR on which the exposure light EL is illuminated via the projection optical system PL has been described as an on-focus area including the optical axis AX in the visual field of the projection optical system PL. However, the exposure area may be an on-focus area not including the optical AX similar to a so-called inline type reflective refraction system which has a single optical axis and is provided with an optical system (reflection system or refraction system) which has a plurality of reflection surfaces and forms an intermediate image at least 1 time, as disclosed in the specification of PCT International Publication No. 2004-107011.

In addition, in each embodiment described above, the illumination area IR and the projection area PR have been described to have a rectangular shape, but the invention is not limited thereto. For example, the shape may be an arcuate shape, a trapezoid shape, or a parallelogram.

In each embodiment described above, the description has been made as an example of the exposure apparatus which is provided with the projection optical system PL. However, the invention may be applied to an exposure apparatus and an exposure method in which the projection optical system PL is not used. Even though such a projection optical system PL is not used, the exposure light is illuminated on the substrate via an optical member such as a lens, and the immersion space is formed between the optical member and the substrate.

Further, in each embodiment described above, the description has been made as an example in that the exposure apparatus EX is the immersion exposure apparatus. However, the exposure apparatus may be a dry exposure apparatus for exposing the substrate P without passing through the liquid.

In addition, in each embodiment described above, the exposure apparatus EX may be an EUV exposure apparatus for exposing the substrate P using extreme ultraviolet light (EUV) in a dry X-ray band.

Further, as the substrate P of the each embodiment described above, there is applied a semiconductor wafer for manufacturing a semiconductor device, and as well as a glass substrate for a display device, a ceramic wafer for a thin-film magnetic head, a mask used for the exposure apparatus, or an original plate (synthetic quartz, silicon wafer) of a reticle.

As the exposure apparatus EX, besides a scanning exposure apparatus (scanning stepper) in a step-and-scan scheme in which the mask M and the substrate P are synchronized and moved for seaming and exposing a pattern of the mask M, a projection exposure apparatus (stepper) in a step-and-repeat scheme may be applied in which the pattern of the mask M is collectively exposed in a state where the mask M and the substrate P are stopped, and sequentially step-moves the substrate P. Also in the case where the exposure apparatus EX is a stepper, the position of the stage holding the substrate is measured by the encoder, so that the measurement error due to the air fluctuation is suppressed from occurring, and the positional control of the stage can be performed with high accuracy.

Furthermore, on exposing in the step-and-repeat scheme, a first pattern of a reduced image may be transferred on the substrate P using the projection optical system in a state where the first pattern and the substrate P are substantially stopped. Thereafter, a second pattern of the reduced image may be partially overlapped with the first pattern using the projection optical system in a state where the second pattern and the substrate P are substantially stopped, so that the reduced image may be collectively exposed on the substrate P (collective exposure apparatus in a stitch scheme). In addition, the exposure apparatus in the stitch scheme may be implemented as an exposure apparatus in a step-and-stitch scheme in which at least two patterns are partially overlapped with each other on the substrate P and exposed, and the substrate P is sequentially moves.

In addition, the invention may be applied to the exposure apparatus in which two mask patterns are synthesized on the substrate via the projection optical system, and one shot area is twice exposed almost at the same time by one scanning exposure, as disclosed in the specification of U.S. Pat. No. 6,611,316. In addition, the invention may be applied to a proximity exposure apparatus and a mirror projection-aligner.

In addition, the invention may be applied to the exposure apparatus in a twin stage type provided with a plurality of substrate stages, as disclosed in the specification of U.S. Pat. No. 6,341,007, the specification of U.S. Pat. No. 6,400,441, the specification of U.S. Pat. No. 6,549,269, the specification of U.S. Pat. No. 6,590,634, the specification of U.S. Pat. No. 6,208,407, and the specification of U.S. Pat. No. 6,262,796.

In addition, the invention may be applied to the exposure apparatus provided with a plurality of the substrate stages and the measurement stages. In addition, the invention may be applied to the exposure apparatus including only one substrate stage.

As for the kind of the exposure apparatus, it is not limited to the exposure apparatus for manufacturing semiconductor elements which exposes semiconductor element patterns on the substrate P. However, the exposure apparatus may be widely implemented also as an exposure apparatus for manufacturing liquid crystal elements or displays, or as an exposure apparatus for manufacturing thin-film heads, imaging elements (CCD), micro machines, MEMS, DNA chips, reticles, or masks.

In addition, in each embodiment described above, an ArF excimer layer may be used as the light source apparatus for generating ArF excimer laser light as the exposure light EL. Alternatively, for example, as the light source apparatus, a high frequency generating apparatus may be used which includes a solid laser light source such as a DFB semiconductor laser or a fiber laser, an optical amplifier, and a wavelength converter, and outputs a pulse light with a wavelength of 193 nm, as disclosed in the specification of U.S. Pat. No. 7,023,610.

Further, in each embodiment described above, there has been used the optical transmission type mask in which a predetermined light blocking pattern (or a phase pattern, photosensitive pattern) is formed on the light transmittable substrate. However, instead of the mask, there may be used a variable forming mask (which is also referred to as an electronic mask, an active mask, or an image generator) in which a transmission pattern or a reflection pattern, or a light emitting pattern is formed on the basis of electronic data of a pattern to be exposed, as disclosed in the specification of U.S. Pat. No. 6,778,257. The variable forming mask includes a kind of DMD (digital Micro-mirror Device) which is a non-emissive image display element (spatial light modulator). In addition, as the variable forming mask, it is not limited to the DMD, but instead of the DMD, a non-emissive image display element may be used as described below. Here, the non-emissive image display element is an element for spatially modulating an amplitude (intensive), a phase, or a state of polarization of the light traveling in a predetermined direction. As the transmission type spatial light modulator, an electro chromic display (ECD) can be exemplified besides the transmission type liquid crystal display (LCD). In addition, as the reflection type spatial light modulator, other than the above-mentioned DMD, a reflection mirror array, a reflection type liquid crystal display element, an electro phonetic display (EPD), an electronic paper (or electronic ink), a grating light valve, and the like can be exemplified.

In addition, instead of the variable forming mask provided with the non-emissive image display element, a pattern forming apparatus including a self-luminescent type image display element may be provided. In this case, the illuminance system is not necessary. Here, as the self-luminescent type image display element, for example, a CRT (Cathode Ray Tube), an inorganic EL display, an organic EL display (OLED: Organic Light Emitting Diode), an LED display, an LD display, a field emission display (FED), a plasma display panel (PDP), and the like can be exemplified. In addition, as the self-luminescent type image display element provided with the pattern forming apparatus, a solid light source chip having a plurality of luminous points, a solid light source chip array in which a plurality of chips are arranged in an array shape, or a light source including one sheet of substrate in which a plurality of luminescent points are produced may be used. By electrically controlling the solid light source, a pattern may be formed. Further, the solid light source element may be inorganic or organic.

In addition, the invention may also be applied to the exposure apparatus (lithography system) which exposes the line-and-space pattern on the substrate P by forming an interference fringe on the substrate P, as disclosed in the specification of PCT International Publication No. 2001-035168.

As described above, the exposure apparatus is manufactured by assembling various kinds of sub systems including the respective components so as to secure mechanical accuracy, electrical accuracy, and chemical accuracy. In order to secure these various kinds of accuracy, before and after the assembling, there are carried out the adjustment for achieving the chemical accuracy on various kinds of chemical systems, the adjustment for achieving the mechanical accuracy on various kinds of mechanical systems, and the adjustment for achieving the electrical accuracy on various kinds of electrical systems. The assembling procedure from the various sub systems to the exposure apparatus includes mechanical connecting, connecting electric circuits via wirings, connecting pneumatic circuits via pipes, and the like. Before the assembling procedure from these various kinds of sub systems to the exposure apparatus, it is a matter of course that the assembling procedure of each sub system be carried out. After completing the assembling procedure from these sub systems to the exposure apparatus, a total adjustment is carried out, and various kinds of accuracy are secured as the exposure apparatus. Further, the manufacturing of the exposure apparatus is preferably carried out in a clean room in which the temperature and cleanness are managed.

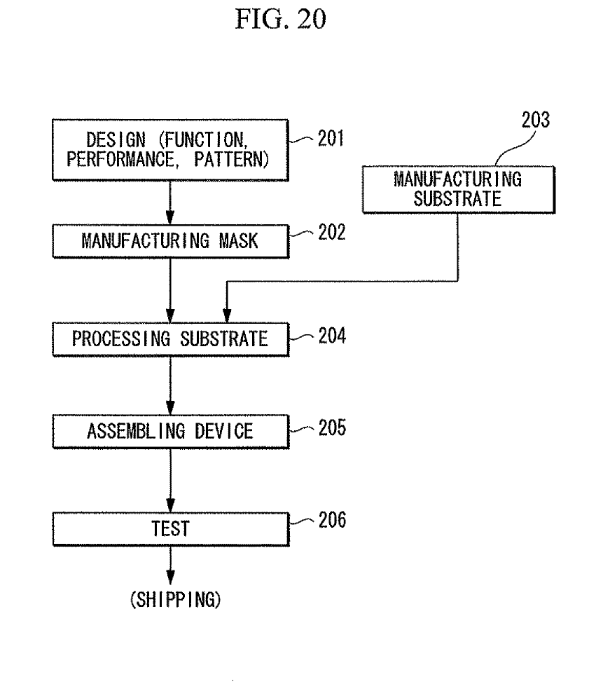

As shown in FIG. 20, a micro device such as a semiconductor device is manufactured through Step 201 in which functions and performance of the micro device are designed, Step 202 in which the mask (reticle) is manufactured on the basis of the design step, Step 203 in which a substrate is manufactured as a base material of the device, Step 204 in which the substrate is processed by a substrate process (exposure process) including the exposure of the substrate with the exposure light using a mask pattern according to the above-mentioned embodiments and the developing of the exposed substrate, Step 205 in which the device is assembled (including the machining process such as dicing procedure, bonding procedure, packaging procedure, etc.), Step 206 for testing, and the like.

Further, in each embodiment described above, the conditions may be properly determined. In addition, all of the documents and the disclosures of US patents relating to the exposure apparatus cited in each embodiment and modified example are adopted in the invention so as to form part of this document.

1. An exposure apparatus which exposes an object with exposure light, comprising:
a moving body which holds the object and is capable of moving in a predetermined plane, and in which a scale member including a grating is disposed;
a measurement system which measures positional information of the moving body in the predetermined plane using the scale member;
a detection system which detects information regarding foreign matter on a surface of the scale member and a size of the foreign matter; and
a cleaning apparatus which is capable of cleaning the scale member,
wherein a cleaning operation is performed on the scale member based on a detection result of the detection system.

2. The exposure apparatus according to claim 1,
wherein the measurement system includes an encoder system having a head which is capable of facing the scale member.

3. The exposure apparatus according to claim 1, further comprising:
a control apparatus which controls the moving body on the basis of measurement information of the measurement system and controls the cleaning apparatus on the basis of a detection result of the detection system.

4. The exposure apparatus according to claim 3,
wherein the control apparatus determines whether or not a cleaning operation on the scale member is performed on the basis of a detection of the detection system.

5. The exposure apparatus according to claim 4,
wherein the control apparatus performs the cleaning operation when a size of foreign matter detected by the detection system exceeds a predetermined acceptable value.

6. The exposure apparatus according to claim 4,
wherein the control apparatus performs the cleaning operation when the amount of foreign matter detected by the detection system exceeds a predetermined acceptable value.

7. The exposure apparatus according to claim 4,
wherein the control apparatus performs the cleaning operation when a position of foreign matter detected by the detection system is the outside of an acceptable area in a surface of the scale member.

8. The exposure apparatus according to claim 4,
wherein the detection system detects positional information of a surface of the scale member regarding a direction perpendicular to the predetermined plane as height information, and
wherein a size of the foreign matter includes the height information of the foreign matter.

9. The exposure apparatus according to claim 8,
wherein the detection system illuminates at least a plurality of detection points on the predetermined plane with detection light.

10. The exposure apparatus according to claim 3,
wherein the control apparatus performs the cleaning operation or change of a control mode of the moving body when the detection system detects foreign matter which is not acceptable in the exposure.

11. An exposure apparatus which exposes an object with exposure light, comprising:
a moving body which holds the object and is capable of moving in a predetermined plane, and in which a scale member including a grating is disposed;
a measurement system which includes an encoder system having a head being capable of facing the scale member and measures positional information of the moving body in the predetermined plane;
a detection system which detects foreign matter on a surface of the scale member;
a cleaning apparatus which is capable of cleaning the scale member; and
a control apparatus which is capable of controlling the moving body on the basis of measurement information of the measurement system and controls the cleaning operation and change of a control mode of the moving body, wherein the control apparatus performs the cleaning operation and the change of the control mode when the detection system detects foreign matter which is not acceptable in the exposure.

12. The exposure apparatus according to claim 10,
wherein the foreign matter which is not acceptable in the exposure includes foreign matter which renders measurement information obtained by the encoder system unusable in control of the moving body.

13. The exposure apparatus according to claim 10,
wherein the cleaning operation is performed when detection information of foreign matter which is not acceptable in the exposure exceeds an acceptable value, and
wherein the change of the control mode is performed when the detection information is equal to or less than an acceptable value.

14. The exposure apparatus according to claim 13,
wherein the detection information includes information of an occupation area of foreign matter per unit area.

15. The exposure apparatus according to claim 10,
wherein the measurement system includes an interferometer system which measures positional information of the moving body in the predetermined plane, and
wherein the control apparatus is capable of changing measurement information to be used to control the moving body from the encoder system to the interferometer system.

16. The exposure apparatus according to claim 1, further comprising:
an immersion member which is capable of forming an immersion space with a liquid in an interval with a surface of the scale member,
wherein the cleaning apparatus includes the immersion member.

17. The exposure apparatus according to claim 16,
wherein the cleaning apparatus executes a relative movement between the immersion member and the moving body in order to come into contact with the liquid in the immersion space and the foreign matter.

18. The exposure apparatus according to claim 16,
wherein the cleaning apparatus expands the immersion space in order to come into contact with the liquid in the immersion space and the foreign matter.

19. The exposure apparatus according to claim 16, further comprising:
an optical member which emits the exposure light,
wherein the immersion member fills an optical path of the exposure light between the optical member and the object so as to be capable of forming an immersion space, at the time of exposing the object, with a liquid for exposure.

20. The exposure apparatus according to claim 19,
wherein an immersion space to be formed at the time of cleaning the scale member is expanded further than an immersion space to be formed at the time of exposing the object.

21. An exposure apparatus which exposes an object with exposure light via an optical member, comprising:
a moving body which holds the object and is capable of moving in a predetermined plane, and in which a scale member including a grating is disposed;
a measurement system which includes an encoder system having a head being capable of facing the scale member and measures positional information of the moving body in the predetermined plane;
an immersion member which fills an optical path of the exposure light between the optical member and the object with a liquid, and is capable of forming an immersion space; and
a cleaning apparatus which expands the immersion space compared with that at the time of exposing the object and carries out cleaning on the scale member.

22. The exposure apparatus according to claim 21, further comprising:
a detection system which detects foreign matter on a surface of the scale member.

23. The exposure apparatus according to claim 22, further comprising:
a control apparatus which is capable of controlling the moving body on the basis of measurement information of the measurement system and controls the cleaning operation and change of a control mode of the moving body,
wherein the control apparatus performs the cleaning operation and the change of the control mode when the detection system detects foreign matter which is not acceptable in the exposure.

24. The exposure apparatus according to claim 18,
wherein the immersion member includes a supply port which supplies a liquid for forming the immersion space, and a recovery port which recovers a liquid in parallel to the supplying of the liquid, and
wherein the expansion of the immersion space includes a decrease in liquid recovery amount per unit time using the recovery port.

25. The exposure apparatus according to claim 18,
wherein the immersion member includes a supply port which supplies a liquid for forming the immersion space, and a recovery port which recovers a liquid in parallel to the supplying of the liquid, and
wherein the expansion of the immersion space includes an increase in liquid supply amount per unit time using the recovery port.

26. The exposure apparatus according to claim 16,
wherein the immersion space is filled with a liquid for exposure at the time of the cleaning.

27. The exposure apparatus according to claim 16,
wherein the immersion space is filled with a liquid for cleaning, which is different from a liquid for exposure, at the time of the cleaning.

28. The exposure apparatus according to claim 27,
wherein the liquid for cleaning includes cleaning water in which a predetermined gas is dissolved in water.

29. The exposure apparatus according to claim 16,
wherein the liquid of the immersion space and the moving body vibrate or fluctuate relatively at the time of the cleaning.

30. The exposure apparatus according to claim 16,
wherein a maximum value of a relative moving speed between the immersion member and the moving body is smaller at the time of the cleaning than that at the time of the exposure.

31. The exposure apparatus according to claim 1,
wherein the detection system is capable of detecting information regarding at least one of a size, an amount, and a position of the foreign matter.

32. The exposure apparatus according to claim 1,
wherein the detection system is capable of detecting positional information of a surface of an object which is held on the moving body.

33. The exposure apparatus according to claim 1, further comprising:
another moving body which is different from the moving body,
wherein the detection system is capable of detecting foreign matter on a surface of the scale member which is disposed on the another moving body.

34. The exposure apparatus according to claim 33,
wherein the cleaning apparatus is capable of cleaning the scale member of the another moving body.

35. The exposure apparatus according to claim 1,
wherein the scale member is disposed such that a surface of the scale member becomes substantially flush with an upper surface of the moving body.

36. The exposure apparatus according to claim 1,
wherein the moving body holds the object such that a surface of the scale member is disposed on substantially the same plane as a surface of the object.

37. A device manufacturing method comprising:
exposing a substrate using the exposure apparatus according to claim 1, and
developing the exposed substrate.

38. An exposure method of exposing an object with exposure light, comprising:
measuring positional information of a moving body in a predetermined plane by an encoder system which uses a scale member of the moving body holding the object, moving the moving body, and exposing the object;
detecting information regarding foreign matter on a surface of the scale member and a size of the foreign matter; and
determining whether or not the scale member is cleaned on the basis of the detection result.

39. The exposure method according to claim 38,
wherein the cleaning is performed when the amount of detected foreign matter exceeds a predetermined acceptable value or when a position of the detected foreign matter is in the outside of an acceptable area of a surface of the scale member.

40. The exposure method according to claim 38,
wherein the cleaning or change in a control mode of the moving body is performed when foreign matter which is not acceptable in the exposure is detected.

41. An exposure method of exposing an object with exposure light, comprising:
measuring positional information of a moving body in a predetermined plane by an encoder system which uses a scale member of the moving body holding the object, moving the moving body, and exposing the object;
detecting foreign matter on a surface of the scale member; and
performing the cleaning or the change of the control mode when foreign matter which is not acceptable in the exposure is detected.

42. The exposure method according to claim 40,
wherein the foreign matter which is not acceptable in the exposure includes foreign matter which renders measurement information obtained by the encoder system unusable in control of the moving body.

43. The exposure method according to claim 40,
wherein the cleaning is performed when detection information of foreign matter which is not acceptable in the exposure exceeds an acceptable value, and
wherein the change of the control mode is performed when the detection information is equal to or less than an acceptable value.

44. The exposure method according to claim 43,
wherein the detection information includes information of an occupation area of foreign matter per unit area.

45. The exposure method according to claim 40,
wherein the change of the control mode includes a change of measurement information to be used for control of the moving body from the encoder system to an interferometer system.

46. The exposure method according to claim 38, further comprising:
forming an immersion space in an interval with a surface of the scale member with a liquid; and
moving the moving body in the cleaning such that the liquid comes into contact with the foreign matter.

47. The exposure method according to claim 38, further comprising:
forming an immersion space in an interval with a surface of the scale member with a liquid; and
expanding the immersion space in the cleaning such that the liquid comes into contact with the foreign matter.

48. An exposure method of exposing an object with exposure light via an optical member, comprising:
filling an optical path of the exposure light between the optical member and the object with a liquid so as to form an immersion space;
measuring positional information of a moving body in a predetermined plane by an encoder system which uses a scale member of the moving body holding the object, moving the moving body, and exposing the object via the liquid;
expanding the immersion space compared with that at the time of the exposure, and cleaning the scale member.

49. The exposure method according to claim 48, further comprising:
detecting foreign matter on a surface of the scale member,
wherein the cleaning or the change of the control mode is performed when foreign matter which is not acceptable in the exposure is detected.

50. The exposure method according to claim 46,
wherein the immersion space is filled with a liquid for exposure at the time of the cleaning.

51. The exposure method according to claim 46,
wherein the immersion space is filled with a liquid for cleaning, which is different from a liquid for exposure, at the time of the cleaning.

52. The exposure method according to claim 51,
wherein the liquid for cleaning includes cleaning water in which a predetermined gas is dissolved in water.

53. The exposure method according to claim 46,
wherein the liquid of the immersion space and the moving body vibrate or fluctuate relatively at the time of the cleaning.

54. The exposure method according to claim 38, further comprising:
exchanging a scale member of the moving body.

55. The exposure method according to claim 38, further comprising:
withdrawing the moving body from the exposure apparatus and maintaining the scale member.

56. The exposure method according to claim 55,
wherein the maintaining includes cleaning and/or exchanging the scale member.

57. The exposure method according to claim 56,
wherein the cleaning of the scale member includes cleaning with an alkali solvent.

58. A device manufacturing method comprising:
exposing a substrate using the exposure method according to claim 38; and
developing the exposed substrate.

59. An exposure apparatus which exposes a substrate with exposure light, comprising:
a moving body on which a scale member including a grating is disposed, and which holds the substrate and is capable of moving in a predetermined plane;
an encoder system which has a head being capable of facing the scale member and measures positional information of the moving body in the predetermined plane by the head;
a drive system which is capable of driving the moving body on the basis of measurement information of the encoder system;
a detection system which detects information regarding a surface state of the scale member; and
a control apparatus which controls driving of the moving body by the drive system on the basis of detection information of the detection system in the middle of scanning and exposing the substrate.

60. The exposure apparatus according to claim 59,
wherein the detection system detects defect information of a surface of the scale member, and
wherein the control apparatus determines a specific area on the substrate in which the encoder system generates measurement error by the defect of the scale member in the middle of the scanning exposure.

61. The exposure apparatus according to claim 59,
wherein the detection system detects defect information of a surface of the scale member, and
wherein the control apparatus determines a specific area on the substrate with which at least a part of an illumination area of the exposure light is overlapped when the defect of the scale member is disposed on a measurement area of the head.

62. The exposure apparatus according to claim 60,
wherein the defect information includes information regarding at least one of a size and a position of the foreign matter on the scale member.

63. The exposure apparatus according to claim 60,
wherein the detection system is capable detecting foreign matter on the scale member.

64. The exposure apparatus according to claim 63,
wherein positional information of the moving body is measured by a measurement system which is capable of measuring positional information of the moving body in the predetermined plane and, at the same time, the foreign matter is detected by the detection system, and
wherein the control apparatus obtains information of the foreign matter in a coordinate system which is defined by the measurement system on the basis of a detection result of the detection system and a measurement result of the measurement system.

65. The exposure apparatus according to claim 64,
wherein the measurement system includes the encoder system.

66. The exposure apparatus according to claim 60,
wherein the control apparatus makes driving of the moving body by the drive system in a first state where the specific area is scanned and exposed different from in a second state in which an area other than the specific area of the substrate is scanned and exposed.

67. The exposure apparatus according to claim 66,
wherein the drive system is capable of adjusting a gain coefficient regarding the measurement information, and
the control apparatus makes the gain coefficient in the first state smaller than the gain coefficient in the second state.

68. The exposure apparatus according to claim 67,
wherein the control apparatus makes the gain coefficient in the first state be zero.

69. The exposure apparatus according to claim 67,
wherein the control apparatus makes the gain coefficient in the second state be a substantially constant value.

70. The exposure apparatus according to claim 67,
wherein the control apparatus makes the gain coefficient small in the middle of the scanning exposure of a shot area including the specific area on the substrate.

71. The exposure apparatus according to claim 67,
wherein the control apparatus makes the gain coefficient small when the specific area passes through an illumination area of the exposure light.

72. The exposure apparatus according to claim 66,
wherein the drive system does not use measurement information of the encoder system in the first state.

73. An exposure apparatus which exposes a substrate with exposure light, comprising:
a moving body on which a scale member including a grating is disposed, and which holds the substrate and is capable of moving in a predetermined plane;
an encoder system which has a head being capable of facing the scale member and measures positional information of the moving body in the predetermined plane by the head;
a drive system which is capable of driving the moving body on the basis of measurement information of the encoder system;
a detection system which detects foreign matter on the scale member; and
a control apparatus which determines a specific area on the substrate with which at least a part of an illumination area of the exposure light is overlapped when the foreign matter is disposed on a measurement area of the head,
wherein the drive system drives the moving body without using measurement information of the encoder system in the first state in which the specific area is scanned and exposed.

74. The exposure apparatus according to claim 73,
wherein the moving body is driven without using measurement information of the encoder system in the specific area in the middle of the scanning exposure of a shot area including the specific area on the substrate.

75. The exposure apparatus according to claim 66,
wherein the drive system drives the moving body on the basis of measurement information of the encoder system in the second state in which an area other than the specific area of the substrate is scanned and exposed.

76. The exposure apparatus according to claim 75, further comprising:
an interferometer system which is capable of measuring positional information of the moving body,
wherein the drive system moves the moving body on the basis of measurement information of the interferometer system in the first state.

77. The exposure apparatus according to claim 76,
wherein the measurement information of the encoder system and the measurement information of the interferometer system which are used for driving the moving body are switched when one of the first state and the second state is changed to the other state by the movement of the substrate.

78. The exposure apparatus according to claim 66,
wherein servo control is not carried out on the moving body by the drive system in the first state.

79. An exposure apparatus which exposes a substrate with exposure light, comprising:
a moving body which holds the substrate and is capable of moving in a predetermined plane, and in which a scale member including a grating is disposed;
an encoder system which has a head being capable of facing the scale member and measures positional information of the moving body in the predetermined plane;
a drive system which is capable of driving the moving body on the basis of measurement information of the encoder system;
a detection system which detects information regarding a surface state of the scale member; and
a control apparatus which determines a specific area on the substrate in which the measurement information is substantially unusable in the driving of the moving body, on the basis of detection information of the detection system.

80. The exposure apparatus according to claim 79,
wherein the specific area includes an area in which the encoder system is unable to measure a position of the moving body.

81. The exposure apparatus according to claim 79,
wherein the detection system detects defect information of a surface of the scale member, and
wherein the specific area includes an area in which the encoder system generates measurement error due to the defect of the scale member at the time of the exposure.

82. The exposure apparatus according to claim 79,
wherein the detection system detects defect information of a surface of the scale member, and
wherein the specific area includes an area with which at least a part of an illumination area of the exposure light is overlapped when the defect of the scale member is disposed on a measurement area of the head.

83. The exposure apparatus according to claim 81,
wherein the defect information includes information regarding at least one of a size and a position of the foreign matter on the scale member.

84. The exposure apparatus according to claim 79,
wherein the detection system is capable of detecting foreign matter on the scale member.

85. The exposure apparatus according to claim 79,
wherein the substrate is relatively moved with respect to the exposure light by the moving body, and scanned and exposed, and
wherein the control apparatus changes a servo gain of the drive system in the middle of the scanning exposure of a shot area including the specific area on the substrate.

86. The exposure apparatus according to claim 85,
wherein the control apparatus makes the servo gain in the specific area small compared with that in an area other then the specific area of the shot area.

87. The exposure apparatus according to claim 86,
wherein the servo gain becomes zero in the specific area.

88. The exposure apparatus according to claim 79,
wherein the substrate is relatively moved with respect to the exposure light by the moving body, and scanned and exposed, and
wherein the control apparatus does not carry out servo control on the moving body by the drive system in the specific area in the middle of the scanning exposure of a shot area including the specific area on the substrate.

89. The exposure apparatus according to claim 79,
wherein the substrate is relatively moved with respect to the exposure light by the moving body, and scanned and exposed, and
wherein the control apparatus performs driving of the moving body by the drive system in another control mode in the middle of the scanning exposure of a shot area including the specific area on the substrate.

90. The exposure apparatus according to claim 89,
wherein the another control mode includes a first mode which is used for an area other than the specific area of the shot area, and in which measurement information of the encoder system is used, and a second mode which is used for the specific area.

91. The exposure apparatus according to claim 90,
wherein a servo gain of the drive system in the second mode is small compared with that in the first mode.

92. The exposure apparatus according to claim 90,
wherein measurement information of the encoder system is not used in the second mode.

93. The exposure apparatus according to claim 90,
wherein the drive system does not carry out servo control on the moving body in the second mode.

94. The exposure apparatus according to claim 90, further comprising:
a measurement apparatus which is different from the encoder system and measures positional information of the moving body on the predetermined plane,
wherein measurement information of the measurement apparatus is used in the second mode.

95. The exposure apparatus according to claim 94,
wherein output coordinates of the encoder system or the measurement apparatus, which are used after switching between the first mode and the second mode, are set at the time of the switching or before the switching such that the output coordinates of the encoder system and the measurement apparatus substantially continue at the time of switching.

96. The exposure apparatus according to claim 94,
wherein a continuous manner between the output coordinates of the encoder system and the measurement system differs at the time of the switching from the first mode to the second mode and at the time of the switching from the second mode to the first mode.

97. The exposure apparatus according to claim 96,
wherein a coordinate connection is used to set the output coordinates of the measurement apparatus in the switching from the first mode to the second mode so as to be matched with the output coordinates of the encoder system.

98. The exposure apparatus according to claim 96,
wherein a phase connection is used to set the output coordinates of the encoder system in the switching from the second mode to the first mode using the output coordinates the interferometer system and phase information of the encoder system.

99. The exposure apparatus according to claim 94,
wherein the measurement apparatus includes an interferometer system.

100. The exposure apparatus according to claim 59,
wherein the detection system is capable of detecting surface positional information of a surface of the substrate which is held on the moving body.

101. An exposure apparatus which exposes a substrate with exposure light, comprising:
a moving body which holds the substrate and is capable of moving in a predetermined plane;
an encoder system which is capable of measuring positional information of the moving body in the predetermined plane;
a drive system which is capable of driving the moving body on the basis of measurement information of the encoder system; and
a control apparatus which can change a servo gain of the drive system in a specific area or can stop servo control of the moving body in the middle of the scanning exposure of a shot area including the specific area in which measurement information of the encoder system is abnormal on the substrate.

102. The exposure apparatus according to claim 101,
wherein the specific area includes an area in which the encoder system generates measurement error.

103. The exposure apparatus according to claim 101,
wherein the specific area includes an area in which the encoder system is unable to measure a position of the moving body.

104. The exposure apparatus according to claim 101,
wherein the specific area includes an area in which the measurement information is abnormal due to a defect of a scale member of the encoder system.

105. The exposure apparatus according to claim 104,
wherein the defect includes foreign matter existing on the scale member.

106. The exposure apparatus according to claim 104,
wherein the specific area includes an area with which at least a part of an illumination area of the exposure light is overlapped when the defect of the scale member is disposed on a measurement area of the encoder system.

107. An exposure apparatus which exposes a substrate with exposure light, comprising:
a moving body which holds the substrate and is capable of moving in a predetermined plane;
a measurement system which has an encoder system and an interferometer system which is capable of measuring positional information of the moving body in the predetermined plane;
a drive system which is capable of driving the moving body on the basis of measurement information of the measurement system; and
a control apparatus which is capable of switching measurement information to be used to drive the moving body from one of the encoder system and the interferometer system to the other system, sets output coordinates of the other system to be used after the switching such that output coordinates of the encoder system and the interferometer system at the time of the switching substantially continue, and makes a continuous manner of the output coordinates different at the time of switching from one of the encoder system and the interferometer system to the other system and at the time of switching from the other system to the one system.

108. The exposure apparatus according to claim 107,
wherein the substrate is relatively moved with respect to the exposure light by the moving body, and scanned and exposed, and
wherein the control apparatus can perform the switching in the middle of the scanning exposure of a shot area of the substrate.

109. The exposure apparatus according to claim 107,
wherein measurement information of the encoder system is used for driving the moving body in an exposure operation of the substrate, and
wherein measurement information of the interferometer system is used when measurement information of the encoder system is abnormal.

110. The exposure apparatus according to claim 109,
wherein measurement information of the interferometer system is used when the encoder system generates measurement error, or when the encoder system is unable to measure a position of the moving body.

111. The exposure apparatus according to claim 109,
wherein measurement information of the interferometer system is used when measurement information is abnormal due to a defect of a scale member of the encoder system.

112. The exposure apparatus according to claim 111,
wherein the defect includes foreign matter existing on the scale member.

113. The exposure apparatus according to claim 107,
wherein a coordinate connection is used to set the output coordinates of the interferometer system in the switching from the encoder system to the interferometer system so as to be matched with the output coordinates of the encoder system.

114. The exposure apparatus according to claim 107,
wherein a phase connection is used to set the output coordinates of the encoder system in the switching from the interferometer system to the encoder system using the output coordinates the interferometer system and phase information of the encoder system.

115. The exposure apparatus according to claim 101,
wherein one of a scale member and a head of the encoder system is provided at the moving body, and the other one is provided to be capable of facing the moving body.

116. The exposure apparatus according to claim 101,
wherein the encoder system has a head which is capable of facing a scale member which is disposed on the moving body.

117. The exposure apparatus according to claim 59, further comprising:
an immersion member which is capable of forming an immersion space with a liquid in an interval with a substrate,
wherein the scale member comes into contact with the liquid in the immersion space.

118. The exposure apparatus according to claim 117, further comprising:
an optical member which emits the exposure light,
wherein an immersion member is capable of forming an immersion space such that an optical path of the exposure light between the optical member and the substrate is filled with a liquid for exposure.

119. The exposure apparatus according to claim 59,
wherein the scale member is disposed such that a surface of the scale member becomes substantially flush with an upper surface of the moving body.

120. The exposure apparatus according to claim 59,
wherein the moving body holds the substrate such that a surface of the scale member is disposed on substantially the same plane as a surface of the substrate.

121. A device manufacturing method comprising:
exposing a substrate using the exposure apparatus according to claim 59, and
developing the exposed substrate.

122. An exposure method of exposing a substrate with exposure light, comprising:
detecting information regarding a surface state of a scale member disposed on a moving body which holds the substrate and is movable in a predetermined plane;
measuring positional information of the moving body by an encoder system which has a head being capable of facing the scale member;
scanning and exposing the substrate while driving the moving body on the basis of measurement information of the encoder system; and
controlling the moving body to be driven on the basis of the detected information in the middle of the scanning exposure of the substrate.

123. The exposure method according to claim 122,
wherein the detected information includes defect information of a surface of the scale member.

124. The exposure method according to claim 123,
wherein the defect information includes information regarding at least one of a size and a position of foreign matter on the scale member.

125. An exposure method of exposing a substrate with exposure light, comprising:
detecting information regarding foreign matter on a scale member disposed on a moving body which holds the substrate and is movable in a predetermined plane;
measuring positional information of the moving body by an encoder system which has a head being capable of facing the scale member;
scanning and exposing the substrate while driving the moving body on the basis of measurement information of the encoder system;
determining a specific area on the substrate with which at least a part of an illumination area of the exposure light is overlapped when the foreign matter is disposed on a measurement area of the head; and
driving the moving body without using measurement information of the encoder system in a first state in which the specific area is scanned and exposed.

126. The exposure method according to claim 125, further comprising:
driving the moving body on the basis of measurement information of the encoder system in a second state in which an area other than the specific area of the substrate is scanned and exposed.

127. The exposure method according to claim 125,
wherein positional information of the moving body is measured by an interferometer system in the first state, and the moving body is driven.

128. The exposure method according to claim 125,
wherein servo control is not carried out on the moving body by the drive system in the first state.

129. An exposure method of exposing a substrate with exposure light, comprising:
detecting information regarding a surface state of a scale member disposed on a moving body which holds the substrate and is movable in a predetermined plane;
measuring positional information of the moving body by an encoder system which has a head being capable of facing the scale member;
scanning and exposing the substrate while driving the moving body on the basis of measurement information of the encoder system; and
determining a specific area on the substrate in which the measurement information is substantially unusable in the driving of the moving body, on the basis of the detected information.

130. The exposure method according to claim 129,
wherein the detected information includes defect information of a surface of the scale member.

131. The exposure method according to claim 129, further comprising:
changing a servo gain of the drive system, which drives the moving body, in the middle of the scanning exposure of a shot area including the specific area on the substrate.

132. The exposure method according to claim 131,
wherein the servo gain in the specific area is small compared with that in an area other then the specific area of the shot area.

133. The exposure method according to claim 129,
wherein servo control is not carried out on the moving body in the specific area in the middle of the scanning exposure of a shot area including the specific area on the substrate.

134. The exposure method according to claim 129,
wherein the moving body is driven in another control mode in the middle of the scanning exposure of a shot area including the specific area on the substrate.

135. An exposure method of exposing a substrate with exposure light, comprising:
measuring positional information of a moving body, which holds the substrate and is movable in a predetermined plane, by an encoder system;
scanning and exposing the substrate while driving the moving body on the basis of measurement information of the encoder system; and
changing a servo gain of a drive system driving the moving body in the specific area or stopping servo control of the moving body in the middle of the scanning exposure of a shot area including the specific area in which measurement information of the encoder system is abnormal on the substrate.

136. An exposure method of exposing a substrate with exposure light, comprising:
measuring positional information of a moving body, which holds the substrate and is capable of moving in a predetermined plane, by a measurement system;
scanning and exposing the substrate while driving the moving body on the basis of measurement information of the measurement system; and
switching measurement information to be used for driving the moving body from one of an encoder system and an interferometer system of the measurement system to the other system, and setting output coordinates of the other system to be used after the switching such that output coordinates of the encoder system and the interferometer system at the time of the switching substantially continue,
wherein a continuous manner of the output coordinates is different at the time of switching from one of the encoder system and the interferometer system to the other system and at the time of switching from the other system to the one system.

137. The exposure method according to claim 136,
wherein the switching is carried out in the middle of the scanning exposure of a shot area of the substrate.

138. The exposure method according to claim 136,
wherein measurement information of the encoder system is used for driving the moving body in the middle of the scanning exposure, and
wherein measurement information of the interferometer system is used when measurement information of the encoder system is abnormal.

139. The exposure method according to claim 122,
wherein the substrate is exposed with exposure light via a liquid.

140. A device manufacturing method comprising:
exposing a substrate using the exposure method according to claim 122; and
developing the exposed substrate.
